(19) United States
(12) Patent Application Publication
(10) Pub. No.: US 2008/0052169 A1
(43) Pub. Date: Feb. 28, 2008

(54) METHOD AND APPARATUS FOR PROVIDING A COUPON OFFER HAVING A VARIABLE VALUE

(76) Inventors: Deirdre O'SHEA, New York, NY (US); Jay S. WALKER, Ridgefield, CT (US); Andrew VAN LUCHENE, Norwalk, CT (US); Magdalena MIK, Greenwich, CT (US); Adam STEVENSON, Solana Beach, CA (US); Scott B. ALLISON, Stamford, CT (US)

Correspondence Address: WALKER DIGITAL MANAGEMENT, LLC, 2 HIGH RIDGE PARK, STAMFORD, CT, 06905, US

(21) Appl. No.: 11/928,572

(22) Filed: Oct. 30, 2007

Related U.S. Application Data
(62) Division of application No. 09/535,790, filed on Mar. 29, 2000.

(51) Int. Cl. G06Q 30/00; B42D 15/00; G06Q 40/00; H04N 7/16; G06F 17/00

(52) U.S. Cl. 705/14; 235/375; 283/56; 705/39; 725/23

(57) ABSTRACT

A method by which a coupon having a variable benefit is provided includes generating a coupon having a variable benefit, wherein a duplicate of the coupon is transmitted from one recipient to another recipient, receiving an indication that a first recipient has performed a qualifying action, such as receiving, registering for and/or redeeming the coupon offer from a second recipient of the coupon, and changing a benefit of the coupon retained by the second recipient after the indication is received. A system includes a controller operable to compute a benefit of the coupon according to benefit variation conditions.

### CROSS REFERENCE TO RELATED APPLICATIONS

The present application is a divisional application of U.S. patent application Ser. No. 09/535,790 filed on Mar. 29, 2000, the entire contents of which is incorporated by reference herein.

### BACKGROUND OF THE INVENTION

1. Field of the Invention

The present invention relates generally to a method and apparatus for providing marketing and other promotional offers and, more particularly, to a method and apparatus for providing variable benefit coupon offers and propagating coupons to potential recipients.

2. Description of the Prior Art

Over the past few decades, retailers have used coupons to motivate customers to visit their stores, while manufacturers have used coupons to promote their products. Typically, the customers take the coupons to a retail store where they are redeemed for some benefit or applied as a discount toward the purchase of some product. However, there are several disadvantages to the conventional coupon issuance and redemption process.

First, potential coupon recipients may be discouraged by the inconvenience of clipping and redeeming coupons. Potential recipients may be reluctant to undergo the time consuming task of searching through publications and flyers to select those coupons that may actually be relevant to the recipients' interest. Once the coupons have been clipped from the publication and saved, the recipient must remember to bring the actual coupon to the retail store in order to receive the discount on the particular product for which the coupon is redeemable.

Second, many manufacturers and retailers spend large amounts of money to provide or distribute coupons to a huge pool of customers when only a fraction of the recipients ever use the coupons. Because it is difficult for manufacturers and retailers to determine which coupons will be attractive to which customers, if any, many more coupons are issued than necessary in the hopes of increasing the number of coupons redeemed. Even when some customers do clip and use the coupons, since many coupons are submitted anonymously, the manufacturer or retailer may not have an efficient way of reaching that person again for arousing interest in related products.

Internet coupons allow customers to seek coupons and other incentives on the Internet that can be redeemed either in a traditional retail environment or at online merchants. Customers may access Internet coupon offers from a number of manufacturers and retailers or from a central coupon issuing service, such as coolsavings.com. Some Internet coupons are merely links to specially priced items that can be purchased through online merchants; others are links to static web pages or web sites.

However, there are disadvantages associated with Internet coupons as well. Internet coupons are relatively new for many customers, and many people who would likely use such coupons do not know of them. In addition, many Internet services have a difficult time reaching recipients, thereby making delivery of Internet coupons difficult. Therefore, since the customers usually must solicit the Internet coupons or take other proactive measures to obtain the Internet coupons, the Internet coupon offers may not reach or be available to a large pool of people. Furthermore, since the use of Internet coupons and the process of using them is new to most consumers, the consumers may not know how or where to look or how to obtain the Internet coupons.

Some Internet coupon offer providers attempt to target recipients by sending unsolicited coupon to the recipients via electronic mail. Such unsolicited Internet coupon may be considered by many consumers to be more of an annoyance than a benefit. Some states are establishing strict “anti-spamming” laws to shield consumers from such unsolicited targeting by merchants, coupon offer issuers, and others. This significantly limits the ability of an issuer of Internet coupons to reach new markets, but not for lack of interested recipients. Thus, coupon offer issuers lack an efficient conduit to reach interested consumers.

Due to the above-stated shortcomings of the prior art, a need exists for a method and apparatus to allow providers of coupon to effectively target potentially interested recipients and to provide incentives, rewards or other benefits for receiving, registering or redeeming the coupons, for promoting, forwarding or otherwise disseminating the coupons to additional potentially interested recipients, or for conducting or completing a qualifying action.

### SUMMARY OF THE INVENTION

The present invention provides coupon offer issuing and redemption systems and methods that overcome the drawbacks of the existing conventional coupon issuing and redemption systems by creating a variable benefit coupon. Using a variable benefit coupon encourages recipients of the coupon to receive, register and redeem the coupon and/or perform other qualifying actions, thereby increasing the benefit of, or associated with, the coupon. In addition, a variable benefit coupon encourages the recipients to promote, forward and disseminate the variable benefit coupon to other family members, friends, acquaintances, etc. who may be interested in the coupon or in a product or service associated with the coupon.

In one embodiment, the present invention provides a variable benefit coupon offer issuing system that increases the benefit of a recipient's coupon when the recipient forwards a duplicate or similar coupon to another recipient, referred to herein as a downstream recipient. The recipient who forwards the coupon to that downstream recipient is referred to herein as the upstream recipient. An initial recipient of a coupon is typically a person or one of a group of recipients who has no upstream recipients for the coupon and may be a person who receives a coupon directly from an issuer of the coupon. Typically, the coupon is an electronic coupon that may be forwarded by one recipient to a downstream recipient via e-mail or a printed coupon that may be copied and forwarded from one recipient to a downstream recipient. The invention further overcomes drawbacks of the prior art by allowing customers to, in some embodiments, identify selected coupons and their present values at a retailer point-of-sale (POS) device with a customer identifier such as a credit card, frequent shopper card, account identifier or other identifier unique to the recipient. This identifier would replace the coupon, thereby negating the need to clip and carry a physical representation of the coupon.

In another embodiment of the variable benefit coupon offer issuing system of the present invention, a coupon offer issuer server issues a coupon having a variable benefit to an initial recipient, or to an upstream recipient who may not be an initial recipient. The benefit of the coupon varies depending upon the actions of the initial and downstream recipients. The coupon preferably has an initial benefit, which may be an offer for a discount off of a retail price of an item or service from a retail merchant or other provider. This is the benefit that the coupon has to each initial recipient when it is first received. In one embodiment of the present invention, when the initial recipient completes a qualifying action such as forwarding a duplicate of the coupon to other recipients via e-mail or other media, the benefit of the coupon retained by the initial recipient increases.

Each duplicate or similar coupon forwarded from the initial or upstream recipient to a downstream recipient has a respective benefit of the coupon. In one embodiment, this benefit increases each time the downstream recipient forwards a duplicate or similar coupon to other downstream recipients. In addition, the benefit of the initial recipient's coupon may increase each time the downstream recipient forwards or transmits a duplicate or similar coupon to another recipient. For example, if an initial recipient forwards a duplicate or similar coupon to another person, referred to herein as the primary downstream recipient with respect to the initial recipient, the benefit of the initial recipient's coupon increases. If the primary downstream recipient with respect to the initial recipient forwards on the coupon to another person, herein referred to as the secondary downstream recipient with respect to the initial recipient, the benefit of the initial recipient's coupon increases. The benefit of the primary downstream recipient with respect to the initial recipient's coupon may also increase. In this way, the benefit of each recipient's coupon depends upon the number of times a duplicate of the coupon has been directly or indirectly forwarded to downstream recipients. It will be appreciated that directly forwarded is intended to mean forwarded from one recipient to another without any recipients in between, and indirectly forwarded is intended to mean forwarded from one recipient to another by way of one or more other recipients. Each respective benefit of each recipient's coupon can continue to increase until, for example, the expiration date of the coupon offer or coupon, the redemption of the coupon by the recipient, the attainment of the maximum number of downstream recipients, the date after which the coupon may not increase in benefit, or the attainment of a predetermined maximum benefit. The coupon offer issuer server tracks the respective benefit of each recipient's coupon.

In another embodiment of the present invention where a coupon is forwarded from one palmtop computer, such as the PalmPilot Palm VII, to other palmtop computers, each palmtop computer tracks which upstream recipient it received the coupon from, and how many coupons each recipient forwarded on to different recipients. Each palmtop computer then tracks the benefit of the recipient's coupon, and communicates this information to the POS, cashier, computer server of the merchant, etc. at the time of redemption of the coupon. Conventionally, this function is called “synchronizing” or “synching” data between a palm computer and the coupon issuer server, point-of-sale server or other server or recipient device in the system.

For example, an initial recipient may receive a coupon with an associated benefit of five dollars off a purchase of any product at a particular toy store. The coupon may also indicate that the coupon offer issuer will increase the benefit of the initial recipient's coupon by fifty cents for each person to whom the initial recipient forwards a duplicate of the coupon, up to six people. These up to six people would be primary downstream recipients with respect to the initial recipient. The coupon may further indicate that the benefit of the initial recipient's coupon can be increased an additional five cents for each recipient to whom a primary downstream recipient with respect to the initial recipient forwards a duplicate of the coupon. These recipients would be secondary downstream recipients with respect to the initial recipient, and primary downstream recipients with respect to one or more of the initial recipient's primary downstream recipients. The coupon offer issuer server preferably keeps track of the recipients of the toy store's coupons and the respective benefits of the recipients' coupons. Each of the recipients can redeem the coupon at the particular toy store before the expiration or termination date of the coupon offer or their coupon. Because the recipients have an incentive to forward the coupon to friends and family who are likely to be interested in the coupon, a more targeted pool of people will receive the coupon than in conventional coupon offer issuance systems. Furthermore, upstream recipients are inclined to give the coupon more consideration than a coupons that is not targeted because the coupons are sent by people who know them and their interests. This is especially true for the embodiment where the benefit of a recipient's coupon only increases if a downstream recipient redeems the coupon. Thus, recipients are encouraged to forward coupon to people they think will actually use them.

The present invention comprises a method and apparatus for issuing and redeeming a variable benefit coupon. Coupon offer issuers may include a retail store, a mall, shopping center, or other collection of stores, a manufacturer of a product, a supplier of a product or service, a credit card company, a government organization, a web site, a computer system, etc. The method of the present invention includes establishing an initial benefit for a coupon, establishing a benefit variation condition associated with the coupon, the benefit variation condition typically including or having one or more qualifying actions or conditions which can change the benefit of the coupon, receiving a notice of a completion of at least one qualifying action, and updating the coupon's benefit in accordance with the benefit variation condition. The apparatus includes a server coupled to at least one output device for issuing a coupon having a variable benefit to a first recipient, wherein the server is operable to change a benefit of the coupon in accordance with benefit variation conditions. The apparatus may also be a coupon in tangible or electronic form comprising indicia or an electronic signal representative of a benefit and a benefit variation condition.

These and other features and advantages of the present invention will be understood upon consideration of the following detailed description of the invention and the accompanying drawings.

### BRIEF DESCRIPTION OF THE DRAWINGS

FIG. 1 is a representative flowchart of a first embodiment of a method in accordance with the present invention;

FIG. 2 is a representative block diagram of a first embodiment of an apparatus usable with the method of FIG. 1;

FIG. 3 is a representative block diagram of a second embodiment of an apparatus usable with the method of FIG. 1;

FIG. 4 is a block diagram illustrating a representative coupon offer issuer server of FIGS. 2 and 3;

FIG. 5 is a tabular representation of a possible data structure for the available coupons database of FIG. 4;

FIG. 6 is a tabular representation of a possible data structure for the coupon recipient database of FIG. 4;

FIG. 7 is a tabular representation of a possible data structure for a record in the coupon tracking database of FIG. 4;

FIG. 8 is a tabular representation of a possible data structure for another record in the issued coupon database of FIG. 4;

FIG. 9 is a tabular representation of a possible data structure for another record in the issued coupon database of FIG. 4;

FIG. 10 is a tabular representation of a possible data structure for the issued coupon database of FIG. 4;

FIG. 11 is a tabular representation of a possible data structure for the recipient variable benefit database of FIG. 4;

FIG. 12 is a block diagram illustrating a representative coupon recipient device of FIGS. 2 and 3;

FIG. 13 is a block diagram illustrating a representative point-of-sale terminal of FIGS. 2 and 3;

FIG. 14 is a representative flowchart of a method for issuing a coupon to a recipient that may be used in conjunction with the method of FIG. 1 and with the coupon offer issuer server of FIGS. 2 and 3;

FIG. 15 is a representative flowchart of a method enabling a recipient of a coupon to registers the coupon with the coupon offer issuer server of FIG. 2 and that may be used in conjunction with the method of FIG. 1 and the apparatus of FIGS. 2 and 3;

FIG. 16 is a representative flowchart of a method of increasing a benefit of a recipient's coupon that may be used in conjunction with the method of FIG. 1 and the apparatus of FIGS. 2 and 3;

FIG. 17 is a representative flowchart of a method of determining a benefit of a coupon for a particular recipient of the coupon that may be used in conjunction with the method of FIG. 1 and the apparatus of FIGS. 2 and 3;

FIG. 18 is a representative flowchart of a continuation of the method of FIG. 17;

FIG. 19 is a representative flowchart of a method that may be performed by a point-of-sale device of FIG. 2 to determine and apply the benefit of a coupon; and

FIG. 20 is a representative flowchart of a second embodiment of a method in accordance with the present invention.

### DETAILED DESCRIPTION OF THE PREFERRED EMBODIMENTS

The method and apparatus of the present invention allow for a coupon to be provided to an initial recipient, the coupon having a benefit or current value that is variable or alterable according to established, selected or identified benefit variation condition(s). Thus, the benefit of the coupon may vary over time, both before and after the coupon is redeemed by the initial recipient, depending on the established benefit variation condition(s) and the actions of the initial recipient of the coupon, other recipients of the coupon, other parties, external events, etc. Actions by a recipient of a coupon that cause a coupon's benefit to change are referred to as “qualifying actions.” Thus, depending on the benefit variation conditions established for a coupon, an initial recipient of the coupon may increase the benefit of the coupon by initiating, performing, or completing an established qualifying action for the coupon. In addition, in some embodiments, actions of other potential recipients of the coupon may also be used as qualifying actions in benefit variation conditions, thereby affecting the benefit of the coupon for the initial recipient of the coupon, both before and after the coupon is redeemed by the initial recipient of the coupon. In addition to benefit variation conditions, a coupon validity duration or coupon validity duration condition may be established for the coupon, such that the coupon may have an infinite life (i.e., the coupon never expires), or a finite, but possibly variable, life (i.e., the coupon expires on a certain date, after a certain amount of time expires from issuance of the coupon, according to a predefined rule, etc.).

Typically, a coupon is an offer or promise for a benefit, such as a discount off of a retail price of an item or service from a merchant or other provider. One or more coupons are typically provided or issued during or in conjunction with a “coupon offer” or “coupon promotion” by a coupon issuer. Thus, each coupon preferably is associated with at least one coupon offer. The coupon issuer is often a service provider that aggregates and distributes coupons for a coupon offer provider, such as a retail store, manufacturer, etc. that sets the terms and conditions of a coupon offer, associates the coupon offer with a specific product or service, sets the initial benefit and benefit variation conditions for coupons associated with the coupon offer, etc. A server, device or entity may function as both a coupon issuer and a coupon offer provider.

For purposes of the present invention and the claims that follow, the term “coupon” shall include all coupons, tickets, labels, tags, vouchers, checks, discount offers, rebate offers, sale offers, promotional offers, tokens, coins, slips, keys, cards, signals, indicia, etc., in both electronic form (such as in e-mail, binary file, image, banner, software, etc.) and tangible form (such as in printed matter, a portion or magnetic or optical media on a card, disk, piece of clothing, etc.), which can be provided to a consumer, user, or other recipient for purposes of providing a benefit to the consumer, user, or other recipient. A coupon might also be or include a multiplier or aggregator of one or more other coupons, prize amounts, rebates, lottery winnings, gambling outcomes, etc. For example, a coupon might entitle a recipient of the coupon to double the benefit of another coupon, a gambling outcome, etc. As another example, a coupon may allow a recipient of the coupon to combine multiple coupons together and treat them as a single coupon.

It should also be understood that the term “item” need not be limited to goods, but could also include services, such as contractor services or videos downloaded to a viewer's multimedia display, as well as deliveryless transactions such as buying stock shares held in a central repository. A discount provided by a coupon may be a dollar amount, a percentage off of the retail price, a rebate, or something comparable such as a free product. A coupon may be store specific, and/or may be provided by the manufacturer of the product. For example, in some embodiments, a coupon offer provider (e.g., retailer or manufacturer) identifier may be stored in association with each coupon.

A “benefit” associated with a coupon may include or comprise any kind, nature, or indicia of benefit or value, either real or perceived. For example, a benefit for a coupon may provide a monetary value, such as one dollar off a case of soda, ten percent off a restaurant bill, a free car wash, a ten-thousand dollar scholarship, fifty dollars off a month's rent for an apartment, etc. A benefit for a coupon may also provide a time value, such as an extra ten minutes of long distance calling or slot machine play. A benefit for a coupon may also provide a tangible object value, such as a magazine subscription for a limited or unlimited period of time. As another example, a benefit for a coupon may also provide an additional right value, such as a right for a recipient to play golf or tennis with a celebrity. Furthermore, a benefit for a coupon may provide or be associated with numerical or point values, such as frequent flyer miles, frequent shopper points, frequent diner points, gambling club points, slot machine plays, calling card time minutes, etc. A benefit for a coupon may also provide a lottery, lotto, gambling, or gaming ticket. As previously discussed above, a benefit may also function as a multiplier, aggregator, combiner, changer, etc. of the benefit of one or more other coupons, prizes, lottery winnings, rebates, discounts, frequent flyer miles, slot machine plays, calling card time minutes, etc.

In some embodiments, a coupon's benefit may be the retail price of a product that the coupon is issued for. Since a coupon offer provider may not know the retail price being charged by retailers for the product, and since the retail price of a product may vary over time after a coupon for the product has been issued, the actual benefit of a coupon may, in some cases, not be determined or finalized until the coupon is redeemed for the product.

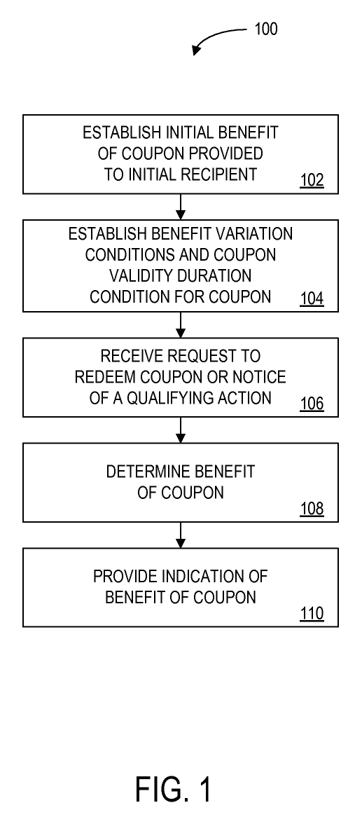

A method 100 in accordance with the present invention for providing a coupon having a variable benefit is illustrated in FIG. 1 and includes a step 102 wherein an initial benefit or current value of a coupon provided, or to be provided, to an initial or upstream recipient is established, a step 104 wherein variation conditions for the benefit of the coupon and validity duration conditions for the coupon are established, selected, identified, etc., a step 106 wherein a request or notice to redeem the coupon is received or indicated, or a notice is received that a recipient of the coupon has performed a qualifying action that may create a change in a benefit for the coupon for one or more recipients of the coupon, a step 108 wherein the benefit of the coupon is updated, computed or determined, and a step 110 wherein the updated, computed or determined benefit of the coupon is provided, displayed, indicated, etc., typically to a person, entity, device, computer system, etc. from which the notice or request received during the step 106 is received, another recipient of a coupon offer, some other person, etc. Each of the steps of the method 100 will be discussed in further detail below.

For purposes of explanation, but not limitation, of the present invention, registration of a coupon will include, but is not limited to, completion of a survey, form, web site page, notice, etc. by a recipient of a coupon indicating that the recipient has received the coupon. A recipient of a coupon may register a coupon on-line, such as by visiting a World Wide Web site or page, communicating with a coupon offer issuer server via email, etc., or off-line, such as by physically registering the coupon in a store, mailing in a registration form, etc. Redemption of a coupon will include, but is not limited to, exchanging, turning in, trading, converting, cashing, using, or otherwise redeeming a coupon to receive, select, spend, or otherwise obtain the coupon's associated benefit, typically as part of an exchange or transaction for receiving a service, product, prize, discount, rebate, etc. or other item or value. Like registration of a coupon, redemption of a coupon can occur in an on-line manner, in a store, etc. In some embodiments, a coupon may be redeemed more than once by a recipient of the coupon.

A significant advantage of the method 100 of the present invention is that with the method 100, a coupon recipient has incentives to perform certain activities or qualifying actions that will increase the benefit of the coupon. For example, if an initial recipient of a coupon registers and/or redeems the coupon within a certain time, the benefit of the coupon may increase. As a result, the initial recipient of the coupon is encouraged to register and/or redeem the coupon sooner rather than later.

There may be many reasons why a coupon offer issuer desires to have early registration or early redemption of a coupon. For example, a new restaurant may want to maximize the number of people that know about and visit the restaurant when the restaurant first opens. By encouraging early registration of coupons provided by or for the restaurant, the restaurant obtains a contact list of people or businesses that the restaurant can use to create targeted advertisements. By encouraging early redemption of the coupons provided by or for the restaurant, the restaurant increases visitors to the restaurant. With additional visitors to the restaurant, the restaurant may be able to increase the public perception of the restaurant being popular or high quality, increase early word-of-mouth advertising of the restaurant by patrons, generate early financial success of the restaurant, etc. The success of other types of promotions tied to a specific event, such as a holiday, a particular person's birthday, a store opening or closing, etc. may also be increased by encouraging recipients of coupons to register or redeem their coupons sooner rather than later. Likewise, the success of a campaign or promotion to build or generate an early mailing or contact list may also be increased by encouraging recipients of coupons to register their coupons sooner rather than later, even if the coupons are not redeemed by coupon recipients for a significant period of time after they are registered by the coupon recipients. In other embodiments, a benefit associated with a coupon may decrease a fixed, random or variable amount each day, week, or other period of time after the coupon is issued so as to encourage people to register or redeem the coupons sooner rather than later.

Another scenario in which a coupon offer issuer may wish to have quick registration or redemption of a coupon by a recipient of the coupon is when the coupon is associated with an expiring or limited quantity product. For example, a grocery store may have many cans of soup in inventory that will expire within a certain period of time. The store may lose money if the store does not sell the cans of soup prior to their expiration date. By providing coupons for the cans of soup to its customers and encouraging coupon recipients to redeem their coupons prior to the expiration date of the cans of soup, the store generates good will with its customers while avoiding a loss created by not selling the cans of soup prior to the expiration date. A similar type of effort may also be desired when promoting other goods or services having limited availability, such as off-season travel packages, limited quantity items, etc.

Another significant advantage of the method 100 of the present invention is that coupon recipients themselves, rather than coupon offer issuers, can perform or complete a majority of the task of circulating the coupons associated with the coupon offer, thereby reducing ill will felt by recipients of coupons toward the coupon offer issuer while potentially increasing the relative success rate of the coupon offer or promotion. The success rate of the coupon offer promotion may be increased since it is reasonable to suppose that initial coupon recipients will usually not want to provide coupons to parties, but may wish to share the coupon offer and its value or benefits with parties they feel might benefit from such a coupon. This may be particularly true in embodiments where the benefit of the coupon associated with the initial recipient increases more when downstream recipients redeem the coupon, an initial or upstream recipient may be selective in forwarding the coupon to those who are most likely to redeem the coupon. Since the initial recipients of the coupon will likely know personally each of the people to whom they forward or otherwise disseminate the coupon (e.g., friends, family members, business associates, club members, co-workers, people having shared interests, etc.), the initial coupon recipients are likely to send the coupons primarily to people they believe will be interested in the coupon, thereby increasing the marketing or promotional success of the coupons by increasing the likelihood that coupons are registered or redeemed or, at the very least, received by interested people. Further, the success rate of a promotional or coupon offer provided in accordance with the present invention will be relatively high since the coupon is forwarded to downstream recipients by someone they know, making it more likely that the downstream recipients of the coupon will pay attention to and use the coupon. This embodiment avoids the problem of inundating customers with unsolicited email, which customers frequently delete or ignore when the source is unknown or untrusted.

Even if a coupon is not redeemed, the coupon offer issuer may obtain or develop benefit from a coupon promotion by a coupon recipient registering the coupon, thereby increasing the size of the coupon offer issuer's database, lead list, or contact list of potentially interested recipients for future promotions or marketing efforts. Thus, a coupon offer issuer is able to obtain contact or lead information for potential consumers that it may not otherwise have been able to obtain. Coupon offer issuers also receive the benefit of having their coupons sent to a targeted market, without bearing the time and expense of performing market research to identify the targeted market.

Another significant advantage of the method 100 of the present invention is that the method can be used with both printed coupons and electronic coupons. In one embodiment or implementation of the method 100, the coupons are forwarded via e-mail, a convenient and inexpensive means for distributing coupons.

Each of the advantages and features of the method 100 will be discussed in further detail below. Referring again to FIG. 1, the method 100 will now be discussed in more detail. As previously discussed above, the method 100 preferably includes a step 102 during which an initial or preliminary benefit of a coupon is established, selected or identified. The initial benefit of a coupon is the benefit that the coupon will have when redeemed by an initial recipient or other user of the coupon, unless the benefit of the coupon is changed after issuance or delivery of the coupon or after receipt of the coupon by the initial recipient, and prior to redemption of the coupon by the initial recipient or another user of the coupon. For example, an initial benefit of a coupon for a tub of butter may be one dollar. An initial or preliminary benefit of a coupon for a television set may be fifty dollars. As previously discussed above, and as will be described in more detail below, the benefit of a coupon may be altered over time based on whether or not certain benefit variation conditions are met. Thus, a benefit of a coupon when the coupon is redeemed may be less than, greater than, or equal to the initial benefit. In some embodiments, an initial benefit for a coupon provided to a recipient may be based, either all or in part, on the recipient's status, personal preferences or interests, coupon registration history, coupon redemption history, etc. Thus, different recipients may have different initial benefits for coupons associated with or provided to the recipients.

Typically, but not necessarily, an initial benefit preferably will be established or selected for one or more coupons that are to be, or have already been, distributed or otherwise provided to one or more initial or upstream recipients. For example, a grocery store may want to provide or distribute coupons in newspapers delivered to subscribers living in the local area, each coupon having an initial benefit of two dollars off a purchase at the grocery store. As another example, a retail store may want to send coupons to one or more previous customers of the store, the coupons having an initial benefit of ten percent off a dinner for two. It should be noted that a store or other entity issuing coupons or providing the coupons to one or more initial recipients can be different from, or the same as, the store or other entity completing the step 102 or the remainder of the method 100. As will be discussed in more detail below, a coupon may have a zero or even negative initial benefit.

Establishment or selection of an initial benefit for a coupon during the step 102 may occur by implication or assumption or in accordance with some other predetermined rule that is used with a plurality of coupons offers. For example, if no initial benefit is actively or explicitly assigned to, or created for, a coupon, the initial benefit of the coupon may be assumed to be zero or some other monetary or default amount.

The method 100 preferably also includes the step 104 during which benefit variation conditions or rules and coupon validity duration conditions or rules are established for the coupon referenced in the step 102. The step 104 can occur prior to, after, or in conjunction with the step 102. Moreover, if desired, establishing an initial benefit for a coupon during the step 102 can be considered as part of establishing a benefit variation condition during the step 104.

Benefit variation conditions for a coupon are one or more rules, heuristics, algorithms, guidelines, procedures, etc. under which a benefit for a coupon may be changed over time after the initial benefit of the coupon is established in the step 102. Under a typical set of benefit variation conditions, a benefit for a coupon may change depending on the actions of one or more initial recipients or downstream recipients of the coupon, which will typically happen after a coupon is issued or otherwise provided to the one or more initial or upstream recipients. Alternatively, or in addition, benefit variation conditions may also be based on external events and benefit variation conditions for a coupon or its associated coupon offer may change during the life span or validity duration of the coupon or its associated coupon offer. For example, a store may want to increase a benefit for a coupon during periods of slow or low sale activity and decrease a benefit, or slow any increases in benefit, for a coupon during periods of high sale activity. As another example, a store may want to increase the benefit of a coupon associated with a specific product or service during periods of high or excess inventory of a product, when a product is about reach its expiration date, when a product or service promotion is tied into or cross-subsidized by another product or service, etc. If desired, benefit variation conditions can change a benefit of a coupon based on the method of payment used by a recipient of the coupon when redeeming the coupon. For example, a recipient of a coupon may see an increase in the coupon's benefit when paying by credit card or debit card as opposed to paying with cash or check. Additionally, benefit variation conditions can change the benefit of a coupon in different ways for different stores, different geographic areas, different times of day, different manufacturers, different suppliers, etc.

Benefits for a coupon may also be staggered in accordance with benefit variation conditions such that a coupon may not be fully redeemed in a single visit to, or single purchase at, a store, chain of stores, mall, etc. For example, a coupon may be established that has an initial benefit. While the benefit of the coupon may increase for a recipient, benefit variation conditions for the coupon may be established such that the recipient may use only the initial benefit during a first visit to a retail store, and any increase in benefit of the coupon during a subsequent visit to the retail store. Thus, the retail store benefits by encouraging repeat visits to the retail store by the recipient and increased purchases by the recipient at the retail store. The recipient benefits from continued use of the coupon and growth in the coupon's benefit. As another example, benefit variation conditions for a coupon may establish that a coupon's benefit will increase if a recipient pays by a specific or designated brand credit card when making a purchase at a retail store when using the coupon. However, the increased amount in the coupon's benefit may only be available at the recipient's next purchase at the retail store and only if the recipient uses the same credit card.

For purposes of the present invention, the phrase “benefit variation conditions” will be used interchangeably with the phrase “benefit variation condition” and the use of the plural term “conditions” shall not necessarily mean that more than one condition exists, is needed, or has been established. Therefore, the establishment, selection or identification of any one benefit variation condition will constitute or suffice for the establishment, selection or identification of benefit variation conditions.

Benefit variation conditions may include one or more qualifying actions or conditions. In some embodiments, a completion or performance of a qualifying action by a recipient of a coupon will result in a change in a benefit of the coupon, either for the recipient and/or one or more of the recipient's upstream recipients. The qualifying actions for a coupon preferably are enumerated, listed, described, selected, or identified in the benefit variation conditions for the coupon established during the step 104. For example, a qualifying action that may increase a coupon's benefit for an initial recipient of the coupon may include the initial recipient receiving or downloading the coupon, redeeming the coupon, registering the coupon, forwarding the coupon, etc. A different qualifying action may be based on actions of people or downstream recipients who receive the coupon or a copy of the coupon from the initial recipient. Thus, the coupon's benefit for the initial recipient is based, at least somewhat, on the completion of qualifying action by such other persons or downstream recipients. For example, the coupon's benefit for the initial recipient may increase when a downstream recipient redeems the coupon, registers the coupon, forwards the coupon, etc., the redemption, registration, or forwarding of the coupon constituting qualifying actions. The benefit increases for the initial recipient may vary depending on how soon or quickly such downstream recipient redeems, registers, or forwards the coupon.

In some embodiments, an external event may trigger a start, end, modification, or availability of a qualifying action or benefit variation condition, such as a sale by a retail store, the end of a business quarter, a notification of excess stock of a product in inventory, an introduction of a new product or service, a phasing out of a previous model of a product, a shortage of a product or service, a cross-marketing event, a special promotion, a natural disaster, etc. For example, a store or coupon offer provider may want to increase the number of available qualifying actions for a coupon during periods of slow or low sale activity and decrease a benefit for a coupon during periods of high sale activity. As another example, a store or coupon offer provider may want to increase the number of qualifying actions associated with a coupon for a specific product or service during periods of high or excess inventory of a product, when a product is about reach its expiration date, etc. As a third example, a store or coupon offer provider may want to increase coupon benefit increments associated with available qualifying actions for a coupon during periods of slow or low sale activity and decrease coupon benefit increments associated with available qualifying actions during periods of high sale activity.

A qualifying actions may have a period of time associated with it such that the completion of the qualifying action will only change a coupon's benefit if the qualifying action is completed within the associated period or time. For example, a qualifying action associated with a coupon may include an initial recipient of the coupon forwarding the coupon to a downstream recipient during a designated two week period. If the initial recipient of the coupon forwards the coupon to a downstream recipient within the designated two week period, the benefit of the coupon for the initial recipient increases by a certain amount. However, the benefit of the coupon for the initial recipient will not increase if the initial recipient forwards the coupon to a downstream recipient after the two week period has elapsed. As another example, a recipient's coupon benefit may increase fifty percent if the recipient forwards the coupon within twenty-four hours or receiving it, but only twenty-five percent if the recipient forwards the coupon after twenty-fours of receiving it and within one week of receiving it, and only five percent if the recipient forwards the coupon after one week of receiving it.

A coupon validity duration condition will generally be one or more rules, procedures, algorithms, heuristics, guidelines, etc. governing the time frame or period for when the coupon is valid, when the coupon terminates or expires, etc. For example, a grocery store may issue a coupon that is valid for one year, although the benefit of the coupon may vary during the one year time period. After the one year period, the coupon expires or terminates since the validity duration conditions for the coupon have been met. A clothing store may issue a coupon that is valid as long as the store remains in business at a certain location. After the store goes out of business, the coupon is expired and is no longer valid. If the store moves to a different location, but stays in business, the coupon is still expired but no longer valid since the validity duration conditions were met once the store changed location. The validity duration of a coupon may be a finite or infinite time. A finite validity duration may be fixed or variable depending on the validity duration conditions established for the coupon.

The step 104 can also be considered to include receiving or establishing implied or assumed validity duration conditions. For example, if a coupon is issued that contains no specifically or explicitly enumerated expiration date, the validity duration conditions for the coupon can be assumed or implied to be some predetermined finite or infinite amount of time for purposes of the step 104. Thus, if desired, establishing of validity duration conditions during the step 104 may occur by implication or assumption or some other predetermined rule that is used with a plurality of coupons. As a result, establishing an explicit validity duration condition for a coupon during the step 104 is not necessary for purposes of the present invention.

Establishing the validity duration conditions for a coupon can happen separately from establishing the benefit variation conditions for a coupon. In addition, different people, computer systems, coupon offer issuers, or other entities may establish the validity duration conditions and the benefit variation conditions. Furthermore, establishing validity duration conditions may occur before either or both of the step 102 or the establishing benefit variation conditions aspect of the step 104. Likewise, establishing benefit variation conditions may occur before either or both of the step 102 or the establishing validity duration conditions aspect of the step 104.

For purposes of further explanation of the present invention, however, validity duration conditions will be considered to be associated with conditions, rules, algorithms, heuristics or guidelines governing when a coupon or its associated coupon offer completely terminates or expires or has a non-changeable zero benefit or value. An expired or terminated coupon preferably will have a zero benefit or value. In contrast to validity duration conditions, benefit variation conditions will be considered to be associated with conditions, rules or guidelines governing how the benefit for a coupon may vary prior to complete termination or expiration of the coupon, i.e., before the validity duration conditions have been met. During such time for a coupon prior to the validity duration conditions for a coupon being met, the coupon has not expired and is still valid. In addition, during the time prior to expiration or termination of the coupon, i.e., prior to the validity duration conditions being met, the benefit of the coupon may be zero, but the benefit of the coupon is changeable and may increase from zero since the coupon has not yet terminated or expired.

Benefit variation conditions may take many forms and the method 100 is not limited to any specific type of benefit variation conditions. For example, in one embodiment of the method 100, an initial recipient of a coupon is encouraged to forward duplicates of the coupon to friends and family, while maintaining a coupon or copy of the coupon for himself or herself. The benefit of the initial recipient's coupon preferably increases for each person, i.e., downstream recipient, he or she forwards the coupon to. In addition, the benefit of the coupon for the initial recipient and/or each of the original downstream recipients receiving the coupon from the initial recipient may increase for each additional downstream recipient to whom one of the original downstream recipients forward the coupon to. If desired, the benefit of the coupon for the initial recipient may increase for each downstream recipient of the coupon, regardless of how many links or people in the chain between each downstream recipient and the initial recipient. Thus, the benefit of the coupon retained by the initial recipient increases based on the recipient's actions and the actions of the people to whom the coupon is subsequently forwarded.

It will be appreciated that for purposes of simplicity of the discussion of the present invention, although the specification refers to forwarding coupon, it should be understood that “forwarding a coupon” is intended to refer to and include “forwarding a duplicate of the coupon” or, in some cases, “forwarding a similar coupon” and that a person forwarding the coupon may also retain the coupon or a copy of the coupon. In addition, “forwarding a coupon” is intended to refer to and include sending or forwarding an invitation to receive a coupon, benefit from a coupon, or retrieve a coupon, rather than the coupon itself. Furthermore, “forwarding a coupon” is intended to refer to and include sending or forward a notice of a web site, address, etc. where a person can obtain, download, or retrieve a coupon.

As another example of benefit variation conditions, an initial recipient may forward a coupon having an initial benefit to one or more downstream recipients, hereinafter referred to as primary recipients. Primary recipients of a coupon receive the coupon from an initial recipient. The benefit of the coupon for the initial recipient may increase each time the initial recipient forwards the coupon to a primary recipient. For example, a coupon having an initial benefit of fifty cents for the initial recipient may increase its benefit by five cents each time the recipient forwards the coupon to a primary recipient. Thus, if the initial recipient forwards the coupon to five people (i.e., five primary recipients), the benefit of the coupon for the initial recipient is then seventy-five cents, the initial benefit of fifty cents plus five cents for each of the five primary recipients.

Each time a primary recipient forwards a coupon to another downstream recipient, hereinafter called a secondary recipient, the benefit for the initial recipient may also increase. Secondary recipients of a coupon receive the coupon from a primary recipient, but not from an initial recipient. Continuing the previous example wherein the initial recipient forwarded the coupon to five primary recipients, assume that three of the five primary recipients forwarded the coupon to two secondary recipients while a different one of the five primary recipients forwarded the coupon to three secondary recipients and the last primary recipient did not forward the coupon to any secondary recipients. If the initial recipient receives an increase in the benefit of the coupon for each secondary recipient of two cents, the benefit of the coupon for the initial recipient is now ninety-three cents. That is benefit of the coupon for the initial recipient is fifty cents plus twenty-five cents (as a result of the initial recipient forwarding the coupon to five primary recipients) plus eighteen cents (as a result of three of the primary recipients forwarding the coupon to two secondary recipients and one of the primary recipients forwarding the coupon to three secondary recipients).

The benefit variation conditions established during the step 104 allow for the initial recipient to benefit from further distribution of the coupon and establish the amount of increase in the benefit obtained by the initial recipient for each further distribution of the coupon. As illustrated by the example given above, the initial recipient is encouraged to forward the coupon to as many primary recipients as possible and to encourage each of the primary recipients to forward the coupon to as many secondary recipients as possible. Of course, the benefit variation conditions can be extended to increase the benefit of the coupon for the initial recipient by further downstream dissemination or forwarding of the coupon by the secondary recipients to tertiary recipients, by further downstream dissemination or forwarding of the coupon by the tertiary recipients to other recipients, etc.

In order to encourage primary recipients to further distribute the coupon, benefit variation conditions for the coupon may be such that the benefit of the coupons received by the primary recipients from the initial recipient may also increase for each secondary recipient to whom the primary recipient forwards the coupon, for each tertiary recipient to whom the secondary recipients for the primary recipient forward the coupon, etc. The benefit variation conditions for a primary or other downstream recipient may be the same as, or different from, the benefit variation conditions for the initial recipient. Thus, once a primary recipient receives a coupon, the primary recipient can be considered as an initial recipient for purposes of computing or otherwise determining the benefit of the coupon for the primary recipient. Thus, for example, for an initial recipient having a first primary recipient and a second primary recipient, a secondary recipient of the initial recipient is a primary recipient of one the initial recipient's two primary recipients, but not both.

In addition to benefit variation conditions, a primary recipient may have the same or different validity duration conditions than the primary recipient's upstream initial recipient had. For example, a validity duration condition may be established during the step 104 that enables a coupon to be valid until the year 2050. Regardless of when a person receives the coupon, the coupon expires or terminals just before the beginning of the year 2050. Thus, the coupon expires on the same day for an initial recipient, the initial recipient's primary recipients, the initial recipient's secondary recipients, etc. As another example, a validity duration condition may be established during the step 104 that enables a coupon to be valid for ten days after receipt or registration of the coupon. Thus, if an initial recipient and all of the initial recipient's primary recipients receive or register the coupon on different days, the coupon may expire or terminate on different days for each of the initial recipient and all of the initial recipient's primary recipients. In a manner similar to the phrases “benefit variation conditions” and “benefit variation condition,” the phrase “validity duration conditions” will be used interchangeably with the phrase “validity duration condition.”

Many other types of benefit variation conditions and associated qualifying actions are possible and the benefit variation conditions may be different for different uses of the method 100. In another implementation of the method 100, a benefit of a coupon for an initial recipient may increase a first amount if the initial recipient registers the coupon within a predefined period of time and a different amount if the initial recipient registers or forwards the coupon after the predefined period of time has elapsed. For example, a coupon having an initial benefit of five dollars may increase its benefit by two dollars if the initial recipient registers or forwards the coupon within five days of receiving the coupon and only fifty cents if the initial recipient does not register or forward the coupon until more than five days after receiving the coupon. In addition, or as an alternative, the benefit may increase an additional by a second amount if the initial recipient redeems or registers the coupon within a another predefined period of time and by a different amount if the initial recipient does not redeem or register the coupon until after the predefined period of time has elapsed. Continuing the previous example, the benefit of the coupon for the initial recipient may increase one dollar if the initial recipient redeems the coupon within ten days of receiving the coupon and/or within three days of registering the coupon or ten cents if the initial recipient redeems the coupon after ten days of receiving the coupon and/or after three days of registering the coupon. In this example, the initial recipient is rewarded for registering and/or redeeming the coupon sooner rather than later, thereby allowing the coupon offer issuer to obtain some early benefits, such as generating a mailing list for later promotions, selling soon-to-expire products, etc.

Benefit variation conditions can use both the variation techniques described above simultaneously. That is, the benefit of a coupon for an initial recipient may increase depending on when the initial recipient registers the coupon, redeems the coupon, or forwards the coupon to one or more primary recipients. In addition, the benefit of a coupon for an initial or upstream recipient may also increase depending on how many downstream recipients of the coupon the initial or upstream recipient has, as previously described above, and/or how soon the initial or upstream recipient's downstream recipients register their coupons, redeem their coupons, forward their coupons, etc. In some embodiments the benefit of a coupon for an initial recipient may increase depending on when the initial recipient forwards the coupon to one or more primary recipients and when such primary recipients register the coupons, particularly when the identity of the initial recipient is known but the identities of the primary recipients are not know until they register the coupons. As illustrated by these examples, very complex benefit variation conditions or qualifying actions can be established during the step 104.

One possible mathematical representation of a benefit variation condition for an initial recipient of a coupon is as follows:
RV_{IR}=vᵢ+c₁(t−x)/t+c₂(t−y)/t+c₃(t−z)/t (1)
where:
RV_{IR} is the benefit in dollars or cents of a coupon for an initial recipient of the coupon;
vᵢ is the initial benefit in dollars or cents of the coupon established during the step 102;
t is the total amount of time in years, months, days, hours, minutes, etc. that the coupon is valid between a start time and an end time, as established by the validity duration conditions;
x is the time from the start date until the initial recipient receives the coupon and 0≦x≦t;
y is the time from the start date until the initial recipient registers the coupon and x <y <t;
z is the time from the start date until the initial recipient redeems the coupon; and y≦z≦t;
c₁ is a value or benefit in dollars or cents equal to zero before the initial recipient receives the coupon and a fixed amount when and after the initial recipient receives the coupon;
c₂ is a value or benefit in dollars or cents equal to zero before the initial recipient registers the coupon and a fixed amount when and after the initial recipient registers the coupon; and
c₃ is a value or benefit in dollars or cents equal to zero before the initial recipient redeems the coupon and a fixed amount when and after the initial recipient redeems the coupon.

As seen in this example, the benefit for the initial recipient RV_{IR} may not be less than the initial benefit vᵢ for the coupon established during the step 102. The values of c₁, c₂ and C₃ can be used to vary the importance of different events. That is, if registration of a coupon is more important to a coupon offer issuer than redemption of the coupon, the value of c₂ after an initial recipient registers a coupon may be greater than the value c₃ has when the initial recipient redeems the coupon. Alternatively, if redemption of a coupon is more important to a coupon offer issuer than registration of the coupon, the value of c₃ after an initial recipient redeems a coupon may be greater than the value of c₂.

The benefit for the initial recipient RV_{IR} will be greater when x, y and z are low relative to t, i.e., when reception, registration, and redemption of the coupon occur sooner rather than later after the start date of the coupon. Reception of a coupon by an initial recipient may coincide with the start date of the time period t and, if desired, the term c₁(t−x)/t can be removed from the equation (1) for RV_{IR}.

While equation (1) does not address the actions of primary recipients, secondary recipients, tertiary recipients, etc. for the initial recipient, a similar equation to equation (1) may be established for each primary recipient, secondary recipient, etc. For example, one possible mathematical representation of a benefit variation condition for a primary recipient is as follows:
RV_{PR}=vᵢ+e₁(t−a)/t+e₂(t−b)/t+e₃(t−d)/t (2)
where:
RV_{PR} is the benefit in dollars or cents of a coupon for the primary recipient of the coupon;
vᵢ is the initial benefit in dollars or cents of the coupon established during the step 102;
t is the total amount of time in years, months, days, hours, minutes, etc. that the coupon is valid between a start time and an end time, as established by the validity duration conditions;
a is the time from the start date until the primary recipient receives the coupon and 0≦a≦t;
b is the time from the start date until the primary recipient registers the coupon and a≦b≦t;
d is the time from the start date until the primary recipient redeems the coupon; and b≦d≦t;
e₁ is a value or benefit in dollars or cents equal to zero before the primary recipient receives the coupon and a fixed amount when and after the primary recipient receives the coupon;
e₂ is a value or benefit in dollars or cents equal to zero before the primary recipient registers the coupon and a fixed amount when and after the primary recipient registers the coupon; and
e₃ is a value or benefit in dollars or cents equal to zero before the primary recipient redeems the coupon and a fixed amount when and after the primary recipient redeems the coupon.

Equation (2) for the primary recipient can work in the same way as equation (1) for the initial recipient. Similar equations can be established for secondary recipients, tertiary recipients, etc. If desired, a total benefit for an initial recipient can be the sum of the equation (1) and similar equations for each of the initial recipient's primary recipients, secondary recipients, etc. For example, one possible mathematical representation of a benefit variation condition for an initial recipient that provides increases to a coupon's benefit based on actions of the initial recipients' primary recipients is as follows:
RV_{T}=RV_{IR}+Σ_{j-1 to k}(RV_{PRj}−vᵢ) (3)
where RV_{T} is the total benefit in dollars or cents for a coupon taking into account an initial recipient and the initial recipient's primary recipients, RV_{IR} is as defined in equation (1) and Σ_{j=1 to k}(RV_{PRj}−vᵢ) represents the sum of equation (2) applied to all k primary recipients for the initial recipient minus the initial benefit vᵢ a k number of times to avoid the multiple counting of the initial benefit vᵢ of the coupon in the value of RV_{T}. Similar equations to equation (3), each with additional terms, can be used to allow actions by secondary recipients, tertiary recipients, etc. to be included in a total benefit calculation for a coupon.

One disadvantage of the benefit variation conditions represented in the equations (1) and (2) is that the coupons have a limited validity duration time oft and equations (1) and (2) do not allow for coupon to have an infinite validity duration time. However, alternative equations can be used which allow for an infinite, or at least very long, validity duration for a coupon.

As additions or alternatives to the benefit variation conditions discussed above, benefit variation conditions can also be established that take the type or status of downstream recipients into account. For example, assume that an initial or upstream recipient forwards a coupon to two downstream recipients, the first of which frequently redeems coupons, and is more likely to be in a database of customers or a mailing list of potential customers for the coupon offer issuer, and the second of which seldom redeems coupons, thereby being less likely to be in the database or on the mailing list. The initial or upstream recipients' coupon benefit may increase by different amounts for the two primary recipients. For example, if the coupon has an initial benefit of one dollar for the initial or upstream recipient, the benefit may go up by ten cents for the first primary recipient (e.g., the person who frequently redeems a coupon) and by fifty cents for the second primary recipient (e.g., the person who seldom redeems a coupon). Such a system allows benefit variation conditions to be applied or associated with a recipient of a coupon and encourages the initial or upstream recipient to forward the coupon to new recipients and to encourage the initial recipient to urge the reluctant second primary recipient to redeem the coupon. Redemption of the coupon by the second primary recipient may be more valuable to the coupon offer issuer, as opposed to redemption of the coupon by the first primary recipient, since redemption of the coupon by the second primary recipient provides an opportunity for the coupon offer issuer to add a person to the database or mailing list that is not likely to already included in the database or mailing list. Benefit variation conditions based on type or status of recipients will be discussed in additional detail below.

During the step 106, a request or notice to redeem a coupon preferably is received, which will also be taken to include receiving a request to determine a benefit of a coupon or receiving a request that a recipient is redeeming a coupon. Such a request may be generated by a recipient, by a store, restaurant, theater, etc. at which the recipient wants to use the coupon, by a coupon validating company, point-of-sale device, etc.

As an alternative to receiving a request to redeem coupon during the step 106, a notice of a completion of a qualifying action may be received during the step 106. As previously discussed above, one or more qualifying actions for a coupon may be established during the step 104. Notices may include a forward indication when a recipient of a coupon forwards the coupon to one or more downstream recipients, a registration indication when a recipient registers a coupon, a redemption indication when a recipient redeems a coupon, a reception indication when a recipient receives a coupon, a qualification completion indication when a recipient completes a qualifying action or when an external event or third party completes, or causes a completion of, a qualifying action, etc. In some embodiments, the notice of a completion of a qualifying action may be assumed to received (even without receipt of an actual or physical notice or message) or may be received by default. That is, in such embodiments the qualifying action will be assumed to be completed unless a notice is received that indicates or states otherwise and no actual physical notice or message of completion of the qualifying action is sent and/or received due to the assumption. As a result, for purposes of elaboration, but not limitation, of the present invention and the claims that follow, a step of receiving notice of a completion of a qualifying action will also include, and be construed to be completed or satisfied by, making an assumption that the qualifying action has or will be completed, or is currently being completed, unless a notice or message is received that indicates or provides otherwise (i.e., that the qualifying action has not been completed). Similarly, for purposes of elaboration, but not limitation, of the present invention and the claims that follow, a step of receiving an indication that a recipient has forwarded, received, registered, or redeemed a coupon, or a duplicate of a coupon, will also include, and be construed to be completed or satisfied by, making an assumption that the coupon has or will be forwarded, received, registered, or redeemed, or is currently being forwarded, received, registered, or redeemed, unless a notice or message is received that indicates or provides otherwise.

Qualifying actions that may be completed by a the recipient may include forwarding a coupon, receiving a coupon, registering a coupon, or redeeming a coupon. Typically, completion of a qualifying action by recipient of a coupon will result in change to the coupon's benefit, either for the recipient or for one or more upstream recipients of the recipient. For example, if a qualifying action is established for registration of a coupon, recipient of the coupon registering the coupon will be deemed to have completed the qualifying action. If a qualifying action is established for forwarding of a coupon, recipient of the coupon forwarding the coupon to a downstream recipient will be deemed to have completed the qualifying action.

During the step 108, the benefit of the coupon being redeemed, or desired to be redeemed, or for which an associated qualifying action has been completed, preferably is calculated, updated, or otherwise determined based on the benefit variation conditions established during the step 104. As previously discussed above, a significant feature of the method 100 is that a coupon's benefit for a recipient can change, potentially right up until the very moment that a recipient desires to redeem the coupon, and possibly even after a recipient has redeemed the coupon. For example, an initial recipient of a coupon may use a credit card or other financial account when making a purchase at a store and redeeming the coupon at the store. If the initial recipient forwards the coupon to a downstream recipient, even after the initial recipient has redeemed the coupon, the initial recipient may seen an increase in his or her benefit of the coupon when the downstream recipient completes a qualifying action, such as registering, redeeming, or forwarding the coupon. Such an increase may be provided to the initial recipient by crediting the initial recipient's credit card, other financial account, store account or credit, etc., or by issuing a new coupon, cash, or check to the initial recipient for the increase in benefit amount. In this manner, the initial recipient is receiving a retroactive change in benefit for the coupon after the initial recipient has redeemed the coupon.

During the step 108, a check may be made to determine that the coupon's validity duration conditions have not been met, i.e., that the coupon is still valid and has not expired. If desired, such as check of the coupon's validity duration conditions may also be conducted by the person, point-of-sale device, computer system or entity making the request or indication received during the step 106, thereby making such a check or determination unnecessary or redundant during the step 108.

If desired, a determination of a coupon's benefit may also be completed by referring to or accessing a database, list, etc. of one or more benefits for one or more coupons associated with one or more recipients. Such a database, list, etc. may be maintained continuously and updated each time a recipient performs a qualifying action or each time an event triggers a completion of a qualifying action, thereby indicating that a benefit for at least one coupon associated with at least one recipient is entitled to be increased or otherwise changed.

After the benefit for a coupon is calculated, updated, or otherwise determined during the step 108, the benefit for the coupon preferably is indicated or provided during the step 110, perhaps to the person, computer system, database, or entity making or providing the request, notice or indication received during the step 106, to an upstream recipient of the coupon, a person or coupon recipient who completed a qualifying action, some other person or entity, etc. Thus, a recipient of a coupon may receive notices of the coupon's benefit each time it changes, periodically, after each five changes, upon request by the recipient, upon the recipient's redemption of the coupon, never, etc. Such a notice may be sent to a recipient of a coupon or another person via email, U.S. mail, telephone call, facsimile machine, etc. An email message sent to a recipient or a coupon or another person may include a portion of software code, a computer program, a script, etc. to update information, a graphic, a database, etc. stored, used, or displayed by the recipient or other person to allow the recipient or other person to have easy and continuous access to, and knowledge of, a coupon's current benefit. In some embodiments, a recipient of a coupon or another person may be beeped or paged every time a benefit changes for a coupon held or being used by the recipient or other person.

If desired, benefits of a coupon for different recipients can be updated, computed or otherwise determined every time a qualifying action occurs relative to one or more of the recipients, only when a recipient desires or attempts to redeem the coupon, continuously, periodically according to fixed or varying schedule, at random time intervals, etc. Moreover, a database, list, etc. of benefits of a coupon for one or more recipients of the coupon can also be maintained and updated or accessed during the step 108 and/or the step 102. In some embodiments, a recipient or other person may access, query or view a centralized database or list to determine a current benefit for a coupon. The coupon's benefit may be continuously or periodically updated to so that such an access, query or view of the centralized database is accurate.

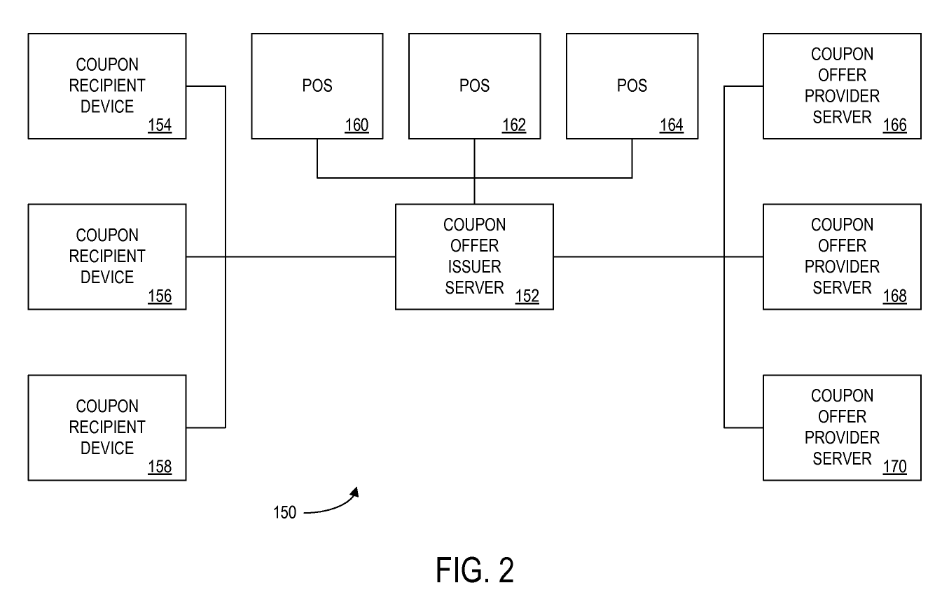

Now referring to FIG. 2, a first example embodiment 150 of an apparatus or system usable with the method 100 will be discussed. The apparatus 150 preferably includes one or more coupon offer issuer servers or controllers 152. The coupon offer issuer server 152 may create or process coupons and distribute or cause distribution of coupons to one or more initial or other upstream recipients. In addition, the coupon offer issuer server may perform all or part of the steps 102 and 104 or be used by a person, computer system or other entity in completing all or part of the steps 102 and 104. In addition, the coupon offer issuer server 152 may complete all or part of the steps 106, 108 and/or 110 or be used by a person, computer system or other entity in completing all or part of the steps 106, 108 and/or 110. The structure, operation and use of coupon offer issuer servers will be discussed in further detail below.

In the system 150 illustrated in FIG. 2, the coupon offer issuer server 152 may be in communication with one or more coupon recipient or client devices 154, 156, 158, one or more point-of-sale (POS) devices or terminals 160, 162, 164, and one or more coupon offer provider servers or controllers 166, 168, 170. Such communication may occur via a telephone network, the Internet, World Wide Web or other computer network, cable network, a cellular telephone network, or any other suitable channels of communication.

Each of the coupon recipient devices or terminals 154, 156, 158 can be used or accessed by one or more recipients to receive coupons. For example, in an implementation where coupons are distributed electronically, the coupon recipient devices 154, 156, 158 may be computers, kiosks, cellular phones, personal digital assistants (PDAs), or other client devices connected to or in communication with the coupon offer issuer server 152 via a computer network. Coupons can be emailed or otherwise electronically transmitted to the coupon recipient or user devices 154, 156, 158. The structure, operation and use of coupon recipient devices will be discussed in further detail below.

Generally, the point-of-sale terminals or devices 160, 162, 164 are used in stores or retailers, such as supermarkets, restaurants, clothing stores, dry-cleaners, gas stations, etc. to create or determine a subtotal corresponding to a customer's purchases or orders and to allow the customer to redeem a coupon. Thus, for example, the point-of-sale terminals 160, 162, 164 may be, or used like, cash registers to determine the total price, pretax and/or post tax, to be paid by the customer for the products and/or services purchased or ordered by the customer, such price being affected by any coupons that the customer is using or redeeming. The structure, operation and use of point-of-sale terminals or devices will be discussed in further detail below.

The coupon offer provider servers 166, 168, 170 may be used to create and distribute coupons. In addition, the coupon offer provider servers 166, 168, 170 may be used to track distribution of coupons. Coupon offer provider servers may be associated with retailers, manufacturers, a chain or collection of stores, etc. If desired, a coupon offer provider server can also function as a coupon offer issuer server, and vice versa.

The coupon offer issuer server 152 can be embodied as a system controller, a dedicated hardware circuit, a programmed general purpose computer, or any other functionally equivalent configurable electronic, mechanical, or electromechanical device. The coupon recipient devices 154, 156, 158, point-of-sale devices or terminals 160, 162, 164, and the coupon offer provider servers 166, 168, 170 can likewise be embodied as dedicated hardware circuits, programmed general purpose computers, or any other functionally equivalent configurable electronic, mechanical, or electromechanical devices. The devices can be in communication with each other and with the coupon offer issuer server 152 via an Internet connection, using a public switched phone network or cable network. Communication may also be provided by dedicated data lines, cellular, Personal Communication Systems (“PCS”), and/or microwave or satellite networks. Using these components, the present invention provides a method, apparatus and system for issuing, forwarding, tracking and redeeming coupons with a variable benefit.

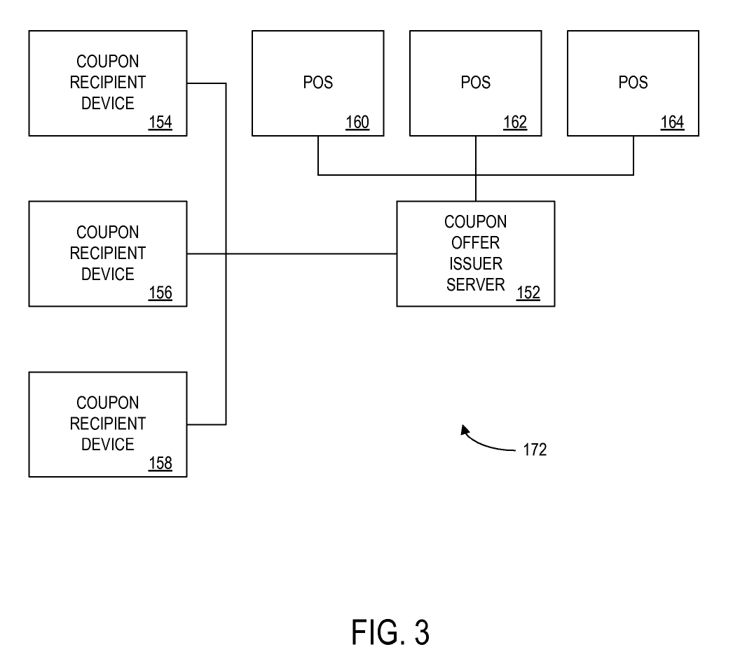

As illustrated in FIG. 3 in a second embodiment 172 of an apparatus usable with the method 100, however, and as previously discussed above, the functions of one or more of the coupon offer provider servers 166, 168, 170 can be performed by the coupon offer issuer server 152.

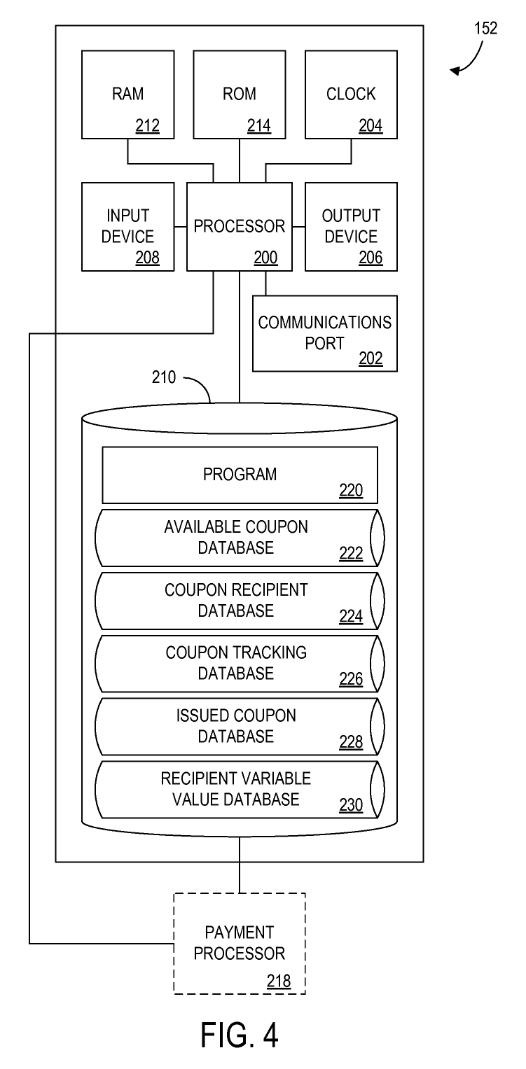

Now referring to FIG. 4, a representative block diagram of a coupon offer issuer server or controller, such as the coupon offer issuer server 152, is illustrated. Note that a coupon offer provider server, such as any one of the coupon offer provider servers 166, 168, 170, may have some or all of the same structure as the coupon offer issuer server.

The coupon offer issuer server 152 may include a processor, microchip, controller, or computer 200 that is in communication with or otherwise uses or includes one or more communication ports 202 for communicating with coupon recipient devices, point-of-sale terminals, coupon offer provider servers, and/or other devices. The communication port 202 may be implemented using a T1 communications board, a serial port and modem, a LAN adapter, or any other communications system.

The coupon offer issuer server 152 may also include an internal clock element 204 to maintain an accurate time and date for the coupon offer issuer server 152, create time stamps for requests or transmissions generated via the coupon offer issuer server 152 or received by the coupon offer issuer server 152, to synchronize the processor 204 or the coupon offer issuer server 152 with other devices, etc. The clock 204 may also be operable to determine the date and time the coupon offer issuer server 152 receives or sends information regarding recipients of coupons, as well as for time related calculations in alternate embodiments described below, such as an amount of time until the expiration date of a coupon.

If desired, the coupon offer issuer server 152 may include one or more output devices 206, such as a printer, infrared or other transmitter, antenna, audio speaker, electro-luminescent array, video display, display screen or monitor, text to speech converter, etc., and the output devices 206 may be operable to display information regarding the status, benefit, etc. of a coupon being sent, received, registered, redeemed, etc.

The coupon offer issuer server 152 may include one or more input devices 208 such as a bar code reader or other optical scanner, infrared or other receiver, antenna, magnetic stripe reader, image scanner, roller ball, touch pad, joystick, touch screen, microphone, computer keyboard, telephone keypad, computer mouse, etc. In addition, the coupon offer issuer server 152 may include a voice recognition system or interactive voice response unit as an input device 208 to aid in or enable receiving, sending and processing of requests to redeem coupons and other transmissions. If desired, the coupon offer issuer server 152 may also function as a coupon recipient device, a point-of-sale terminal, or a coupon offer provider server.

In addition to the above, the coupon offer issuer server 152 may include a memory or data storage device 210 to store information, software, databases, device drivers, product information, customer or recipient information, customer or recipient identifiers, coupon information, coupon benefit information, configuration information, etc. The memory or data storage device 210 preferably comprises an appropriate combination of magnetic, optical and/or semiconductor memory, and may include, for example, Random Access Memory (RAM), Read-Only Memory (ROM), a tape drive, flash memory, a floppy disk drive, a ZIP™ disk drive, a compact disc and/or a hard disk. The processor 200 and the data storage device 210 in the coupon offer issuer server 152 may each be, for example: (i) located entirely within a single microchip, computer or other computing device; or (ii) connected to each other by a remote communication medium, such as a serial port cable, telephone line or radio frequency transceiver. In one embodiment, the coupon offer issuer server 152 may comprise one or more computers that are connected to a remote server computer for maintaining databases.

If desired the coupon offer issuer server 152 may also include other internal memory or memory storage, such as a random access memory (RAM) 212 or a read only memory (ROM) 214, for storing information, programs, databases, operating systems, coupons, recipient information, and like elements.

A conventional personal computer or workstation with sufficient memory and processing capability may be used as the coupon offer issuer server 152. In one embodiment, the coupon offer issuer server 152 operates as or includes a web server for an Internet environment. The coupon offer issuer server 152 transmits and receives data related to coupons generated by coupon recipients and is capable of high volume transaction processing, performing a significant number of mathematical calculations in processing communications and database searches. A Pentium™ microprocessor such as the Pentium III™ microprocessor, manufactured by Intel Corporation may be used for processor 200. Equivalent processors are available from Motorola, Inc., AMD, or Sun Microsystems, Inc. The processor 200 may also comprise one or more microprocessors, computers, computer systems, etc.

In one embodiment, the coupon offer issuer server 152 operates in a telephone environment. In such a system, using a telephone, coupon recipients are prompted by an interactive voice response unit (IVRU) within the coupon offer issuer server 101 to input certain information, such as their name, the name of the retailer or store promoting the coupon or the identifier of the coupon, and the name or identifier of the person from whom the coupon was received. For example, the IVRU may prompt the recipient of the coupon to enter the identifier of the coupon. Once the identifier is entered, the IVRU many prompt the recipient to enter an identifier for the person from whom the coupon was received, and then enter their own information, such as name and telephone number. The recipient may also be prompted to enter a telephone number of a person to whom they want to forward the coupon. Such an embodiment of the coupon offer issuer server 152 affords recipients an alternate mechanism to receive and forward coupons.

In yet another embodiment, the coupon offer issuer server 152 operates as, or in conjunction with, a kiosk in a retail environment. A kiosk is essentially a self-service interactive system, typically a computer system placed inside a box-like structure, or a desktop computer system for use in performing transactions and/or providing information, such as providing a layout of a shopping mall facility to the general public. The kiosk may employ a touch screen as the input device since they are easy to use. However, other input devices such as a mouse or a keyboard may also be used.

In some embodiments, the coupon offer issuer server 152 includes or is further in communication with a payment processor 218 that may include one or more conventional microprocessors supporting the transfer and exchange of payments, charges or debits, attendant to the method 100 or other operation of the apparatus 150. The payment processor 218 can also be configured as part of processor 200. Processing of credit card or other financial account transactions by payment processor 218 may be supported with commercially available server software, such as the Secure Webserver™ software manufactured by Open Market, Inc. This server software may transmit credit card numbers electronically over the Internet to servers located at the Open Market headquarters where card verification and processing is handled. The coupon offer issuer server 152 may use this payment processor 218 in order to credit a financial or store account of the coupon recipient.

Software may be resident and operating or operational on the coupon offer issuer server 152. The software may be stored on the data storage device 210 and may include some or all of the following: a control program 220 for operating the coupon offer issuer server 152; an available coupons product database 222 for storing information coupons previously or currently in operation; a coupon recipient database 224 for storing information about one or more recipients of one or more coupons; a coupon tracking database 226 for storing information regarding dissemination of coupons; an issued coupon database 228 for storing information about coupons that have been disseminated to recipients; and a recipient variable benefit database 230 for storing information and descriptions of types of actual or potential recipients.

The program 220 may also includes instructions for managing the coupon offer issuer server 152, such as calculating a current benefit of the coupon for each respective recipient and a maximum benefit of the coupon. The processor 200 is operable to load and run the control program 220. The control program 220 may also store data accumulated, or computed by, the processor 200 on the data storage device 210. Some or all of the stored data preferably is organized and indexed in one or more of the databases 220, 222, 224, 226, 228, or 230.

Various forms of computer readable media may be involved in carrying one or more sequences of one or more instructions to the processor 200 for execution. The following example illustrates the transmission of computer-readable instructions via a plurality of media. The instructions may initially be stored on a magnetic disk of a remote computer. The remote computer can load the instructions into its dynamic memory and send the instructions over a telephone line using a modem. A modem local to the coupon offer issuer server 152 can receive the instructions from the telephone line and use an infrared transmitter to convert the instructions into an infrared signal. An infrared detector can receive the instructions represented by the infrared signal and transmit the instructions across a system bus to the processor 200. The system bus carries the instructions to a main memory, from which the processor 200 retrieves and executes the instructions. The instructions received by the main memory may optionally be stored elsewhere before or after execution by the processor 200.

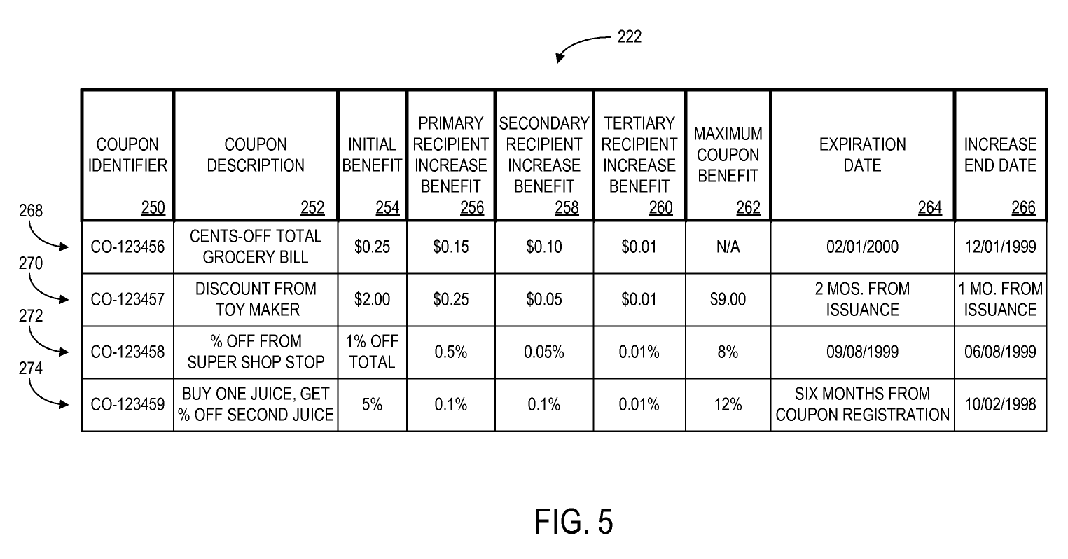

Each of the databases 222, 224, 226, 228 and 230 and their use and potential data structure will be discussed in more detail below. As will be understood by those skilled in the art, the schematic illustrations and accompanying descriptions of the databases presented herein are exemplary arrangements for stored representations of information. A number of other arrangements may be employed besides those suggested by the tables shown. Similarly, the illustrated entries of the databases represent exemplary information only. Thus, those skilled in the art will understand that the number and content of the entries can be different from those illustrated herein. Not all of the databases 222, 224, 226, 228 and 230 will be used or needed in every embodiment of the method 100, the apparatus 150, or the apparatus 172. Furthermore, some embodiments of the method 100, the apparatus 150, or the apparatus 172 may use none or only some of the databases 222, 224, 226, 228, 230. Of course, there may be embodiments of the method 100, the apparatus 150, or the apparatus 172 where all of the databases 222, 224, 226, 228 and 230 are used. One of ordinary skill in the art would recognize that the databases 222, 224, 226, 228, 230 could contain any number of fields and/or records and that the number of fields and/or records illustrated in FIGS. 5-11 is for illustrative purposes only.

The control program 220 may control the processor 200. The processor 200 performs instructions of the control program 220, and thereby operates in accordance with the present invention, and particularly in accordance with the methods described in detail herein. The control program 220 may be stored in a compressed, uncompiled and/or encrypted format. The control program 220 furthermore includes program elements that may be necessary, such as an operating system, a database management system and device drivers for allowing the processor 200 to interface with peripheral devices. Appropriate program elements are known to those skilled in the art, and need not be described in detail herein. According to an embodiment of the present invention, the instructions of the control program 220 may be read into a main memory from another computer-readable medium, such as from a ROM to RAM. Execution of sequences of the instructions in the control program 220 causes processor 200 to perform the process steps described herein. In alternative embodiments, hard-wired circuitry may be used in place of, or in combination with, software instructions for implementation of the processes of the present invention. Thus, embodiments of the present invention are not limited to any specific combination of hardware and software.

A tabular representation of a possible implementation of, or data structure for, the available coupons database 222 is illustrated in FIG. 5. The available coupons database 222 may be used by the apparatus 150 or the apparatus 172 to store information or data regarding available coupons established or initiated by manufacturers, retailers, suppliers, service providers, etc. In addition, the available coupons database 222 may include information related to initial benefits of coupons established during the step 102, benefit variation conditions for coupons established during the step 104, value validity duration conditions for coupons established during the step 104, etc. Each coupon or type of coupon stored in the available coupons database may also have its own coupon identifier. The information in this available coupons database 222 is typically provided by the retailers or manufacturers issuing the coupons, for example, by providing a user identification and password to the system 150 through the point-of-sale devices 160, 162, 164 or through the coupon offer provider server devices 166, 168, 170.

As previously discussed above, a coupon is typically an offer, promise, etc. for a discount or percentage off of a price of a good or as service. In addition, a coupon may be store specific, and/or may be provided by a manufacturer of a good or product or a provider of a service.

The illustrative available coupons database 222 illustrated in FIG. 5 is directed to an implementation of the method 100 where a benefit of a coupon for an initial recipient may increase if the initial recipient forwards or disseminates, or promotes or causes forwarding or dissemination, of a coupon to one or more primary recipients, secondary recipients, tertiary recipients, etc. The illustrative available coupons database 222 illustrated in FIG. 5 includes a coupon identifier field 250 which may include identification information for coupons or coupon offers, a coupon description field 252 which may include descriptive information regarding the coupons identified in the field 250, an initial benefit field 254 which may store information regarding the initial benefit for each coupon provided to a recipient for the coupons identified in the field 250, a primary recipient increase benefit field 256 which may store information regarding how the benefit for a coupon will increase from the initial benefit identified in the initial benefit field 254 for each downstream or primary recipient an upstream or initial recipient forwards a coupon to for each coupon identified in the field 250, a secondary recipient increase benefit field 258 which may store information regarding how the benefit for an initial recipient's coupon will increase from the initial benefit identified in the initial benefit field 254 for each downstream secondary recipient of an initial recipient that receives a coupon for each coupon identified in the field 250, a tertiary recipient increase benefit field 260 which may store information regarding how the benefit for an initial recipients' coupon will increase from the initial benefit identified in the initial benefit field 254 for each downstream tertiary recipient of an initial recipient that receives a coupon for each coupon identified in the field 250, a maximum coupon benefit field 262 which may store information regarding the maximum benefit each coupon for a particular coupon identified in the field 250 may obtain, an expiration or termination date field 264 which may store information regarding when a coupon expires or terminates, thereby causing the benefit of the coupon to become zero, and a benefit increase end date field 266 which may store information regarding when the benefit for a particular coupon identified in the field 250 may no longer increase, although the coupon has not expired or terminated.

The information stored in the fields 254, 256, 258, 260, 262 and 266 of the available coupon database 222 thus comprise some or all of the benefit variation condition information for the coupons identified in the field 250. Similarly, the information stored in the field 266 of the available coupon database 22 comprise some or all of the validity duration conditions for the coupons identified in the field 250.

While the available coupons database 222 illustrated in FIG. 5 provides information for four coupons illustrated in the records 268, 270, 272, 274 identified by or associated with the coupon identifiers “CO-123456,” “CO-123457,” “CO-123458” and “CO-123459,” respectively, in the coupon identifier field 250, there is no theoretical limit to the number of coupons that can be stored in the available coupons database 222 and different fields may be used in the available coupons database 222. The coupon identifier field 250 field preferably stores a unique identifier for each coupon. In the exemplary embodiment of an available coupon database illustrated in FIG. 5, the coupons are numbered consecutively, generally as they might have been received by the coupon offer issuer server 152. Thus, the unique identifier for each coupon corresponds to the order in which it was received by the coupon offer issuer server 152. As illustrated in FIG. 5, the coupon identifier field 250 stores coupon identifiers numbered from “CO-123456” through “CO-123459.” It will be appreciated that the coupon identifiers are not required to be numbered consecutively within the scope of the present invention, nor are they required to be alphanumeric. For example, infrared transmission, bar codes, magnetic stripe cards or data, or any form of identification can be used so long at each coupon can be uniquely identified.

Coupon identifier “CO-123456” corresponds to a coupon for cents-off a total grocery bill, coupon identifier “CO-123457” corresponds to a coupon for a discount from a toy maker, coupon identifier “CO-123458” corresponds to a coupon for a percentage off of an item from a supermarket, and coupon identifier “CO-123459” corresponds to a coupon to receive a percentage off a second juice when you buy a first juice.

The current benefit of the coupon varies depending upon the actions of the recipients of the coupon, i.e., in accordance with established benefit variation conditions. Each coupon has an initial benefit that is stored in the initial benefit field 254. This is the benefit the coupon has to each recipient when that recipient initially receives the coupon. For example, the coupon identified by the coupon identifier “CO-123456” in the field 250 has an initial benefit of twenty-five cents, as indicated in the corresponding initial benefit field 254. This refers to twenty-five cents off a total grocery bill as indicated by the corresponding coupon description field 252 for the coupon identified by the coupon identifier “CO-123456” in the field 250. The coupon identified by the coupon identifier “CO-123457” in the field 250 has an initial benefit of two dollars, as indicated in the corresponding initial benefit field 254. This refers to a two dollar discount from a toy maker as indicated by the corresponding coupon description field 250. The coupon identified by the coupon identifier “CO-123458” in the field 250 has an initial benefit of one-percent off the total price of a selection of goods and/or services from a super shop stop, as indicated by corresponding fields 252 and 254. Finally, the coupon identified by the coupon identifier “CO-123459” in the field 250 has an initial benefit value of five percent off a second item, as shown in the corresponding fields 253 and 254. This refers to five percent off a second juice when one juice is purchased, as indicated by the corresponding coupon description field 252.

As previously discussed above, the illustrative available coupons database 222 shown in FIG. 5 is directed to an implementation of the method 100 wherein benefit of an initial recipient's coupon increases when the initial recipient forwards the coupon to primary recipients and/or the coupon is forwarded or otherwise disseminated to secondary and tertiary downstream recipients of the initial recipient.

Thus, the benefit variation conditions established by the illustrative available coupons database 222 shown in FIG. 5 create a hierarchy and each of the recipients of a given coupon is arranged on a level of the hierarchy. The initial recipient of the coupon is at the top level. The primary recipients, to whom the initial recipient forwards the coupon, are immediately below the top level. The secondary recipients, to whom the primary recipients forward the coupon, are immediately below the primary recipient level. The tertiary recipients, to whom the secondary recipients forward the coupon, are immediately below the secondary recipient level.

As a coupon is forwarded down a hierarchy or recipients, the recipient value of each upstream recipient's coupon increases by an amount determined by the level, with respect to the new downstream recipient of the upstream recipient in the hierarchy. It will be appreciated that the term upstream recipient is intended to refer to a recipient who has directly or indirectly forwarded the coupon to an identified recipient. As explained above, indirectly forwarded is intended to mean forwarded from one recipient to another by way of one or more other recipients.

Similarly, it will be appreciated that the term downstream recipient is intended to refer to a recipient who has directly or indirectly received the coupon from an identified recipient. Although the hierarchical structure of the method of the coupon issuing apparatus 150 and the apparatus 172 has been described with four levels, it will be appreciated that any number of levels may be selected within the scope of the present invention.

The recipients can redeem a coupon at any time before the expiration date of the coupon, as may be set by the coupon's validity duration conditions established during the step 104. Referring again to FIG. 5, the primary recipient increase benefit field 254 stores a primary recipient increase benefit of the coupon. As previously discussed above, this is an amount by which the initial benefit of the initial recipient's coupon increases each time the initial recipient forwards the coupon to another person. In this exemplary embodiment, the person to whom the initial recipient forwards the coupon is known as the primary recipient. Thus, when the primary recipient receives the forwarded coupon, the benefit of the coupon to the primary recipient may be the initial benefit indicated in initial benefit field 254. However, the benefit of the coupon to the initial recipient is the initial benefit plus the primary recipient increase.

As shown in the primary recipient benefit increase benefit field 256 in the example available coupons database 222 illustrated in FIG. 5, the coupon identifier “CO-123456” has a corresponding primary recipient benefit increase of fifteen cents, the coupon identifier “CO-123457” has a corresponding primary recipient benefit increase of twenty-five cents, the coupon identifier “CO-123458” has a corresponding primary recipient benefit increase of five percent, and the coupon identifier “CO-123459” has a corresponding primary recipient benefit increase of one percent.

The secondary recipient increase field 258 stores a secondary recipient benefit increase benefit of the coupons identified in the coupon identifier field 250. This is an amount by which the initial benefit of the initial recipient's coupon increases each time a primary recipient of the initial recipient forwards the coupon to another person. In this exemplary embodiment, all the people to whom a primary recipient of an initial recipient forwards a coupon are known as secondary recipients with respect to the initial recipient. When a secondary recipient receives the forwarded coupon from a primary recipient, the benefit of the coupon to the secondary recipient may be the initial benefit indicated in initial benefit field 254.

In this embodiment, the benefit of a coupon to a primary recipient with respect to an initial recipient is the initial benefit plus the primary recipient increase benefit for each recipient receiving the coupon from the primary recipient. Since a secondary recipient with respect to the initial recipient can be considered to be a primary recipient with respect to a primary recipient of the initial recipient, the benefit of a coupon to the initial recipient is the initial benefit plus the primary recipient increase benefit for each primary recipient and the secondary recipient increase benefit for each secondary recipient. For example, if an initial recipient forwards the coupon to six primary recipients, the benefit of the coupon to the initial recipient is the initial benefit plus the primary recipient increase benefit multiplied by six. If three of these primary recipients each forward the coupon to two people (i.e., secondary recipients with respect to the initial recipient), the benefit of the coupon to the initial recipient becomes the initial benefit of the coupon, plus the primary recipient increase benefit multiplied by six, plus the secondary recipient increase benefit multiplied by two. The benefit of the coupon to each of the three primary recipients who have forwarded the coupon becomes the initial benefit of the coupon plus the primary recipient increase benefit multiplied by two.

In one embodiment, the increase in the benefit of each recipient's coupon is based on the relationship of the person to whom the recipient forwards the coupon to the initial recipient. When an initial recipient forwards a coupon to a primary recipient who forwards the coupon to a secondary recipient with respect to the initial recipient, the benefit of the coupon to the primary recipient with respect to the initial recipient is the initial benefit plus the secondary recipient increase. Using the example set forth above, if three of the six primary recipients with respect to the initial recipient each forward the coupon to two people, the current benefit of the coupon retained by each primary recipient with respect to the initial recipient is the initial benefit plus the secondary recipient increase benefit multiplied by two.

In yet another embodiment, the benefit of a coupon only increases when the recipients complete a qualifying action of the coupon offer issuer server, such as forward, register for, or redeem a coupon. The coupon does not increase automatically when the coupon is indirectly forwarded. For example, the initial recipient can only increase the benefit of a coupon by forwarding the coupon to primary recipients. Primary, secondary, tertiary, etc. recipients with respect to an initial recipient forwarding of the coupon do not affect the benefit of the coupon of the initial recipient.

As shown in the secondary recipient value increase field 258 in the available coupons database 222 illustrated in FIG. 5, the coupon identifier “CO-123456” has a corresponding secondary recipient increase benefit of ten cents, the coupon identifier “CO-123457” has a corresponding secondary recipient increase benefit of five cents, the coupon identifier “CO-123458” has a corresponding secondary recipient increase benefit of five percent, and coupon identifier “CO-123459” has a corresponding secondary recipient value of one percent.

The tertiary recipient increase benefit field 260 stores a tertiary recipient increase of the coupon. This is an amount by which the initial benefit of the initial recipient's coupon increases each time the secondary recipient with respect to the initial recipient forwards the coupon to another person. In this exemplary embodiment, a person to whom the secondary recipient with respect to the initial recipient forwards the coupon is known as the tertiary recipient with respect to the initial recipient. When the tertiary recipient receives the forwarded coupon, the benefit of the coupon associated with the tertiary recipient is the initial benefit indicated in initial benefit field 254. The benefit to the initial recipient is the initial benefit plus the primary recipient increase benefit multiplied by the number of primary recipients the coupon was forwarded to by the initial recipient, the secondary recipient increase benefit multiplied by the number of secondary recipients the coupon was forwarded to by primary recipients, and the tertiary recipient increase benefit multiplied by the number of tertiary recipients the coupon was forwarded to by secondary recipients.

As mentioned above, in one embodiment, the benefit of the coupon only increases when primary downstream recipients complete a qualifying action. The coupon does not increase when indirect recipients of the coupon, such as secondary and tertiary recipients of the recipient in question, complete qualifying actions. In such an embodiment, the benefit of coupon of neither the initial recipient nor the primary recipient increases when the tertiary recipient receives the coupon, but the benefit of the secondary recipient may increase.

Alternately, in embodiments where the benefit of a coupon increases each time the coupon is forwarded by recipients, the benefit of all the recipients' coupon increases. In these embodiments, when the secondary recipient with respect to the initial recipient forwards the coupon to the tertiary recipient with respect to the initial recipient, the benefit of the coupon to the initial recipient is the initial benefit of the coupon plus the primary recipient increase benefit for each primary recipient, plus the secondary recipient increase benefit for each secondary recipient, plus the tertiary recipient increase benefit for each tertiary recipient.

In some embodiments, an initial recipient's tertiary recipient is a primary recipient's secondary recipient and a secondary recipient's primary recipient. Thus, the benefit of the coupon to the primary recipient is the initial benefit of the coupon, plus the primary recipient increase benefit for each secondary recipient, plus the secondary recipient increase benefit for each tertiary recipient. In this example, the benefit of the coupon to the secondary recipient is the initial benefit of the coupon plus the primary recipient increase benefit

In one embodiment, the benefit of a coupon to the primary recipient is the initial benefit of the coupon plus the secondary recipient increase benefit for each secondary recipient plus the tertiary recipient increase benefit for each tertiary recipient. The benefit of the coupon to the secondary recipient is the initial benefit of the coupon plus the tertiary recipient increase benefit.

Referring again to the tertiary recipient increase benefit field 260 in the available coupons database 222 illustrated in FIG. 5, the coupon identifier “CO-123456” has a corresponding tertiary recipient increase benefit of one cent, the coupon identifier “CO-123457” has a corresponding tertiary recipient increase benefit of one cent, the coupon identifier “CO-123458” has a corresponding tertiary recipient increase benefit of one percent, and the coupon identifier “CO-123459” has a corresponding tertiary recipient increase benefit of one cent.

Although the available coupons database 222 and the discussion of the exemplary embodiments are illustrated with a primary, secondary and tertiary recipient increase, any number of recipient increases can be used within the scope of the present invention. The number of recipient increases typically will depend upon a number of intervening recipients between the initial recipient and a final recipient that can receive the forwarded coupon. In addition, although the recipient increases illustrated in FIG. 5 have varying benefits, the same benefits can be used for each increase. Alternately, different recipients may increase the upstream recipients' coupon benefits to a greater or lesser extent. For example, recipients who have never received, registered for, and/or redeemed a coupon from the coupon offer issuer server before may be worth more or less to the system than recipients who already have. The system might, therefore, provide a greater increase to an upstream recipient extending the offer to such downstream recipients.

The maximum coupon benefit field 262 stores a maximum benefit a coupon can attain. Once the benefit of a coupon corresponding to a particular recipient reaches or exceeds this maximum benefit, the benefit of the coupon is set at the maximum benefit, regardless of further action by an initial recipient of the coupon or any downstream recipients of the initial recipient of the coupon. Thus, the coupon can no longer be increased even if it is forwarded or redeemed by downstream recipients, or if downstream recipients register with the coupon offer issuer server. In one embodiment of the coupon issuing system 150, there may be no upper limit to the benefit the coupon may accrue. However, typically, there is some upper limit imposed upon the benefit of the coupon. The maximum benefit of a coupon can be based on various factors. For example, the maximum benefit can be a predetermined fixed benefit. For example, the maximum benefit for a coupon might be three dollars. In other embodiments, the maximum benefit of a coupon for a recipient may be based upon a predetermined total number of downstream recipients of the recipient that can receive the coupon before the benefit of the upstream recipient's coupon can no longer be increased. As indicated above, it will be appreciated that “downstream recipients” is intended to refer to those recipients who directly or indirectly receive the coupon from a particular preceding recipient in the hierarchy. For example, the benefit of the initial recipient's coupon may only increase in benefit until a total of thirty downstream recipients directly or indirectly receive the coupon.

In some embodiments, benefit variation conditions for or associated with a coupon may specify that each level of a hierarchy may have a maximum number of recipients that may receive the coupon and still increase the benefit of the upstream recipient's coupon. For example, with respect to a primary recipient level of the hierarchy, an initial recipient's coupon may increase in benefit only up until six primary downstream recipients have received the coupon. If the initial recipient forwards the coupon to more than six primary recipients, the benefit of the coupon is only increased based on the first six people to whom the coupon has been forwarded. However, the benefit of the initial recipient's coupon may still increase for secondary recipients up until the maximum number of secondary recipients for that level of the hierarchy receive the coupon, regardless of which primary recipient has forwarded the coupon to a secondary recipient.

In other possible embodiments of the coupon issuing systems 150 and 172, the benefit of a coupon increases up to a predetermined level of downstream recipients in the hierarchy relative to the individual forwarding the coupon. For example, the benefit of the recipients' coupon may only increase up to the level of secondary recipients. In such a situation, if the secondary recipients with respect to the initial recipient forward the coupon to tertiary recipients with respect to the initial recipient, the benefit of the initial recipient's coupon is not increased based on those tertiary recipients.

In yet another possible embodiment of the coupon issuing systems 150 and 172, the maximum benefit a coupon can attain is based upon a combination of the previous two embodiments. In such embodiment, the benefit of a coupon increases until either a predetermined benefit of the coupon is reached or a predetermined number of downstream recipients receive the coupon, whichever is preferred by the coupon offer issuer or coupon offer provider. For example, the benefit of the initial recipient's coupon may “cap” at three dollars or the first thirty downstream recipients, whichever benefit is greater. Alternatively, the benefit of the initial recipient's coupon may cap at three dollars or the first thirty downstream recipients, whichever benefit is less, whichever occurs first, or whichever occurs later, as determined by the coupon offer issuer server 152 or otherwise established as the benefit variation conditions during the step 104. In some embodiments, the benefit of the initial recipient's coupon may cap at a retail price of a product, even though the retail price of the product may not be finalized until the coupon is redeemed.

In still another possible embodiment, the maximum benefit of a coupon may be set based on a period of time. For example, the benefit of the coupon may only increase for two weeks from the date of issuance or up until two weeks prior to an expiration or termination date of the coupon, as established by the validity duration conditions established during the step 104, where the expiration date is the date after which the coupon may not be redeemed. Alternately, a coupon may have two expiration dates: one after which the benefit of the coupon may no longer increase, and one after which the coupon may no longer be redeemed, as established by a combination of benefit variation conditions and validity duration conditions established during the step 104.

For example, the maximum benefit of a coupon corresponding to coupon identifier “CO-123456” is “seven dollars, as shown in the maximum coupon benefit field 262 in the available coupon database 222 illustrated in FIG. 5. The initial benefit of this coupon is twenty-five cents, as shown in initial benefit field 254. Thus, the benefit of the cents-off total grocery bill coupon can increase an additional six dollars and seventy-five cents. For example, an initial recipient can forward the coupon to forty-five primary recipients prior to Dec. 1, 1999, each of which increases the benefit of the coupon by fifteen cents for a total of six dollars and seventy-five cents. But, if any of the forty-five primary recipients with respect to the initial recipient later forwarded the coupon to a secondary recipient with respect to the initial recipient, the benefit of the initial recipient's coupon would not increase.

Alternately, the initial recipient can forward the coupon to thirty-five primary recipients. Then, the benefit of the initial recipient's coupon is five dollars and fifty cents (i.e., 35×$0.15=$5.25, $5.25+$0.25, the initial benefit, =$5.50). Thereafter, once fifteen primary recipients with respect to the initial recipient forward the coupon to secondary recipients with respect to the initial recipient, the benefit of the initial recipient's coupon reaches the maximum benefit (i.e., 15×$0.10=$1.50, $1.50+$5.50=$7.00). After that, even if more primary recipients forward the coupon or secondary recipients forward the coupon to tertiary recipients, the benefit of the initial recipient's coupon does not increase beyond the maximum benefit of seven dollars set forth in the maximum coupon benefit field 262.

Although the benefit of an initial recipient's coupon does not increase once it attains the maximum benefit, the benefits of the coupons retained by other recipients in the hierarchy may continue to increase until the maximum benefit of those coupons, as indicated in the maximum coupon benefit field 262, is obtained. For example, if an initial recipient forwards the coupon to forty-five primary recipients (45×$0.15=$6.75), where fifteen cents is the primary recipient increase benefit, the benefit of the initial recipient's coupon reaches the maximum benefit of seven dollars, ($6.75+$0.25=$7.00), where twenty-five cents is the initial benefit of the coupon. However, the forty-five primary recipients with respect to the initial recipient can increase their respective benefits of the coupon by forwarding the coupon to secondary recipients with respect to the initial recipient, who in turn, forward the coupon to tertiary recipients with respect to the initial recipient. Again, the benefit of the coupon corresponding to each recipient continues to increase until the maximum benefit is attained.

Referring again to the coupon database 222 shown in FIG. 5, the expiration date field 264 stores the date after which the coupon is no longer valid, as set by the validity duration conditions established during the step 104. For example, the coupon with coupon identifier “CO-123456” expires on “Feb. 1, 2000” and the coupon with coupon identifier “CO-123457” expires two months from the date of issuance to the initial recipient. Additionally, coupon with coupon identifier “CO-123458” expires on “Sep. 8, 1999,” and coupon with coupon identifier “CO-123459” expires on “Oct. 2, 1999.” The coupon can no longer be redeemed after its respective expiration date.

The increase cut-off date field 266 stores the last date in which the benefit of a coupon can increase and forms part of the benefit variation conditions for the coupon established during the step 104. For example, the coupon with coupon identifier “CO-123456” has an increase cut-off date of “Dec. 1, 1999” and the coupon with coupon identifier “CO-123457” has an increase cut-off date of one month from the date of issuance. Additionally, coupon with coupon identifier “CO-123458” has an increase cut-off date of “Jun. 8, 1999.” In some instances, the expiration date and the increase cut-off date of the coupon may be the same. For example, the coupon with coupon identifier “CO-123459” has an increase cut-off date and an expiration date of “Oct. 2, 1999.” The available coupons database 222 illustrated in FIG. 5 has been described in such a way that recipient increases in the fields 256, 268, 260 are used to increase the benefit of an upstream recipients' coupon when the coupon is forwarded. However, it will be appreciated that the recipient increases can be used in various embodiments. For example, recipient increases in benefits may be used to increase the benefit of a coupon only when the primary, secondary, or tertiary recipient redeems the forwarded coupon or registers with the coupon offer issuer server 152. In yet another embodiment, the recipient increases in benefits may be used to increase the benefit of the coupon when the coupon is forwarded to the primary, secondary, or tertiary recipient and again when the coupon is redeemed by the primary, secondary, or tertiary recipient. Further, in such an embodiment, two different increases in benefits may be used for forwarding and redeeming coupons respectively.

In yet another potential embodiment, recipient increases in benefits may be used to increase the benefit for a coupon when a downstream recipient performs one or more of forwarding, registering or redeeming a coupon. Each of the activities or qualifying actions, separately or in combination, may have different recipient increase benefits based on the activity and the benefit of that activity to the coupon offer issuer server 152. For example, the primary recipient benefit increase for a given coupon may be five cents if the initial recipient forwards the coupon to a primary recipient, but the primary recipient increase may be seven cents if that primary recipient registers with the coupon offer issuer server 152. Alternately, if a primary recipient redeems a coupon, the primary recipient benefit increase may be some other amount. Mechanisms and techniques for how the coupon offer issuer server 152 determines that a coupon has been forwarded, registered or redeemed will be discussed in further detail below.

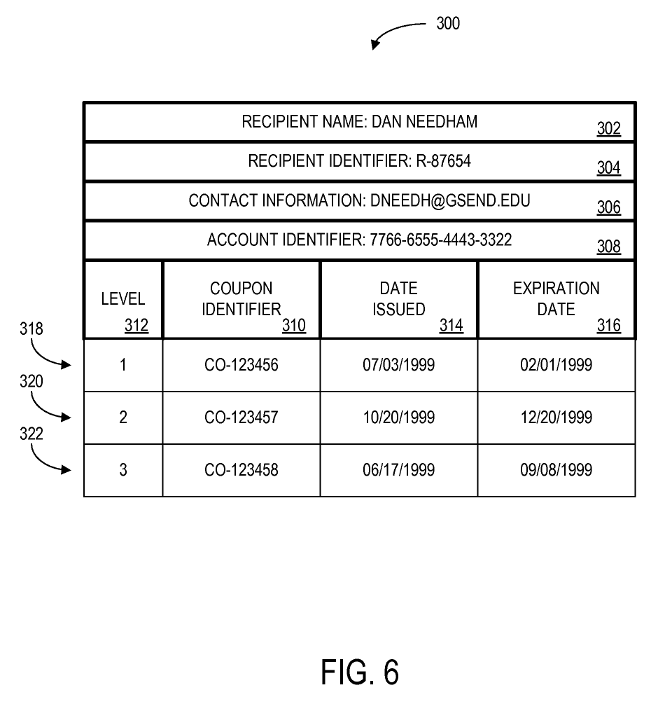

As previously discussed above, a coupon recipient database, such as the coupon recipient database 224, preferably stores information and data regarding each recipient of a coupon. A tabular representation of a possible implementation of, or data structure for, a record 300 for the coupon recipient database 224 is illustrated in FIG. 6. The record 300 may include a recipient name field 302 which may store a name of a recipient of a coupon and a recipient identifier field 304 which may store a distinct identifier for the recipient named in the field 302. A recipient identifier field 304 may be helpful in distinguishing recipients when multiple recipients have identical or similar names or identifying a recipient when the recipient goes by more than one name or has several variations of his or her name. Each recipient may be assigned or allowed to create a unique recipient identifier. Recipients may also or alternately be assigned or create a passcode to access information regarding their coupons. Using the recipient identifier that corresponds to the recipient identifier 304, a recipient can access his coupon account via the coupon offer issuer server 152 or associated web page in order to view the current benefits of any of his valid coupons.

The record 300 may also include a contact information field 306 which may store information regarding mailing addresses, home address, telephone numbers, e-mail addresses, shopping habits, personal preferences, or other contact or personal information for the recipient identified in the field 304. For example, the recipient's name is “Dan Needham” and his e-mail address is “DNEEDH@GSEND.EDU” as stored in field 402. The field 306 may also contain other personal information pertaining to the recipient.

A recipient's record may also include an account identifier field 308 which may store information regarding how to credit the recipient for any excess benefit a coupon may have accrued after the recipient has redeemed the coupon, or for any other credits or debits made by the coupon offer issuer or coupon offer provider to the recipient, in accordance with some embodiments of the present invention. Thus, the method 100 of the present invention allows for a recipient of a coupon to increase the benefit of the coupon even after the recipient has redeemed the coupon, thereby providing a credit that can be used by the recipient for other purposes or in other situations. The duration, maximum limit, and use of the credited benefit of a coupon may be controlled or monitored by the coupon offer issuer server 152 and may be governed by benefit variation conditions established during the step 104 or at some other time. In addition, if desired, credits for multiple excess benefits for multiple coupons redeemed by a recipient may be aggregated to form a single excess benefit credit for the recipient. Credits or debits may have a monetary benefit. While the account identifier field 308 for the record 300 stores a credit card account, although the field 308 may also identify a bank account, an account with the coupon offer issuer server, or any other account where a recipient may receive credits and/or debits.

The coupon identifier field 310 for the record 300 may store a coupon identifier of each of the coupons retained or received by the recipient having the recipient identifier stored in field 304. For example, Dan Needham has retained three coupons 318, 320, 322 identified by “CO-123456,” “CO-123457,” and “CO-123458,” respectively, in the coupon identifier field 310. The coupon identifier field 310 has a corresponding recipient level field 312 that identifies in which level of the hierarchy the recipient is with respect to each coupon. For example, Dan Needham is in level “1” of the hierarchy for coupons “CO-123456” and “CO-123458,” as shown in the recipient level field 312, indicating that Dan Needham is the initial recipient of these coupons. As for the coupon “CO-123457,” Dan Needham is in level “2” as shown in the recipient level field 312, indicating that Dan Needham is a primary recipient of this coupon.

The record 300 may also include a date issued field 314 indicating the date on which a respective coupon was issued by the coupon offer issuer server 152 to the particular recipient, in this case “Dan Needham,” and an expiration date field 316 indicating the last date that the coupon can be redeemed. The expiration date field 316 can be determined from the validity duration conditions established during the step 104. In general, the expiration date field 316 of the record 300 for the coupon recipient database 224 stores the same information as expiration date field 264 of the available coupons database 222 illustrated in FIG. 5.

Referring again to record 300, it can be seen that the coupon “CO-123456” was issued to “Dan Needham” on “Jul. 3, 1999” and expires on “Feb. 1, 1999,” as shown in date issued field 314 and expiration date field 316, respectively. The coupon “CO-123457” was issued on “Oct. 20, 1999” and expires on “Dec. 20, 1999” and the coupon “CO-123458” was issued on “Jun. 17, 1999” and expires on “Sep. 8, 1999.” It should be noted that the information in coupon identifier field 310 for the record 300 corresponds to the information in the coupon identifier field 250 in the available coupons database 222.

While the record 300 illustrated in FIG. 6 for the coupon recipient database 224 provides information for three coupons 318, 320, 322 identified by the coupon identifiers “CO-123456,” “CO-123457” and “CO-123458,” respectively, in the coupon identifier field 310, there is no theoretical limit to the number of coupons that can be stored for a recipient in the stored in the record 300 or the number of recipients for which information can be stored in the coupon recipient database 224 and different fields may be used in the record 300 and in the coupon recipient database 224.

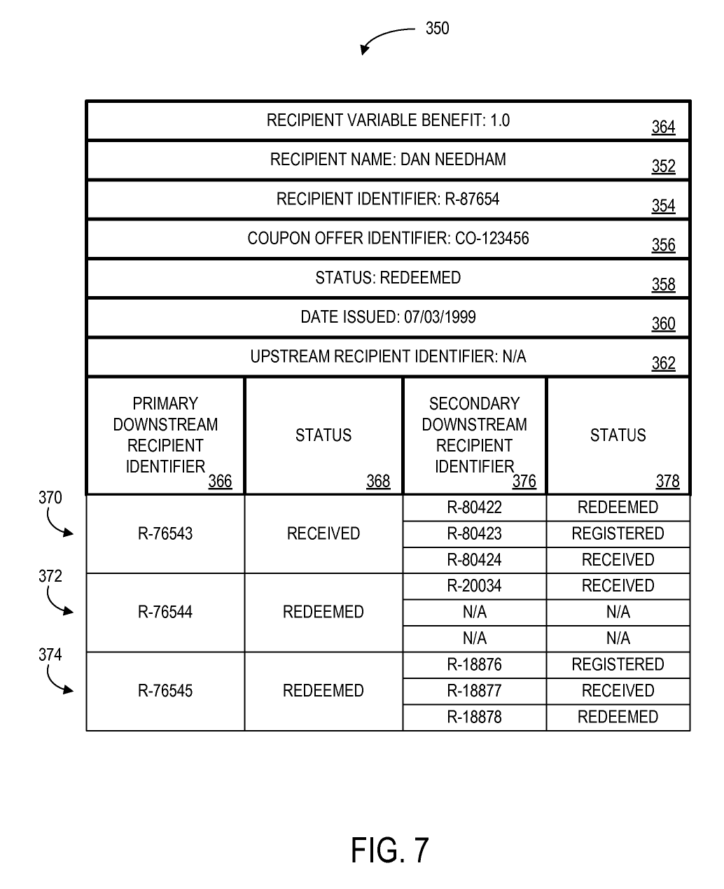

As previously discussed above, the coupon tracking database 226 can be used to store information and data regarding the status of issued coupons as they pertain to particular recipients. A tabular representation of a possible implementation of, or data structure for, a record 350 for the coupon tracking database 226 is illustrated in FIG. 7.

In a similar fashion to the record 300 in the coupon recipient database 224, the record 350 may include a recipient name field 352 which may store a name of a recipient of a coupon and a recipient identifier field 354 which may store a distinct identifier for the recipient named in the field 352. The record 350 may also include a coupon identifier field 356 which may contain identification information for a specific coupon associated with the recipient identified in the field 354, a status field 358 which may contain information regarding the status of the coupon identified in the field 356 relative to the recipient identified in the field 354, a date issued field 360 containing information for the coupon identified in the field 356, and an upstream recipient identifier field 362 which may contain information regarding one or more upstream recipients for the recipient identified in the field 354. An upstream recipient identified in the field 362 will be a person, computer system or other entity who forwarded or otherwise provided the coupon identified in the field 356 to the recipient identified in the field 354. The upstream recipient identifier field 354 stores the recipient identifier of the recipient from whom the coupon was received. As shown in the record 350, this upstream recipient identifier field 362 indicates “N/A.” Since the record 350 is a record of the initial recipient, i.e., “Dan Needham,” who has solicited or received the coupon from the coupon offer issuer rather than from a prior recipient, the field 362 does not have an upstream recipient identifier.

The coupon identifier field 356 stores the unique identifier of the coupon that has been retained by this recipient identified in field 354. The coupon offer issuer server 152 tracks the recipients of the coupon by storing an indication of who forwarded a coupon to each recipient, and to whom each recipient in turn forwarded the coupon. As shown, the record 350 tracks the recipients of coupon “CO-123456” as it pertains to recipient “R-87654.”

Each coupon that the coupon offer issuer server 152 issues to a recipient preferably has a corresponding record in the issued coupons database 228 that indicates or identifies a recipient or person to whom the recipient forwarded the coupon, and the status of that recipient's or person's coupon. As downstream recipients perform qualifying actions that increase the benefit of upstream recipients' coupons, the coupon offer issuer server 152 credits the upstream recipients' account. For example, as “Dan Needham” forwards the coupon to primary recipients who then forward the coupon to secondary recipients with respect to him, the coupon offer issuer server 152 updates the accounts of “Dan Needham” and the primary recipients. While the example being discussed above is based on forwarding of coupon offers, in other embodiments the coupon offer issuer server may only track redemption of coupons and not forwarding of coupons, registration of coupons and not forwarding of coupons, etc.

The record 350 may also include a recipient variable benefit field 364 which may contain information regarding a multiplier, benefit addition or subtraction, or other data regarding a type or status associated with the recipient identified in the field 354.

This recipient variable benefit preferably is specific to each recipient of a coupon and may be based upon a variety of factors. Recipient variable benefits may be stored in the recipient variable benefit database 230 which will be discussed in further detail below. Thus, in this exemplary embodiment, the greater the recipient variable benefit the greater the benefit of the coupon. The variable benefit field 364 allows a coupon offer issuer server or a point-of-sale device to increase or decrease the benefit of the incremental increase to an upstream recipient's coupon, based on the variable benefit of his downstream recipients to the coupon server.

Types of recipient statuses are stored in the recipient variable benefit database 230. For example, if a recipient has never received a coupon before, that recipient may have a recipient variable benefit of “1.4.” If the recipient has never registered with the coupon offer issuer server 154, then that recipient may have a recipient variable benefit of “1.3.” If the recipient has never redeemed a coupon then, that recipient may have a recipient variable benefit of “1.2.” On the other hand, if the recipient has previously received a coupon, previously registered a coupon, or previously redeemed a coupon, then that recipient may have a variable benefit of “1.0.” Alternately, if the recipient has frequently received coupons or frequently redeemed coupons, then that recipient may have a variable benefit of “0.8” or “0.9,” respectively.

Use of the recipient variable benefit is intended to encourage recipients to forward coupons to those individuals who may have higher recipient variable benefits than other potential recipients. Since the individuals with a higher recipient variable benefit are typically new recipients or new to the coupon offer issuer server, the pool of coupon recipients continues to expand.

The record 350 may also include a primary downstream recipient identifier field 366 which can include information regarding primary downstream recipients of the recipient identified in the field 354 for the coupon identified in the field 356. Thus, each recipient identified in the field 366 is a primary downstream recipient of the recipient identified in the field 354. The record 350 may also contain a status field 368 containing information for each of the downstream recipients identified in the field 366 regarding each downstream recipient's status for the coupon identified in the field 356 and forwarded to the downstream recipient by the recipient identified in the field 354. The recipient identified in the field 354 may have many primary downstream recipients identified in the field 366.

For the primary downstream recipients identified in the field 366, such as the primary recipients 374, 376, 378 identified by the primary recipient identifiers “R-76543,” “R-76544” and “R-76545,” respectively, the record 350 may include a secondary downstream recipient identifier field 376 which may include information regarding secondary downstream recipients of the recipient identified in the field 354. Each primary recipient identified in the field 366 may have many associated secondary recipients identified in the field 376. In a manner similar to the status field 368 for the primary recipient identifier field 366, each associated secondary downstream recipient identified in the field 376 may have a corresponding status for the coupon identified in the field 356. Such status information for the secondary downstream recipients may be stored in a status field 378.

As illustrated in the example record 350 shown in FIG. 7, the recipient “Dan Needham” has three primary downstream recipients “R-76543,” “R-76544” and “R-76545” for the coupon identified by “CO-123456” in the field 356. The primary recipient “R-76543” has received the coupon while the primary recipients “R-76544” and “R-76545” have both redeemed the coupons as indicated in the status field 368. The primary recipient “R-76543” has three associated secondary recipients “R-80422,” “R-80423” and “R-80424” for the coupon as identified in the secondary recipient field 376. The secondary recipient “R-80422” has redeemed, the coupon as indicated by the status field 378, while the secondary recipient “R-80423” has registered the coupon and the secondary recipient “R-80424” has received the coupon.

In a similar manner to the primary recipient “R-76543,” the primary recipient “R-76544” has redeemed the coupon identified in the field 356 and has one associated secondary recipient “R-20034” who has received the coupon identified in the field 356. Likewise, the primary recipient “R-76545” has redeemed the coupon identified in the field 356 and has three associated secondary recipients “R-18876,” “R-18877” and “R-18878.” The secondary recipient “R-18876” has registered the coupon identified in the field 356, the secondary recipient “R-18877” has received the coupon identified in the field 356, and the secondary recipient “R-18878” has redeemed the coupon identified in the field 356.

The record 350 is directed to the coupon “CO-123456,” as illustrated in the field 356, which was issued on Jul. 3, 1999, as provided by the field 360 and redeemed by the recipient “Dan Needham,” as indicated in the recipient name field 352 and the status field 358. The recipient “Dan Needham” has no upstream recipients with regard to the coupon “CO-123456,” as illustrated by the upstream recipient identifier field 362.

The coupon tracking database 226 may include additional records associated with the recipient “R-87654” identified in the field 354 for other coupons. Similarly, the coupon tracking database 226 may include additional records associated with the coupon “CO-123456” identified in the field 356 for additional initial, primary, secondary, tertiary, etc. recipients of the coupon.

The recipient of the coupon “R-87654,” identified in the field 352 of the record as “Dan Needham,” may access his account via a personal Uniform Resource Locator (URL) with an embedded session key or other identifier unique to the recipient. The session key may act as the recipient's personal identifier, or may be used in conjunction with a recipient identifier to access the coupon offer issuer server web page. It will be appreciated by one of ordinary skill in the art that a URL is a standard way developed to specify the location of a resource available electronically. It will also be appreciated that a session key is an identifier embedded in or attached to a URL that a web site's browser may issue to those who access the site.

In other embodiments, a recipient may access a personal web page with a user name and pass code that details an account of coupons attained by the customer. If a person utilizes a URL issued by the web browser to a specific recipient, the web browser can assume the person is the individual to whom the web browser originally issued the URL.

Alternately, the benefit of the recipient's coupon may be updated and displayed on the recipient's computer monitor. In one embodiment, the coupon offer issuer server 152 updates the benefit of each recipient's coupon in real-time. The coupon offer issuer server 152 can communicate with the recipient via the recipient's e-mail address. In particular, an attachment or program included in an e-mail from the coupon offer issuer server 152 may trigger the file update when opened by the recipient.

For example, each time a downstream recipient performs an action that increases the benefit of an upstream recipient's coupon, the coupon offer issuer server 152 sends an e-mail with an attachment. When the attachment is opened, a program is executed that updates the benefit represented on the upstream recipient's icon. A Postlt Desk Top Note® from 3M Corporation or a program such as a Java Applet could sit on the recipient's computer desktop, and receive file updates from a computer executable program attached to an e-mail message. Whenever the recipient received and opened an e-mail notifying him of an increase in his coupon benefit, the program in the e-mail would increase the representation of the benefit of the coupon on the Postlt Desk Top Note®. Such updates may be performed periodically, automatically or upon request by the recipient, although other updating options are available.

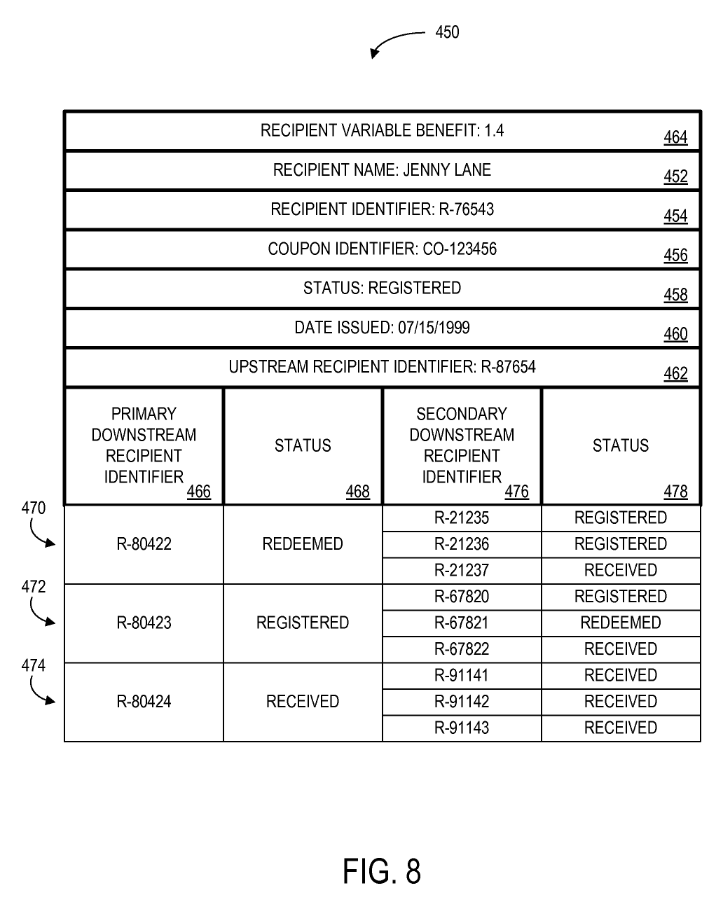

Now referring to FIG. 8, another possible record 450 for the coupon tracking database 226 is illustrated. In a similar manner to the record 350, the record 450 may include a recipient name field 452, a recipient identifier field 454, a coupon identifier field 456, a status field 458, a date issued field 460, an upstream recipient identifier field 462, and a recipient variable benefit field 464. Also in a manner similar to the record 350, the record 450 may include a primary downstream recipient identifier field 466, a status field 468 associated with the primary recipients 472, 474, 476 identified in the primary downstream recipient field 466, a secondary downstream recipient field 476, and a status field 478 associated with the secondary recipients identified in the secondary downstream recipient field 476.

As shown by the fields 452, 454, 456, 458 and 462 in the record 450, the recipient “Jenny Lane” identified by the recipient identifier “R-76543” received the coupon “CO-123456” from the upstream recipient “R-87654” and has registered the coupon “CO-123456.” The upstream recipient “R-87654” is the recipient “Dan Needham” as shown by the field 462 for the record 450 the recipient identifier field 354 for the record 350. The field 462 acts as a link that enables the coupon offer issuer server 152 to determine which upstream recipients' records to update based on the qualifying action of “Jenny Lane.” “Jenny Lane” is a primary recipient of “Dan Needham” and “Dan Needham” is an upstream recipient of “Jenny Lane” with respect to the coupon “CO-123456.” In this exemplary embodiment, “Jenny Lane's” recipient variable benefit is “1.4,” which may indicate that “Jenny Lane” is a recipient who has never received a coupon before.

As previously discussed above, “Jenny Lane” is a primary recipient for “Dan Needham.” In addition, as illustrated by the secondary downstream recipient identifier field 376 in the record 350, the recipients “R-80422,” “R-80423” and “R-80424” are secondary recipients for “Dan Needham.” However, the recipients “R-80422,” “R-80423” and “R-80424” are primary recipients with respect to “Jenny Lane,” as indicated in the primary downstream recipient field 466 in the record 450. Likewise, the entries associated with the secondary recipients “R-80422,” “R-80423” and “R-80424” in the secondary recipient status field 378 in the record 350 correspond to the entries associated with the primary recipient status field 468 in the record 450.

The primary recipients “R-80422,” “R-80423” and “R-80424” with respect to “Jenny Lane” each have three associated secondary recipients with respect to “Jenny Lane,” and who constitute tertiary recipients with respect to “Dan Needham” even though they are not listed or recorded in the record 350. For example, the primary recipient “R-80422” identified in the primary downstream recipient field 466 in the record 450 for “Jenny Lane,” and in the secondary downstream recipient field 376 in the record 350 for “Dan Needham,” has three secondary recipients “R-21235,” “R-21236” and “R-21237” as identified in the secondary downstream recipient identifier field 476. The recipients “R-21235,” “R-21236” and “R-21237” are secondary recipients with respect to “Jenny Lane” and tertiary recipients with respect to “Dan Needham.” As shown in the status field 478, the recipients “R-21235” and “R-21236” have both registered the coupon “CO-123456” while the recipient “R-21237” has received the coupon.

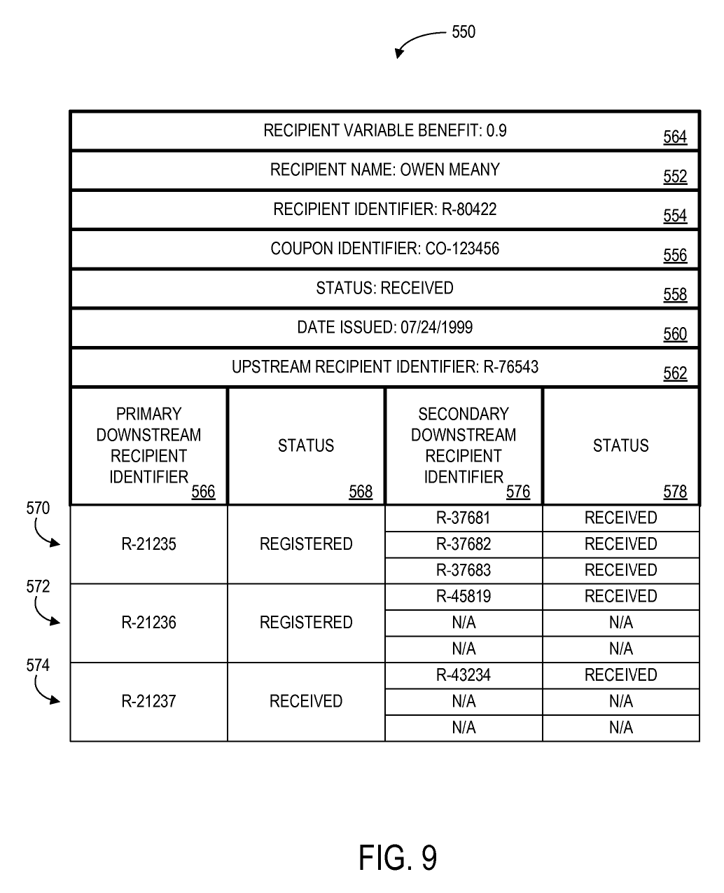

Now referring to FIG. 9, another possible record 550 for the coupon tracking database 226 is illustrated. In a similar manner to the records 350 and 450, the record 550 may include a recipient name field 552, a recipient identifier field 554, a coupon identifier field 556, a status field 558, a date issued field 560, an upstream recipient identifier field 562, and a recipient variable benefit field 564. Also in a manner similar to the records 350 and 450, the record 550 may include a primary downstream recipient identifier field 566, a status field 568 associated with the primary recipients 572, 574, 576 identified in the primary downstream recipient field 566, a secondary downstream recipient field 576, and a status field 578 associated with the secondary recipients identified in the secondary downstream recipient field 576.

As shown by the fields 552, 554, 556, 558 and 562 in the record 550, the recipient “Owen Meany” identified by the recipient identifier “R-80422” received the coupon “CO-123456” from the upstream recipient “R-76543.” The upstream recipient “R-76543” is the recipient “Jenny Lane” as shown in the recipient identifier field 454 for the record 450. Thus, “Owen Meany” is a primary recipient of “Jenny Lane” and a secondary recipient of “Dan Needham.” The recipient “Jenny Lane” is an upstream recipient of “Owen Meany” with respect to the coupon “CO-123456.” The recipient identifier “R-76543” for “Owen Meany” is recorded in the primary downstream recipient identifier field 466 of the record 450 for “Jenny Lane.”

“Owen Meany” is a primary recipient of “Jenny Lane” who is, in turn, a primary recipient for “Dan Needham.” Thus, “Owen Meany” is a secondary recipient of “Dan Needham.” In addition, as illustrated by the secondary downstream recipient identifier field 476 in the record 450, the recipients “R-21235,” “R-21236” and “R-21237” are secondary recipients for “Jenny Lane” and, as a result, are tertiary recipients for “Dan Needham.” However, the recipients “R-21235,” “R-21236” and “R-21237” are primary recipients with respect to “Owen Meany,” as indicated in the primary downstream recipient field 566 in the record 550. Likewise, the entries associated with the secondary recipients “R-21235,” “R-21236” and “R-21237” in the secondary recipient status field 478 in the record 450 correspond to the entries associated with the primary recipient status field 568 in the record 550.

The primary recipient “R-21235” with respect to “Owen Meany” has three associated secondary recipients “R-37681,” “R-37682” and “R-37683” with respect to “Owen Meany,” each of whom constitutes a tertiary recipient with respect to “Jenny Lane” and each of whom has receive the coupon “CO-123456.” Both of the primary recipients “R-21236” and “R-21237” with respect to “Owen Meany” have one secondary downstream recipient who has received the coupon “CO-123456.”

As previously discussed above, the issued coupon database 228 can be used to store information and data regarding the benefit of recipients' coupons. The issued coupon database 228 may also be used to store pertinent data regarding the changing benefit of an identified recipient's coupon due to the participation of the recipients downstream from the identified recipient.

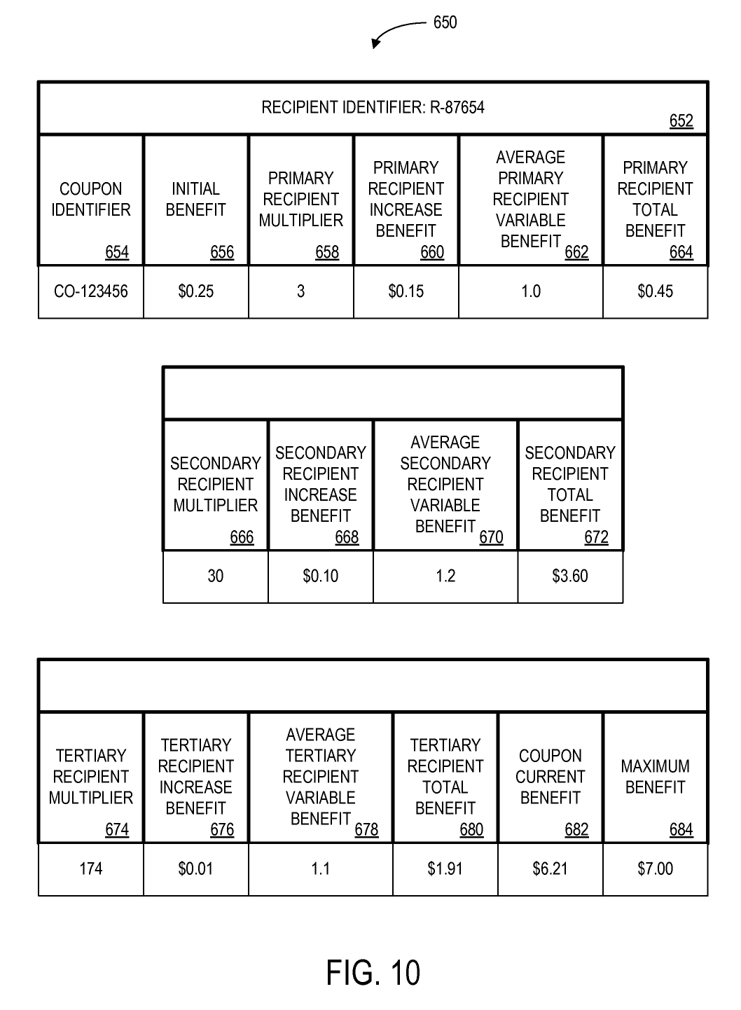

A tabular representation of a possible implementation of, or data structure for, a record 650 for the issued coupon database 228 is illustrated in FIG. 10. The record 650 illustrated in FIG. 10 for the issued coupon database 228 is directed to an implementation of the method 100 wherein the benefit variation conditions or rules established during the step 104 allow the benefit for an initial recipient's coupon to vary depending on the activities or qualifying actions of downstream recipients of the initial recipient. Thus, an initial recipient's coupon benefit will increase for each primary, secondary, and tertiary recipient of the initial recipient receiving the coupon. The benefit variation conditions reflected in the record 650 illustrated in FIG. 10 for the issued coupon database 228 also allow a benefit for a coupon to vary depending on the recipient variable benefits for recipients, such as the recipient variable benefits in the fields 364, 464 and 564 of the records 350, 450 and 550, respectively.

The record 650 is directed to a specific recipient and a specific coupon, as reflected in a recipient identifier field 652 and the coupon identifier field 654. The issued coupon database 228 may include additional records for the recipient identified in the field 652 and other coupons and additional records for the coupon identified in the field 654 and other recipients.

The record 650 may include an initial benefit field 656 which may contain the initial benefit for the coupon identified in the field 654 and which was established during the step 102. The record may also include a primary recipient multiplier field 658 which may contain information regarding the number of primary recipients of the coupon identified in the field 654 for the recipient identified in the field 652, a primary increase benefit field 660 which may contain information regarding the increase in benefit for the coupon identified in the field 654 for each of the primary recipients of the recipient identified in the field 652, an average primary recipient variable benefit field 662 which may contain the average of variable benefits for each of the primary recipients of the recipient identified in the field 664.

As illustrated in the fields 652, 654, 656, 658 and 660 of the record 650, the recipient “R-87654” has three primary recipients, each of which increases the initial benefit of twenty-five cents for the coupon “CO-123456” by fifteen cents. The average primary recipient variable benefit of the three primary recipients is 1.0, as provided in the field 662. Thus the primary recipient total benefit for the coupon “CO-123456” identified in the field 654 is forty-five cents ($0.15×3×1.0=$0.45). The average primary recipient variable benefit generates a multiplier or proportional result for the additional benefit of the coupon “CO-123456” provided by the primary recipients. Thus, the higher the average primary recipient variable benefit, the higher the benefit of the coupon. The recipient variable benefit for a recipient of a coupon can be based on many factors, such as the type or status of the recipient, the frequency of the recipient's redemption of coupons, etc.

As illustrated by the benefit variation conditions implemented in the record 650, the benefit for the coupon identified in the field 654 for the recipient identified in the field 652 increases as a result of the recipient forwarding the identified coupon to primary recipients. In addition, the benefit variation conditions implemented in the record 650 also allow a recipient's benefit for the identified coupon to increase for each secondary recipient of the coupon for the recipient identified in the field 652. Thus, the record 650 includes a secondary recipient multiplier field 666 that works in a similar manner to the primary recipient multiplier field 658, a secondary recipient increase benefit field 668 that works in a similar manner to the primary recipient increase benefit field 660, an average secondary recipient variable benefit field 670 that works in a similar manner to the average primary recipient variable benefit field 662, and a secondary recipient total benefit field 672 that works in a manner similar to the primary recipient total benefit field 664.

As illustrated in the fields 666, 668 and 670 of the record 650, the recipient “R-87654” has thirty secondary recipients, each of which increases the initial benefit of twenty-five cents for the coupon “CO-123456” by ten cents. The average secondary recipient variable benefit of the three secondary recipients is 1.2, as provided in the field 670. Thus the secondary recipient total benefit for the coupon “CO-123456” identified in the field 654 is three dollars and sixty cents ($0.10×30×1.2=$3.60), as provided in the field 672.

The benefit variation conditions implemented in the record 650 for the coupon identified in the field 654 for the recipient identified in the field 652 also increases as a result of the recipient's secondary recipients forwarding the identified coupon to tertiary recipients. Thus, the record 650 includes a tertiary recipient multiplier field 674 that works in a similar manner to the primary recipient multiplier field 658 and the secondary recipient multiplier field 66, a tertiary recipient increase benefit field 676 that works in a similar manner to the primary recipient increase benefit field 660 and the secondary recipient increase benefit field 668, an average tertiary recipient variable benefit field 678 that works in a similar manner to the average primary recipient variable benefit field 662 and the average secondary recipient variable benefit field 670, and a tertiary recipient total benefit field 680 that works in a manner similar to the primary recipient total benefit field 664 and the secondary recipient total benefit field 672.

As illustrated in the fields 674, 676 and 678 of the record 650, the recipient “R-87654” has 174 tertiary recipients, each of which increases the initial benefit of twenty-five cents for the coupon “CO-123456” by one cent. The average tertiary recipient variable benefit of the three secondary recipients is 1.1, as provided in the field 678. Thus the tertiary recipient total benefit for the coupon “CO-123456” identified in the field 654 is one dollar and ninety-one cents ($0.01×174×1.1=$1.91), as provided in the field 680.

The record 650 may also include a coupon total benefit field 682 that is the sum of the benefits in the primary recipient total benefit field 664, the secondary recipient total benefit field 672, and the tertiary recipient total benefit field 680. Thus, the coupon “CO-123456” identified in the field 654 has a current total benefit of five dollars and twenty-one cents ($0.25+$0.45+$3.60+$1.91=$6.21), as provided in the field 682.

The record 650 may also include a maximum benefit field 684 for the coupon identified in the field 654 and the recipient identified in the field 652. The coupon “CO-123456” has a maximum coupon benefit of seven dollars, as provided in the field 684, the same maximum benefit reflected in the maximum benefit field 262 for the coupon “CO-123456” identified in the field 250 of the available coupons database 222 illustrated in FIG. 5.

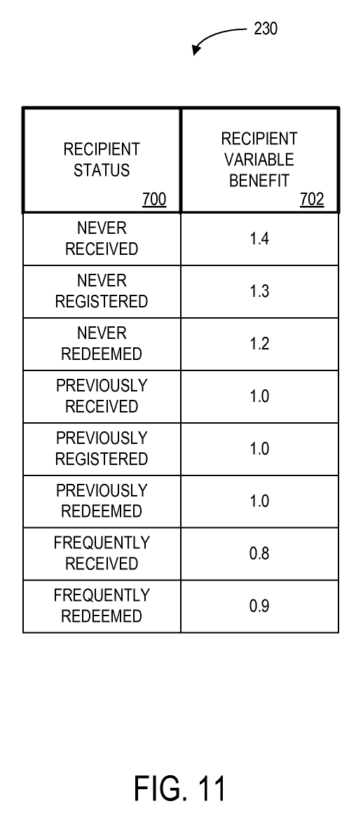

As previously discussed above, a recipient variable benefit database, such as the recipient variable benefit database 230, preferably stores information and data regarding the types of recipients of a coupon as well as any conditions that might create a variation in benefit. A tabular representation of a possible implementation of, or data structure for, a recipient variable benefit database 230 is illustrated in FIG. 11.

The recipient variable benefit database 230 illustrated in FIG. 11 includes a recipient status field 700 that includes information regarding designations of recipients or a descriptions of types of recipients. In addition, the recipient variable benefit database 230 includes a recipient variable benefit multiplier 702, such as the recipient variable benefit multipliers in the fields 364, 464 and 564 of the records 350, 450 and 550, respectively. For the recipient variable benefit database 230 illustrated in FIG. 11, a recipient who has never received a coupon has a higher variable benefit than a recipient who has never registered a coupon, a recipient who has never registered a coupon, a recipient who has never redeemed a coupon, etc. A recipient of a coupon who frequently redeems coupons has the lowest variable benefit.

Referring again to the recipient variable benefit field 364 of the record 350 illustrated in FIG. 7 for the coupon tracking database 226, it can be seen that “Dan Needham” has a recipient variable benefit of “1.0.” Using the recipient variable benefit database 230 illustrated in FIG. 11, it can be determined that since “Dan Needham” has a recipient variable benefit of “1.0,” “Dan Needham” has either previously received a coupon, previously registered with the coupon offer issuer server 152, or previously redeemed a coupon.

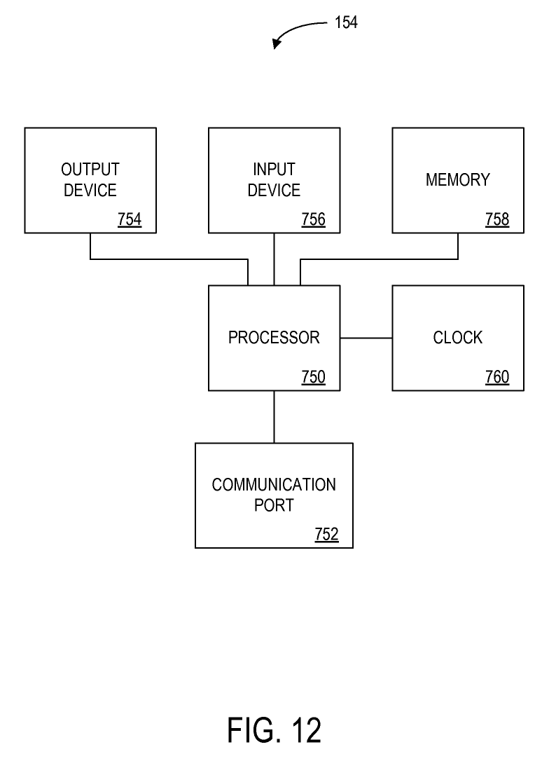

Now referring to FIG. 12, block diagram of a coupon receiving device, such as the device 154, is illustrated. The coupon receiving device 154 may include a processor, microchip, or computer 750 that is in communication with or otherwise uses or includes one or more communication ports 752 for communicating with the coupon offer issuer server 152 and/or other devices. The coupon receiving device 750 may also include one or more output devices 754 for conveying information, such as a printer, audio speaker, infrared or other transmitter, antenna, display screen or monitor, text to speech converter, etc. to provide information, responses, and instructions to a recipient, as well as one or more input devices 756 for receiving information, such as a bar code reader or other optical scanner, infrared or other receiver, antenna, magnetic stripe reader, image scanner, roller ball, touch pad, joystick, touch screen, fingerprint scanner, voice analyzer, retinal scanner, microphone, computer keyboard, computer mouse, etc. to enable a customer to enter information, request a coupon, authenticate himself or herself, etc.

In addition to the above, the coupon recipient device 154 may include a memory or data storage device 758 to store information, software, databases, device drivers, coupons, downstream or recipient related information, etc. The memory or data storage device 758 preferably comprises an appropriate combination of magnetic, optical and/or semiconductor memory, and may include, for example, Random Access Memory (RAM), Read-Only Memory (ROM), a tape drive, flash memory, a floppy disk drive, a ZIP™ disk drive, a compact disc and/or a hard disk.

The coupon recipient device 154 may also include an internal clock element 760 to maintain an accurate time and date for the coupon recipient device 154, create time stamps for coupons received at or registered or redeemed with the coupon recipient device 154, create time stamps for other communications received or generated via the coupon recipient device 154, etc.

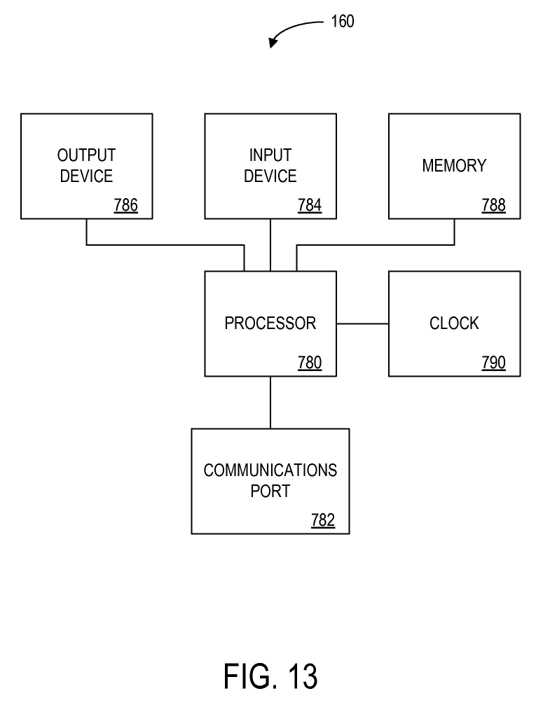

A block diagram of a basic point-of-sale terminal, such as the point-of-sale terminal 160, is illustrated in FIG. 13. The point-of-sale terminal 160 may include a processor or controller 780 that uses or includes one or more communications ports 782 for connecting to or communicating with coupon offer issuer store server 152 or to any other devices. The point-of-sale terminal 160 may also include one or more input devices 784, such as a bar code reader, image scanner, microphone, roller ball, touch pad, joy stick, computer keyboard, or computer mouse. In addition, the point-of-sale terminal 160 may include one or more output devices 786, such as a printer, a display screen or monitor, a text to speech converter, etc. Software may be resident and operating or operational on the point-of-sale terminal 160. The software may be stored or resident on a data or mass storage device or other memory 788 and may include a control program, information, software, databases, device drivers, coupons, downstream or recipient related information, etc. The memory or data storage device 758 preferably comprises an appropriate combination of magnetic, optical and/or semiconductor memory, and may include, for example, Random Access Memory (RAM), Read-Only Memory (ROM), a tape drive, flash memory, a floppy disk drive, a ZIP™ disk drive, a compact disc and/or a hard disk.

The point-of-sale terminal 160 may also include an internal clock element 790 to maintain an accurate time and date for the point-of-sale terminal 160, create time stamps for coupons registered or redeemed at the point-of-sale terminal 160, create time stamps for other communications received or generated via the point-of-sale terminal 160, etc.

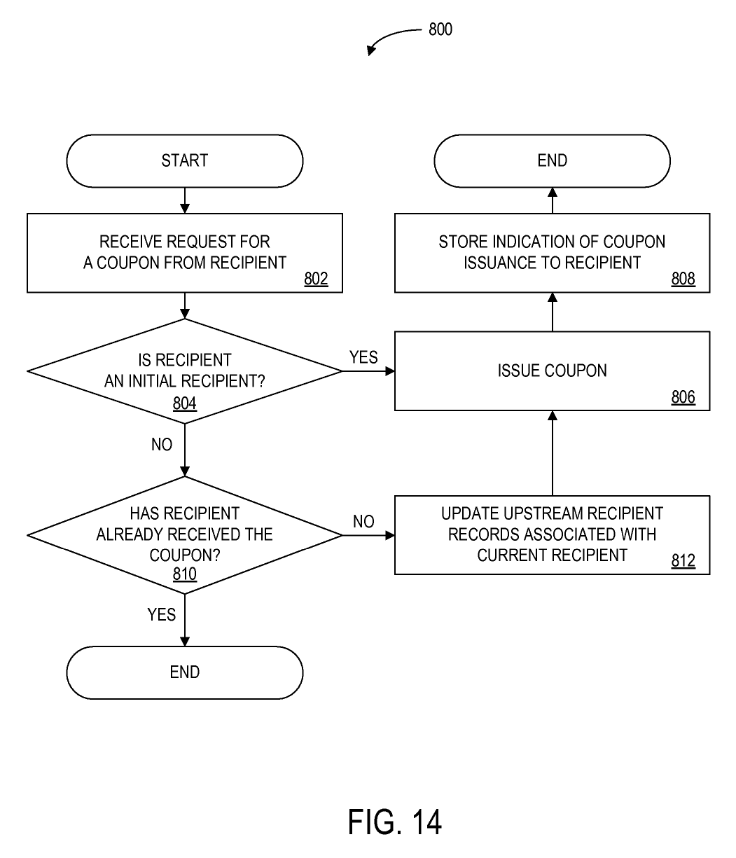

Now referring to FIG. 14, a method 800 is provided that illustrates an exemplary embodiment wherein the coupon offer issuer server 152 issues a coupon to a recipient. During a step 802, the coupon offer issuer server 152 receives a request for a coupon from a recipient. During a step 804 the coupon offer issuer server 152 determines whether the recipient is an initial recipient.

There are various ways that the coupon offer issuer server 152 can track coupons which can be used to determine whether a recipient of a coupon is an initial recipient of the coupon. For example, in one embodiment, a Uniform Resource Locator (URL) is issued to or associate with each recipient of a coupon. In this embodiment, a domain name of a web site associated with the coupon offer issuer server 152 of the URL has a unique code or recipient identifier attached to it. Thus, an essentially infinite number of unique URLs can be issued to a recipient for a coupon offer issuer's domain name. For example, the URL could be “www.funcompany.com/id?12345” where “id?12345” is the recipient identifier or session key provided to a recipient of a coupon and tracked by the company “FUNCOMANY” for the coupon and the recipient. U.S. Pat. No. 5,793,972 entitled “SYSTEM AND METHOD PROVIDING AN INTERACTIVE RESPONSE TO DIRECT MAIL BY CREATING PERSONALIZED WEB PAGE BASED IN URL PROVIDED ON MAIL PIECE,” the contents of which are herein incorporated by reference, describes a method and system for discloses a system using a personal identification code attached to mail.

Downstream recipients of a coupon initially access the coupon offer issuer's web site with a URL of the upstream recipient from whom the coupon was forwarded. The URL preferably has a session key or other recipient identifier of the upstream recipient embedded within it. This allows the coupon offer issuer to determine which upstream recipient forwarded the coupon to the new downstream recipient. When the downstream recipient accesses the coupon offer issuer's web site via the upstream recipient's URL, the coupon offer issuer issues or associates a new URL with a unique session key or other identifier to the downstream recipient. The unique session key or identifier allows downstream recipients to forward a duplicate of the coupon to further downstream recipients in such a way that identifies them to the coupon offer issuer server 152 as the forwarding recipient when the further downstream recipients use the URL to receive a duplicate of the coupon. The coupon offer issuer server can determine a hierarchy based on who forwarded the coupon to whom. Thus, the coupon offer issuer server 152 can track coupon recipients more efficiently.

In one embodiment, a unique URL or link is issued to each initial recipient of a coupon. In this embodiment, all downstream (direct and indirect) recipients of the initial recipient's coupon receive and share the same URL or link to the web site, although they each still receive their own unique session keys or identifiers once they access the web site. Upstream and downstream recipients of the coupon are determined by the chronological or temporal order in which they access the web site via the unique URL issued to the initial recipient of the coupon. In particular, the order in which a recipient of a coupon registers for, forwards, or redeems the coupon determines that recipient's place in the hierarchy. For example, when a primary recipient forwards a coupon to another individual, that individual may register with the coupon offer issuer server before the primary recipient registers with the coupon offer issuer server. In this situation, the coupon offer issuer server 152 may incorrectly determine that the individual receiving the coupon from the primary recipient is actually the primary recipient, and that the primary recipient is actually the secondary recipient. When one unique URL is shared by a number of recipients, the sequence in which the recipients register with the coupon offer issuer server 152 determines their level in the hierarchy. Thus, recipients of a coupon are encouraged to register for, forward, and/or redeem coupons quickly.

In another embodiment, the recipient of a coupon registers with the web site of or associated with the coupon offer issuer server 152 using an identifier and/or pass code. When the recipient forwards the coupon to any downstream recipients, the recipient includes the identifier and/or pass code to identify the recipient who forwarded the coupon to the coupon offer issuer server 154. In this embodiment, when the recipient accesses the web site of the coupon offer issuer server 152, the recipient either receives an identifier and/or pass code from the web site or creates an identifier and/or pass code to that web site.

A downstream recipient affects the benefit of the upstream recipient's coupon by registering with the coupon offer issuer web site and inputting the identifier of the upstream recipient, or in some other way indicating to the coupon offer issuer server 152 that the coupon was received from the upstream recipient. It will be appreciated that this identifier also allows the recipient to access the recipient's individual coupon record. This record would track the coupons a recipient received, the status of that particular coupon, its benefit, the date after which the coupon can no longer can accrue benefit and its expiration date. Even after a coupon is redeemed it may accrue benefit or receive retroactive changes in benefit, either in cash, store credits, credit card or other financial account credits, or in new or added coupons for the benefit amount of the increase. This allows a recipient to redeem a coupon without losing potential increased benefit for the coupon, rather than encouraging the recipient to wait for the coupon to reach a desired benefit before redeeming the coupon.

In yet another embodiment, each recipient of a coupon is issued a finite number of pre-issued unique URLs to forward to downstream recipients along with the coupon. The issued coupons database 228 tracks coupons by associating each URL with the upstream recipient from whom an identified downstream recipient received the coupon. This embodiment limits each upstream recipient of a coupon to a predetermined number of primary downstream recipients to whom the coupon can be forwarded. However, provisions may be made for issuing additional URLs for additional primary recipients.

The coupon offer issuer server 152 may use e-mail to track coupon recipients and a hierarchy of recipients for a coupon. In one such embodiment, the coupon offer issuer server 152 is carbon copied on e-mail messages that an upstream recipient sends to downstream recipients when forwarding a coupon. This way, the coupon offer issuer server 152 sees the name and address of each downstream recipient, and uses this information to verify from whom the coupon was sent and to track recipients of the coupon. The e-mail message sent to the coupon offer issuer server 152 may be a visible or a blind carbon copy. In addition, the e-mail message may be a specific format issued by the coupon offer issuer server 152 that allows a machine to automatically process e-mail registration.

In another embodiment, the e-mail message is used in a “send to a friend” application. In this application, the coupon offer issuer server 152 may host e-mail and an upstream recipient of a coupon uses the coupon offer issuer server 152's e-mail server to send a predetermined e-mail message that includes the coupon and space for the upstream recipient to include a note to downstream recipients of the coupon. In this way, the coupon offer issuer server 152 can determine who receives the duplicate coupon, regardless of whether the recipient registers the coupon with the coupon offer issuer server 152. As another variation, the coupon offer issuer 152 hosting the e-mail can track coupon forwarding paths. In this way, server 101 has a record of which recipients sent coupon e-mail messages, and who received the e-mail messages associated with the coupon.

Rather than using URLs or e-mail messages, the coupon offer issuer server 152 may use contact information to track recipients of a coupon. For example, a web site of or associated with the coupon offer issuer server 152 may have a form which coupon recipients complete when they access the web site to register or redeem the coupon. Using the form, the recipients may also provide the coupon offer issuer server 152 with an e-mail address or other contact information for potential downstream recipients of the coupon. Then the coupon offer issuer server 152 solicits the downstream recipients directly. Although this embodiment simplifies tracking of coupon recipients, it does not address unsolicited coupons sent directly from the coupon offer issuer server 152. To avoid this problem, the e-mail message may appear to the downstream recipient as if it was sent by the upstream recipient. Alternately, the e-mail message may contain text explaining that the coupon is from the upstream recipient. The coupon offer issuer server 152 may even include a personal greeting in the text of the coupon from the immediate upstream recipient for the downstream recipient. If such an embodiment is used, the downstream recipient may reply to the e-mail message sent from the coupon offer issuer server 152, or send an e-mail message to the coupon offer issuer server 152 in a machine readable format which includes the e-mail addresses of new potential downstream recipients of the coupon.

Referring again to FIG. 14, the coupon offer issuer server 152 may use one of the tracking and forwarding techniques or embodiments described above to determine during the step 804 whether or not the request for a coupon is from an initial recipient or a downstream recipient. When the recipient is an initial recipient, the coupon offer issuer server 152 issues the coupon to the recipient during a step 806 and, if desired, records an indication of the issue of the coupon to the recipient during a step 808.

Conversely, when it is determined during the step 804 the recipient of a coupon is not an initial recipient of the coupon, the coupon offer issuer server 152 determines during a step 810 whether the recipient has already received the coupon. This determination can be made by reviewing the appropriate fields in the coupon recipient database 224. The step 810 would prevent recipients from receiving more than one copy of the same coupon and from increasing the benefit of their coupon by sending the coupon to the same person multiple times. It would also prevent recipients from receiving multiple copies of the same coupon from one or more sources.

In another embodiment, the coupon offer issuer server 152 also determines during the step 810 whether the recipient is forwarding the coupon to himself at an alternate e-mail address. Various check processes, such as determining if an account identifier or name for the coupon recipient is the same as, or similar to, any of his downstream recipients, or if the recipient's contact information (e.g., e-mail address, account identifier, etc.) is suspiciously close to the contact information of the upstream recipient, may indicate that the recipient is attempting to mail the coupon to himself. A program written to identify such an activity is typically called an alias scoring system, and is known to those skilled in the art.

If the recipient has not already received the coupon and has not forwarded the coupon to himself, as determined during the step 810, then the recipient is a downstream recipient of the coupon and has an associated upstream recipient for the coupon then the process 800 proceeds a step 812 during which a record, such as a record in the coupon recipient database 224, for the upstream recipient is update to reflect the downstream recipient's reception of the coupon. The process 800 then proceeds to the steps 806 and 808 as previously described above. On the contrary, if the recipient has already received the coupon, or the recipient has forwarded the coupon to himself, as determined during the step 810, then the process 800 ends. The recipient cannot use the coupon and the upstream recipients' records are not updated.

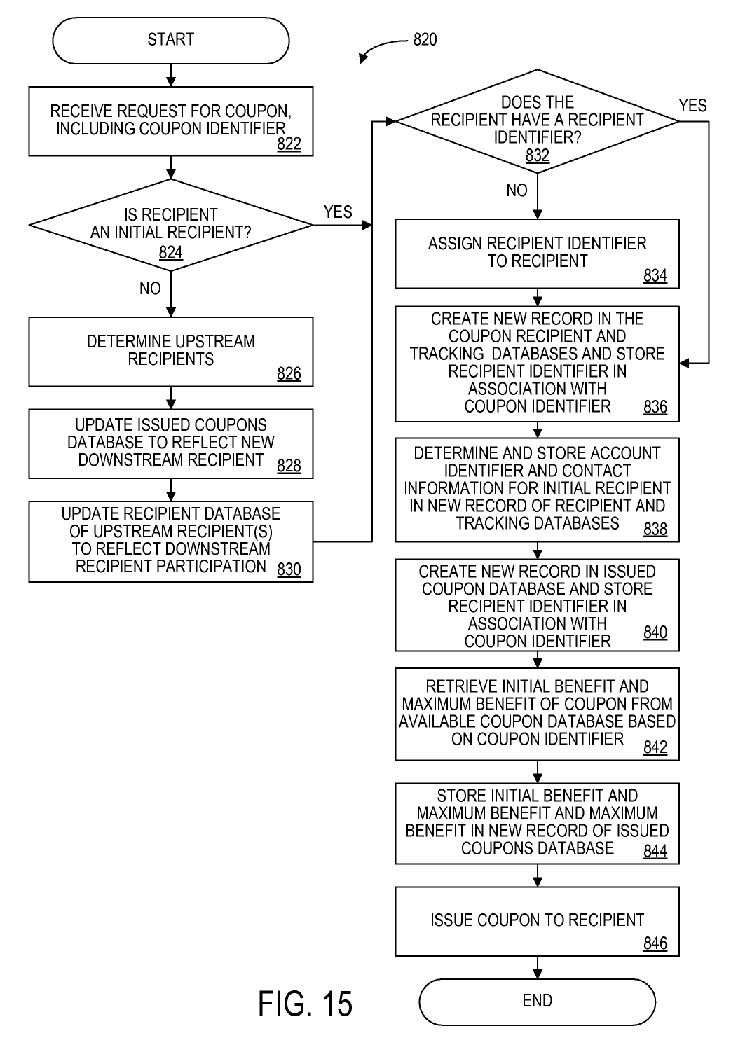

Now referring to FIG. 15, a method 820 is provided that illustrates an exemplary situation wherein a recipient of a coupon registers the coupon with the coupon offer issuer server 152. During a step 822, the coupon offer issuer server 152 receives a request for a coupon, the request preferably including a coupon identifier.

As discussed above with reference to the available coupons database 222, the coupon identifier for a coupon received during the step 822 preferably is the same as that stored in the coupon identifier field 250 for the coupon. The recipient may have browsed a web site on or associated with coupon offer issuer server 152 in order to learn about one or more coupons, or may have received the coupon from the coupon offer issuer server 152, or an upstream recipient of the coupon.

During a step 804, the coupon offer issuer server 152 determines whether the recipient sending the request received during the step 822 is an initial recipient of the coupon. When the recipient is not an initial recipient of the coupon, the coupon offer issuer server 152 proceeds to a step 826 and determines the recipient's associated upstream recipient for the coupon using the coupon recipient database 224 or the coupon tracking database 226. The issued coupons database 228 is then updated during a step 828 to reflect a new downstream recipient of the coupon. During a 830, the coupon recipient database 224 and/or the coupon tracking database 226 is updated to reflect the participation of the new downstream recipient of the coupon. The process then proceeds to a step 832. Conversely, when it is determined during the step 824 that the recipient is an initial recipient of the coupon, the process proceeds directly to the step 832.

During the step 832, it is determined whether a recipient identifier has been assigned to the initial recipient of the coupon. If a recipient has not been assigned a recipient identifier, then a recipient identifier is assigned to the recipient during a step 834 and the process 820 proceeds to a step 836. On the other hand, if a recipient identifier has been assigned to the recipient, then the process proceeds directly to the step 836.

During the step 836, new records in the coupon recipient database 224 and the coupon tracking database 226 are created which store the initial recipient's identifier and the coupon identifier of the coupon.

During a step 838, an account identifier is determined and stored in the account identifier field 308 of the initial recipient's new record of the coupon recipient database 224. In addition, contact information, such as the initial recipient's e-mail address, mailing address, telephone number, etc., is stored or updated in the contact information field 306 of the coupon recipient database 224.

During a step 840, a new record is created in the issued coupon database 228 which stores the recipient identifier of the initial recipient associated with the particular coupon. Using the available coupon database 222 illustrated in FIG. 5, the coupon identifier is located in the coupon identifier field 250.

An initial benefit and a maximum benefit corresponding to the coupon identifier can be retrieved from the initial benefit field 254 and maximum benefit field 262 during a step 842. These initial and maximum benefits are stored in the new record of the issued coupon database 228 during a step 844. Then, during a step 846, the coupon is issued to the initial recipient.

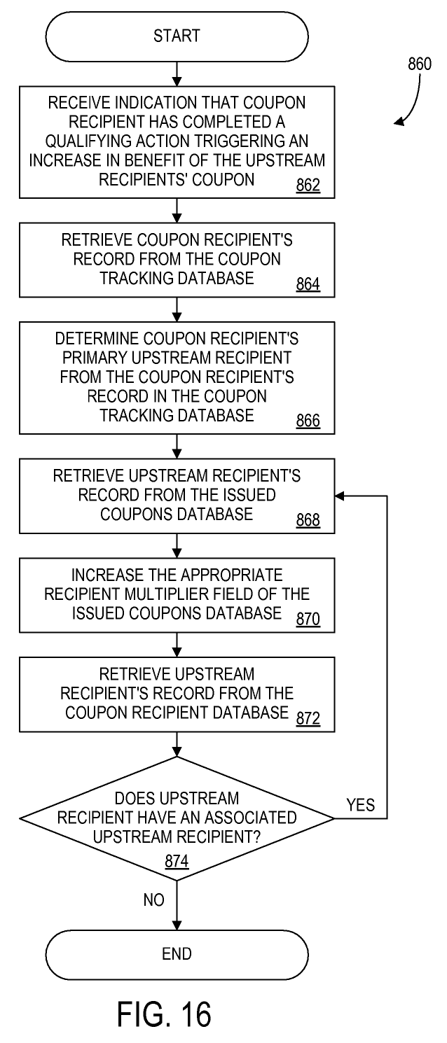

Now referring to FIG. 16, a method 860 is provided that illustrates an exemplary situation wherein a benefit of a recipient's coupon is increased in accordance with benefit variation conditions established during the step 104. During a step 862, an indication or message is received that a recipient of a coupon from an upstream recipient has completed an activity or qualifying action triggering an increase in the benefit of the upstream recipients' coupon. There are several ways this indication or message can be received and various activities or qualifying actions may trigger an increase in the benefit of the upstream recipient's coupon. For example, the benefit of an upstream recipient's coupon may increase when a downstream recipient registers with the coupon offer issuer server 152. In this embodiment, the downstream recipient may indicate his or her upstream recipient passively, such as by using a link to the web site of the coupon offer issuer server 152 that identifies the upstream recipient, or actively, such as by providing identifying information such as the recipient identifier, name or e-mail address of the recipient from whom the coupon was forwarded. Once the downstream recipient indicates from whom the coupon was forwarded, the coupon offer issuer server 152 preferably increases the benefit of the upstream recipients' coupon.

As another example, the benefit of an upstream recipient's coupon may increase when a downstream recipient receives the coupon. In this embodiment, the coupon offer issuer server 152 preferably tracks all recipients who have received the coupon. One way to accomplish this tracking of the coupons is for each upstream recipient to carbon copy the coupon offer issuer server 152 on coupons forwarded via e-mail to downstream recipients. Then, when the coupon offer issuer server 152 receives the carbon copy e-mail message indicating to which downstream recipient the coupon has been sent, the coupon offer issuer server 152 increases the benefit of the upstream recipient's coupon.

In a third example, the benefit of an upstream recipient's coupon may increase when a downstream recipient redeems the coupon. In this embodiment, when a downstream recipient redeems the coupon, the coupon offer issuer server 152 identifies all upstream recipients of the coupon and increases the benefit of the upstream recipients' respective coupons.

In a fourth example, the benefit of an upstream recipient's coupon may increase based on a combination of the above examples or embodiments. For example, the benefit of the upstream recipients' coupon may increase when a downstream recipient receives the coupon, when the downstream recipient registers with the coupon offer issuer server 152, and/or when the downstream recipient redeems the coupon, or some combination thereof. The coupon offer issuer server 152 may combine tracking methods and increase the benefit of the coupon based on a more complicated rate structure. For example, the benefit may increase a greater amount when the downstream recipient registers with the coupon offer issuer server 152 or redeems the coupon than when the downstream recipient receives the coupon. In addition, the benefit of the upstream recipient's coupon may increase a greater amount if the coupon is registered sooner rather than later by a downstream recipient of the coupon, if the coupon is redeemed sooner rather than later by a downstream recipient of the coupon, etc.

In another embodiment, the coupon offer issuer server 152 can identify new potential downstream recipients of a coupon to whom a recipient has not yet sent or forwarded a duplicate of a coupon, and provide a different increase for a coupon forwarded to such a recipient. A greater increase for such a new downstream recipient would encourage recipients to forward coupons more broadly. Also, recipients who traditionally forward coupons may be of a different benefit (i.e., they have a different variable benefit such as the benefits provided in FIG. 11) to the coupon offer issuer server 152 than recipients who do not. Thus, the coupon offer issuer server 152 may increase the benefit of the upstream recipient's coupon more for forwarding a duplicate of the coupon to such a person.

Referring again to FIG. 16, once an indication or message has been received during the step 862 that a coupon recipient or associated downstream recipient(s) have completed a prescribed activity that changes the benefit of the upstream recipient's coupon benefit, such as forwarding a duplicate of the coupon to a downstream recipient, registering a downstream recipient with the coupon offer issuer server, or redeeming a coupon, the record of the coupon recipient completing the activity is retrieved from the coupon tracking database 226 during a step 864. During a step 866, the primary upstream recipient is determined from the record in the coupon tracking database 226. In this example, the primary upstream recipient is the recipient from whom the coupon is directly received. The primary upstream recipient's record is retrieved from the issued coupon database 228 during a step 868.

During a step 870, the appropriate recipient field of the issued coupons database 228 is increased. Since the coupon recipient is a primary downstream recipient with respect to the initial recipient, the primary recipient multiplier field 658 of the issued coupons database 228 is increased to reflect the new primary recipient of the coupon.

During a step 872, the primary upstream recipient's record is retrieved from the coupon tracking database 226. It is then determined during a step 874 whether the primary upstream recipient has an associated upstream recipient. If there is no associated upstream recipient, the benefit of the upstream recipient's coupon can be determined and the process 860 ends. If there is an associated upstream recipient, then the process returns to step 868 and the record of the upstream recipient, who is upstream from the primary upstream recipient, is retrieved from the issued coupons database 228.

During the step 870, the appropriate recipient field of the issued coupons database 228 is increased. In this case, the recipient completing the activity is a secondary downstream recipient with respect to the initial recipient, so the secondary downstream recipient multiplier field 666 of the issued coupons database 228 is increased to reflect the new secondary recipient of the coupon. The process 860 repeats the steps 868, 870 and 872 until it is determined in the step 874 that the final upstream recipient does not have an associated upstream recipient, or until the predetermined number of levels in the hierarchy established by the benefit variation conditions have been compensated.

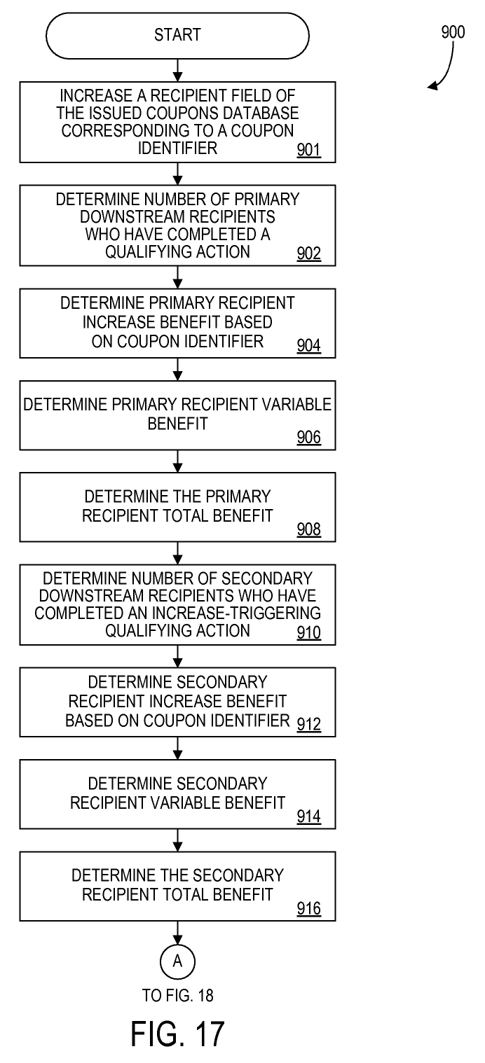

Now referring to FIG. 17, a representative flowchart is provided illustrating a process 900 of determining a benefit of a coupon for a particular recipient of the coupon. For example, the particular recipient might be the recipient “Dan Needham” having the recipient identifier “R-87654” as illustrated in the record 350 for the issued coupons database 228 in FIG. 7. During a step 900, a number in one of the recipient multiplier fields 658, 666 or 674 of the record 650 for the issued coupons database 228 corresponding to a particular coupon identifier is increased, thereby indicating a receipt of the coupon by a downstream recipient for “Dan Needham,” who is associated with the recipient identifier “R-87654” in the field 652 of the record 650. More specifically, the three recipient fields 658, 666, and 674 of the record 650 are associated with a primary recipient multiplier, a secondary recipient multiplier field, and a tertiary recipient multiplier field, respectively. Thus, during the step 901, one of these three fields 658, 666 or 674 in the record 650 is increased, indicating a new recipient has received the coupon corresponding to a coupon identifier stored in field 654 of the record 650.

During a step 902, a number of primary downstream recipients who have completed one or more predetermined activities or qualifying actions is determined. These may include the same activities or qualifying actions discussed in conjunction with step 862 of the process 860 shown in FIG. 16. For example, the activities or qualifying actions may include a recipient receiving the coupon, a recipient registering with the coupon offer issuer, or a recipient redeeming the coupon.

During a step 904, a primary recipient increase benefit corresponding to the coupon identifier is determined. Referring again to FIG. 10, a primary recipient increase benefit field 660 is illustrated in the exemplary record 650 of the issued coupons database 228. Thus, in this field 660, the increase benefit corresponding to the identified coupon can be determined.

The exemplary method 900 includes optional steps of determining recipient variable benefits. Thus, during a step 906, the primary recipient variable benefit is determined. As explained more fully in connection with record 350 of the coupon tracking database 226 illustrated in FIG. 7, and recipient variable benefit database 230 illustrated in FIG. 11, a recipient variable benefit is specific to each recipient and may be based on a variety of factors. The primary recipient variable benefit is an average of the total recipient variable benefits assigned to the corresponding primary recipients and is stored in primary recipient variable benefit field 660 in the record 650 for the issued coupons database 228.

During a step 908, the primary recipient total benefit is determined. This total benefit is determined by multiplying the primary recipient multiplier stored in primary recipient field 658 of the record 650 by the primary recipient increase stored in the primary recipient increase field 660 of the record 650. That result is then multiplied by the primary recipient variable benefit stored in the primary recipient variable benefit field 662. The primary recipient total benefit is stored in field 664 of the record 664 for the issued coupons database 228.

During a step 910, a number of secondary downstream recipients who have completed one or more predetermined activities or qualifying actions is determined. Generally, these are the same activities or qualifying actions discussed in conjunction with step 902. During a step 912, a secondary recipient increase benefit corresponding to the coupon identifier is determined. Referring again to FIG. 10, a secondary recipient increase benefit field 668 is shown in the exemplary record 650 of the issued coupons database 228. Thus, in this field 668, the increase benefit corresponding to the identified coupon can be determined. During a step 914, the secondary recipient variable benefit is determined. This is an average of the total recipient variable benefits assigned to the corresponding secondary recipients stored in the secondary recipient variable field 670 of the record 650 for the issued coupon database 228.

During a step 916, the secondary recipient total benefit is determined or identified. This total benefit is determined by multiplying the secondary recipient multiplier stored in secondary recipient field 666 of the record 650 by the secondary recipient increase benefit stored in the secondary recipient increase benefit field 668. This result is then multiplied by the secondary recipient variable benefit stored in the secondary recipient variable benefit field 670 The secondary recipient total benefit is stored in field 672 of the issued coupons database 228.

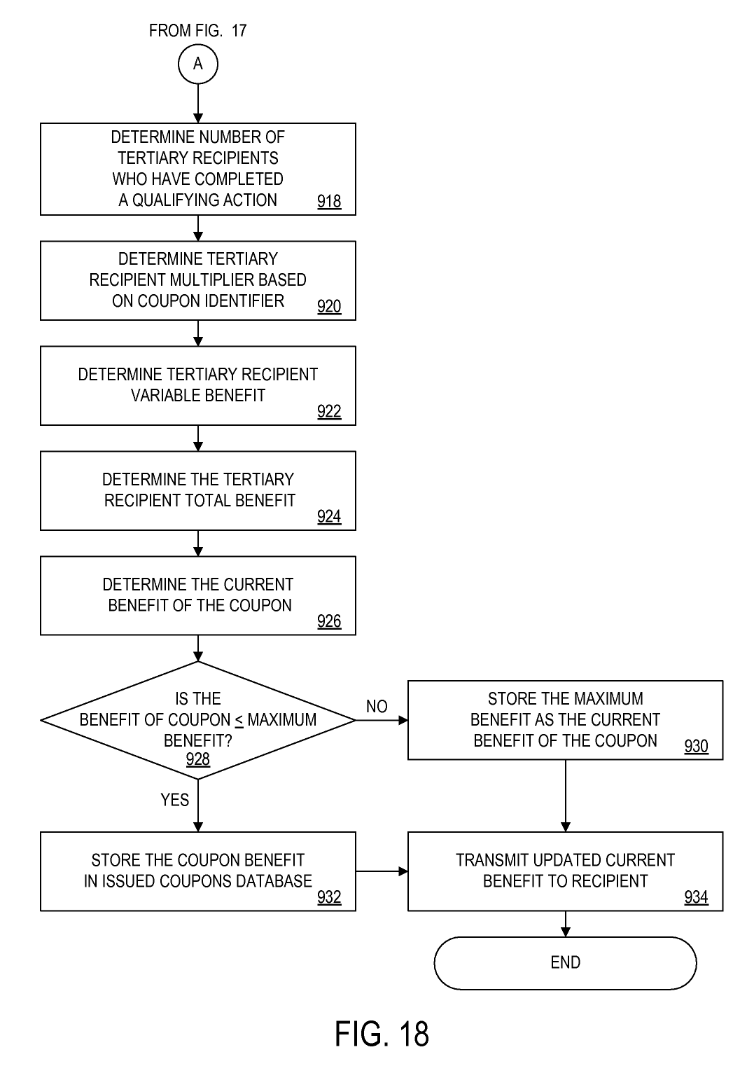

Referring now to FIG. 18, the process 900 of determining the benefit of a coupon is continued. During a step 918, the number of tertiary recipients who have completed one or more predetermined activities or qualifying actions is determined. These are the same activities or qualifying actions discussed in conjunction with the step 902. During a step 920, a tertiary recipient increase benefit corresponding to the coupon identifier is determined. Referring again to FIG. 10, a tertiary recipient increase benefit field 676 is shown in the exemplary record of the issued coupons database 228. For example, in this field 676 the increase benefit corresponding to the identified coupon can be determined. During a step 922, the tertiary recipient variable benefit is determined. This is an average of the total recipient variable benefits assigned to the corresponding tertiary recipients stored in the tertiary recipient variable field 678 of the record 650 for the issued coupon database 228.

During a step 924, the tertiary recipient total benefit is determined. This total benefit is determined by multiplying tertiary recipients multiplier, stored in tertiary recipient multiplier field 674 of the record 650 by the tertiary recipient increase benefit stored in the tertiary recipient multiplier field 676 of the record 650. The result is then multiplied by the tertiary recipient variable benefit stored in the tertiary recipient variable benefit field 678 of the record 650. The tertiary recipient total benefit is stored in field 680 of the record 650.

The value or benefit of the coupon is determined during a step 926. In an example where three levels of the coupon hierarchy affect the total benefit of a recipient's coupon benefit, the benefit is obtained by summing the initial benefit of the coupon and the primary, secondary and tertiary recipient total benefits. The benefit is stored in the benefit field 682 of the record 650 for the issued coupons database 228. It should be understood that any number of levels in the hierarchy may affect the total benefit of a recipient's coupon, and that three was chosen here for exemplary purposes only.

During a step 928, a determination is made as to whether the benefit of the coupon is less than or equal to a maximum allowed benefit for the coupon. The maximum benefit is stored in the maximum benefit field 684 of the record for the issued coupon database 228. If the benefit of the coupon is less than or equal to the maximum benefit, then the benefit of the coupon is stored in field 682 of the record 650 during a step 930. If the benefit of the coupon is not less than or equal to the maximum benefit, then the maximum benefit is stored as the current benefit in field 682 of the record 650 during a step 932. The updated benefit is then transmitted to the recipient or some other computer system or entity associated with the recipient during a step 934.

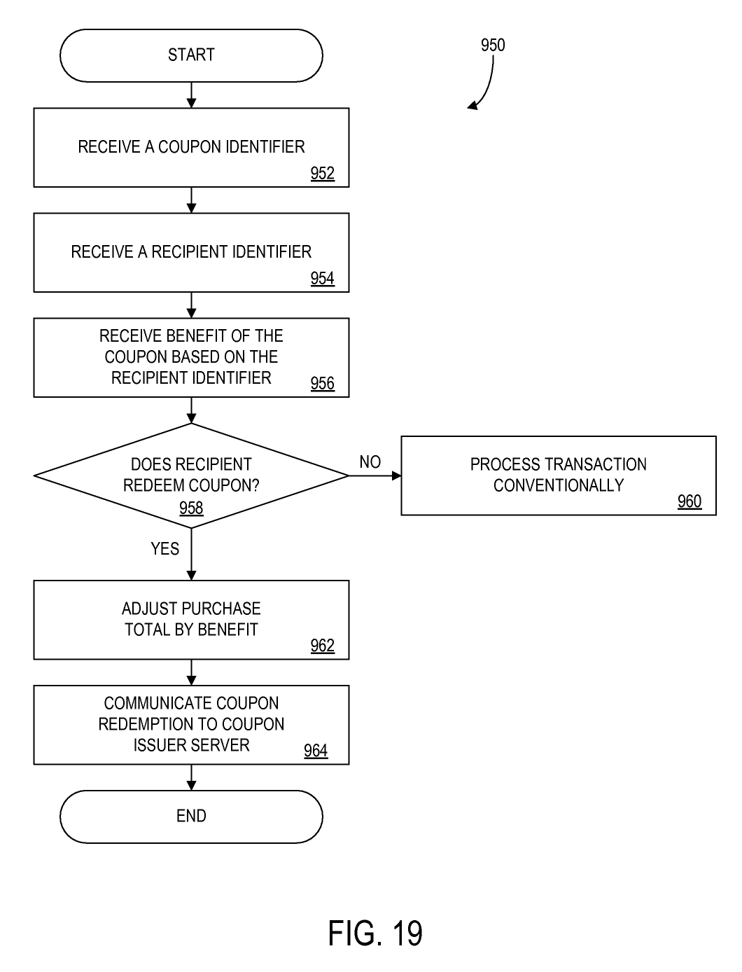

Now referring to FIG. 19, a process 950 is provided that may be performed by a point-of-sale device, such as the point-of-sale device 160 illustrated in FIG. 2, to determine and redeem the benefit of a coupon provided by a recipient. During a step 952 the point-of-sale device 160 receives the coupon identifier. During a step 954, the point-of-sale device 160 receives the recipient identifier. The benefit of the coupon is received in step 956 based on the recipient identifier.

In one embodiment, the point-of-sale device 160 is, or is associated with, an on-line retailer and can look up the coupon identifier of the coupon from a database. The recipient of the coupon provides the point-of-sale device 160 with a unique identifier, such as a session key, log-on name and/or password, or recipient identifier. In such an embodiment, the database may be periodically updated, or non-periodically updated in essentially real time by the coupon offer issuer server 152 to allow the point-of-sale device 160 to determine the benefit of the coupon when the recipient desires to redeem it. Typically, the recipient provides the coupon identifier or some other representation of the coupon, such as a printed page from the coupon offer issuer server 152. This enables the online retailer to perform the database lookup to determine the specific coupon being redeemed. Alternately, the coupon offer issuer and the retailer redeeming the coupon may associate coupon benefits to the recipient's frequent shopper card, credit card number, or a printed code that could act as the coupon identifier. A retailer server houses the database, or in some other way remains in communication with the coupon offer issuer server 152 and/or its database in order to perform a look-up of the benefit of the coupon when the coupon is presented for redemption by the recipient. The retailer then alters the price of the product for which the recipient has a coupon to reflect the benefit of the coupon at the time of purchase.

In another embodiment, when a recipient presents an online retailer with a coupon the online retailer may solicit the coupon offer issuer server 152 for the benefit of the coupon. Again, the recipient would provide a coupon identifier or some other identification for representing the coupon to the online retailer to enable the online retailer to solicit the coupon offer issuer server 152.

Coupon recipient devices 154, 156 and 158 may be palm top computers, also known to those skilled in the art as personal digital assistants (PDAs). An initial coupon recipient may download a coupon from a web site of, or associated with, the coupon offer issuer server 152 either directly via a modem in communication with her palm top computer, or from the recipient's desk top personal computer to the palm top computer via a palm top computer docking station in communication with a desk top computer. The recipient may forward duplicates of the coupon either to downstream recipient's palm top computers or to their desk top personal computers. Palm top computers that are web-enabled (i.e., that have a modem connection to the Internet or World Wide Web) would act in much the same way as a desk top computer. Palm top computers may communicate with retailer point-of-sale devices in order to identify the recipient, recipient information, recipient coupons, the benefit of coupons, or other information relevant to redeeming coupons.

In yet another embodiment, the point-of-sale device 160 is or is at a brick and mortar store. In such an embodiment, a coupon can be printed. When a recipient desires to redeem the coupon, he or she can access the web site of the coupon offer issuer server 152 and print out a copy of the coupon. Alternately, the coupon may be printed from kiosks in the store. If the coupon is printed in the store, a store server may only allow one printing of the coupon. The benefit of the coupon is then printed on the coupon and the coupon can be redeemed just like a traditional coupon. To minimize potential fraud through printing multiple copies of a coupon, or altering the benefit on the coupon before printing, the information on the coupon indicating its benefit can be encrypted or encoded in bar code format. Then, the information can be decrypted or decoded when the coupon is redeemed at the point-of-sale device 160. Even if the recipient tampered with the text of the coupon, the encrypted information would reveal the coupon's true benefit to the point-of-sale device 160. Alternately, the coupon may be printed on special paper that indicates its authenticity to the point-of-sale device 160 or to a cashier managing or using the point-of-sale device 160.

Rather than printing the benefit of a coupon on the coupon, a coupon identifier can be printed on the coupon. The point-of-sale device 160 may use this identifier to access a database of coupons and their benefits, which is either updated periodically or non-periodically in essentially real-time by the coupon offer issuer server 152. Alternately, the point-of-sale device 160 may solicit the coupon offer issuer server 160 for the current benefit of the recipient's coupon.

The coupon identifier may be associated with an identifier on a frequent shopper card, credit card, bar code printed on a page from a web page from the coupon offer issuer server 152, or other such identifier that a customer would present at the retail point-of-sale device 160. The point-of-sale device 160 would receive the coupon identifier, and if a product being purchased matches a coupon stored in the record of the recipient in the available coupons database 222 or some other database, the point-of-sale device 160 would subtract the benefit of the coupon from the transaction total or price for the associated product. Thus, the customer may present his identifier, and the associated item, and the point-of-sale device 160 would record the coupon benefit in the transaction. If the recipient presents the identifier, but not one or more of the associated products, the point-of-sale device 160 would not record the coupon benefit in the transaction.

During a step 958, it is determined whether the recipient redeems the coupon. If the recipient does not redeem the coupon, then the transaction is processed conventionally during a step 960. In this case, the recipient receives no deduction off the purchase price of the item. If the recipient does redeem the coupon, then the purchase total is adjusted by the benefit of the coupon during a step 962 and communicated to the coupon offer issuer server 152 during a step 964.

In one embodiment of the present invention, once the coupon is redeemed, the redeeming recipient no longer accrues credit or increases in benefit for the coupon. In this embodiment, the upstream recipient does not receive any benefits if downstream recipients forward or redeem the coupon after the upstream recipient has redeemed the coupon.

In an alternate embodiment, if an indication or message is received that a downstream recipient has completed a qualifying action, such as receiving, registering, or redeeming a coupon, after an upstream recipient has already redeemed the coupon, but prior to the expiration date of the coupon, then the coupon offer issuer server 152 may issue a new coupon to the upstream recipient or credit a financial or store account associated with the upstream recipient. The new coupon may have a benefit corresponding to an amount the redeemed coupon would have increased as established during the step 102 for the new coupon.

For example, consider the example when the benefit of “Dan Needham's” coupon is six dollars and twenty-one cents as indicated in the current coupon benefit field 682 of the record 650 for the issued coupons database 260 illustrated in FIG. 10. Then, after “Dan Needham” redeems the coupon at this benefit, two new tertiary recipients receive the coupon. Referring now to tertiary recipient multiplier field 674 in the record 650, the number of tertiary recipient is “2” and referring to the tertiary recipient increase benefit field 676, the tertiary recipient multiplier is one cent. Assume the tertiary recipient variable benefit as stored in the tertiary recipient variable benefit field 678 is “1.0.” Thus, the tertiary recipient total benefit is two cents, which is also the benefit of the new coupon issued to “Dan Needham.” In this example, a new coupon would be issued to “Dan Needham” having a benefit of two cents. The benefit of the new coupon could continue to increase until the predetermined time when a coupon may no longer increase in benefit, which may be the expiration date of the coupon.

Additionally, the coupon offer issuer may have a maximum number of times that a coupon can be redeemed. For example, the coupon may only be able to be redeemed two times. After that, the redeeming recipient no longer accrues credit for the coupon.

In yet another embodiment of the present invention, if an indication is received that a downstream recipient has received or redeemed a coupon after the upstream recipient has redeemed the coupon, but prior to the expiration date of the coupon, the redeeming recipient's financial or store account is credited for the additional benefit amount the upstream recipient would have received had he or she not already redeemed the coupon. Thus, in such an embodiment, the amount credited corresponds to an amount the redeemed coupon would have increased. For example, using the prior example, rather than issuing “Dan Needham” a new coupon having a benefit of two cents, the coupon offer issuer server 152 would credit a financial or store account provided by “Dan Needham” the two cents.

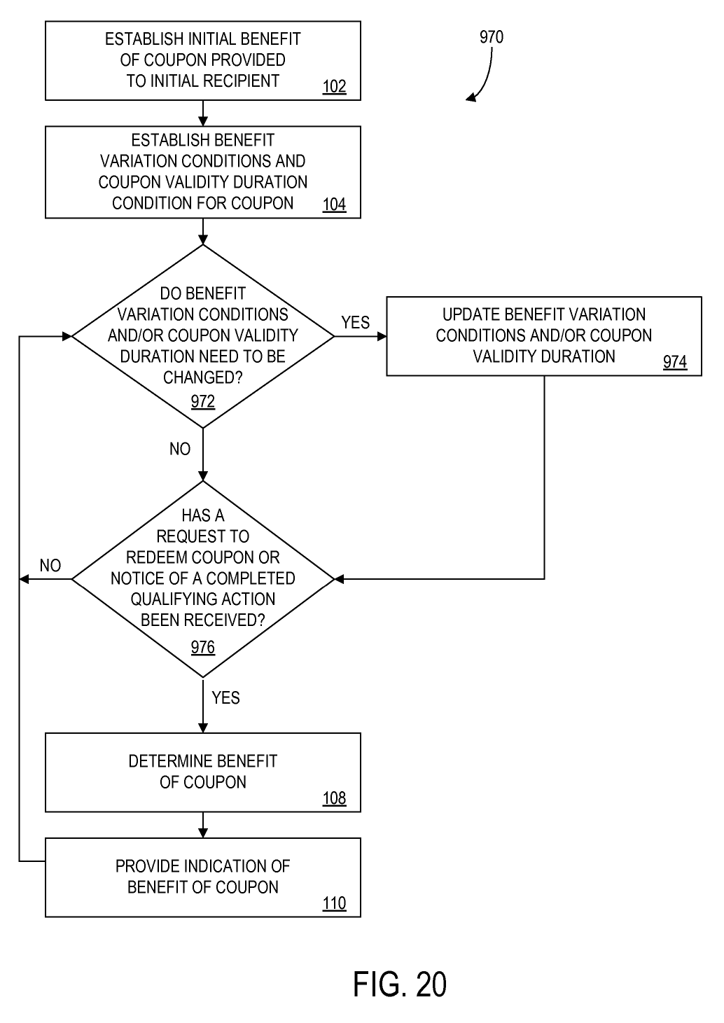

Now referring to FIG. 20, a another embodiment 970 of a method in accordance with the present invention is illustrated. The method 970 includes the steps 102, 104, 108 and 100 previously described above in relation to the method 100. In addition, after benefit variation conditions and validity duration conditions for the coupon are established during the step 104, a determination is made during the step 972 as to whether either or both of the benefit variation conditions or the validity benefit during conditions need to be altered or updated for any reason. For example, if too many or too few coupons are being forwarded, received, registered, redeemed, etc., benefit variation conditions for the coupon might be altered to encourage or discourage further activity with the coupons by recipients, to increase the number of recipients, etc. Furthermore, qualifying actions associated with a coupon as part of the coupon's benefit variation conditions might be altered, added, removed to obtain a desired outcome.

If a determination is made during the step 972 that either or both of the benefit variation conditions or the validity duration conditions for a coupon need to be changed, the method 970 proceeds to a step 974 wherein such change is made to either or both of the benefit variation conditions or the validity duration conditions for the coupon.

If a determination is made during the step 972 that no changes are needed to either of the benefit variation conditions or the validity duration conditions for a coupon, or upon completion of the step 974, the process 970 proceeds to a step 976 wherein a determination is made as to whether a request to redeem a coupon has been received or a notice of a completion of a qualifying action has been received. If the determination made during the step 976 is negative, the method 970 proceeds or loops back to the step 972.

If the determination made during the step 976 is affirmative, the method 970 proceeds to the steps 108 and 110 as previously described above before also proceeding or looping back to the step 972.

While the method and apparatus of the present invention has been described in terms of its presently preferred and alternate embodiments, those skilled in the art will recognize that the present invention may be practiced with modification and alteration within the spirit and scope of the appended claims. The specifications and drawings are, accordingly, to be regarded in an illustrative rather than a restrictive sense.

The present invention may be embodied as a computer program developed using an object oriented language that allows the modeling of complex systems with modular objects to create abstractions that are representative of real world, physical objects and their interrelationships. However, it would be understood by one of ordinary skill in the art that the invention as described herein can be implemented in many different ways using a wide range of programming techniques as well as general purpose hardware systems or dedicated controllers. In addition, many, if not all, of the steps for the methods described above are optional or can be combined or performed in one or more alternative orders or sequences without departing from the scope of the present invention and the claims should not be construed as being limited to any particular order or sequence, unless specifically indicated.

While specific implementations and hardware configurations for the coupon offer issuer server, coupon offer provider server, coupon recipient devices and point-of-sale devices have been illustrated, it should be noted that other implementations and hardware configurations are possible and that no specific implementation or hardware configuration is needed. Therefore, many different types of implementations or hardware configurations can be used in the system 150, 172 and with the methods 100, 970 and the methods disclosed herein are not limited to any specific hardware configuration.

Further, even though only certain embodiments have been described in detail, those having ordinary skill in the art will certainly understand that many modifications are possible without departing from the teachings thereof. All such modifications are intended to be encompassed within the following claims.

Each of the methods described above can be performed on a single computer, computer system, microprocessor, etc. In addition, two or more of the steps in each of the methods described above could be performed on two or more different computers, computer systems, microprocessors, etc., some or all of which may be locally or remotely configured. The methods can be implemented in any sort or implementation of computer software, program, sets of instructions, code, ASIC, or specially designed chips, logic gates, or other hardware structured to directly effect or implement such software, programs, sets of instructions or code. The computer software, program, sets of instructions or code can be storable, writeable, or savable on any computer usable or readable media or other program storage device or media such as a floppy or other magnetic or optical disk, magnetic or optical tape, CD-ROM, DVD, punch cards, paper tape, hard disk drive, ZIP™ disk, flash or optical memory card, microprocessor, solid state memory device, RAM, EPROM, or ROM.

The term “computer-readable medium” as used herein refers to any medium that directly or indirectly participates in providing instructions to a processor for execution. Such a medium may take many forms, including but not limited to, non-volatile media, volatile media, and transmission media. Non-volatile media include, for example, optical or magnetic disks. Volatile media include dynamic random access memory (DRAM), which typically constitutes the main memory. Transmission media include coaxial cables, copper wire and fiber optics, including the wires that comprise a system bus coupled to a processor. Transmission media can also take the form of acoustic, electrical or electromagnetic waves, such as those generated during radio frequency (RF) and infrared (IR) data communications.

The connections or communications between coupon recipient devices, point-of-sale devices, coupon offer issuer server, and coupon offer provider server discussed herein is only meant to be generally representative of cable, computer, telephone, or other communication or data networks and methods for purposes of elaboration and explanation of the present. The connections are also intended to be representative of, and include all or a part of, the Internet, the World Wide Web, and other privately or publicly operated networks, including wide area networks, local area networks, data communication networks or connections, intranets, routers, satellite links or networks, microwave links or networks, cellular telephone or radio links, fiber optic transmission lines, ISDN lines, Ti lines, etc. In addition, as used herein, the terms “computer,” “user device,” “coupon recipient device,” “terminal,” “client,” “device” and “client device” are generally interchangeable and are meant to be construed broadly and to include, but not be limited to, all clients, client devices or machines, personal digital assistants and palm top computers, cash registers, terminals, computers, point-of-sale devices, processors, servers, etc. connected or connectable to a computer or data communications network and all devices on which Internet-enabled software, such as the NETSCAPE COMMUNICATOR™ or NAVIGATOR™ browsers, MOSIAC™ browser, or MICROSOFT INTERNET EXPLORER™ browsers, can operate or be run. The term “browser” should also be interpreted as including Internet-enabled software and computer or client software that enables or allows communication over a computer network and Internet-enabled, monitored, or controlled devices such as WebTV™ devices, household appliances, phones, etc.

The words “comprise,” “comprises,” “comprising,” “include,” “including,” and “includes” when used in this specification and in the following claims are intended to specify the presence of stated features, elements, integers, components, or steps, but they do not preclude the presence or addition of one or more other features, elements, integers, components, steps, or groups thereof.

What is claimed is:

1. A method for providing a coupon having a variable benefit, comprising:
generating a coupon having a variable benefit;
receiving an indication that a first recipient has received a duplicate of said coupon from a second recipient after the second recipient has redeemed said coupon; and
issuing a new coupon to the second recipient, the new coupon having a benefit corresponding to an incremental benefit the second recipient would have received had said coupon not been redeemed by the second recipient.

2. A method for providing a coupon having a variable benefit, comprising:
generating a coupon having a variable benefit;
receiving an indication that a first recipient has received a duplicate of said coupon from a second recipient after the second recipient has redeemed said coupon; and
crediting a financial account associated with the second recipient an incremental benefit the second recipient would have received had said coupon not been redeemed by the second recipient.

3. A method for providing a coupon having a variable benefit, comprising:
issuing a coupon having a variable benefit to a first recipient;
receiving an indication after a second recipient registers a duplicate of said coupon; and
increasing a benefit of said coupon retained by the first recipient after the indication is received.

4. A method for providing a coupon having a variable benefit, comprising:
issuing a coupon having a variable benefit to a first recipient;
receiving an indication after a second recipient redeems a duplicate of said coupon; and
increasing a benefit of said coupon retained by the first recipient after the indication is received.

5. A method for providing a coupon having a variable benefit, comprising:
issuing a coupon having a variable benefit to a first recipient;
receiving an indication after a second recipient completes a qualifying action; and
increasing a benefit of said coupon retained by the first recipient after the indication is received.

6. The method of claim 5, wherein the qualifying action includes at least one of the following:
the second recipient receiving said coupon;
the second recipient registering said coupon;
the second recipient redeeming said coupon; or
the second recipient forwarding said coupon.

7. A coupon issuing system, comprising:
a controller;
a storage device coupled to the controller; and
software operative to run on the controller to increase a benefit of a coupon in accordance with at least one benefit variation condition.

8. A coupon issuing system, comprising:
a controller;
a storage device coupled to the controller; and
software operative to run on the controller to increase a benefit of a coupon retained by a first recipient when an indication is received that a second recipient has registered a duplicate of said coupon received from the first recipient.

9. A coupon issuing system, comprising:
a controller;
a storage device coupled to the controller; and
software operative to run on the controller to increase a benefit of a coupon retained by a first recipient when an indication is received that a second recipient has redeemed a duplicate of said coupon received from the first recipient.

10. A coupon issuing system, comprising:
a controller;
a storage device coupled to the controller; and
software operative to run on the controller to increase a benefit of a coupon in accordance with benefit variation conditions.

11. A coupon issuing system, comprising:
a controller;
a storage device coupled to the controller; and
software operative to run on the controller to increase a benefit of a coupon upon completion of a qualifying action by a recipient of said coupon.

12. A method for changing a benefit for a coupon, comprising:
establishing benefit variation conditions for a coupon;
receiving a request to redeem said coupon; and
updating said coupon's benefit in accordance with the benefit variation conditions.

13. A coupon, comprising:
a portion of material having indicia representative of at least one qualifying action; and
a benefit associated with a coupon.

14. The coupon of claim 13, further comprising indicia representative of a coupon identifier for said coupon.

15. A coupon, comprising:
a portion of material having indicia representative of a benefit associated with a coupon; and
a benefit variation condition associated with said coupon.

16. A coupon, comprising:
a portion of material having indicia representative of a benefit associated with a coupon; and
at least one qualifying action associated with said coupon.

17. An electronic coupon, comprising:
an electronic signal representative of an benefit associated with a coupon; and
a benefit variation condition associated with said coupon.

18. An electronic coupon, comprising:
an electronic signal representative of a benefit associated a coupon; and
at least one qualifying action associated with said coupon.

19. A method for changing a benefit for a coupon, comprising:
establishing an initial benefit for a coupon;
establishing a benefit variation condition for said coupon; and
updating said coupon's benefit in accordance with the benefit variation condition.

20. The method of claim 19, wherein the benefit variation condition includes at least one qualifying action.

21. The method of claim 20, further comprising receiving an indication of a completion of the qualifying action.

22. The method of claim 20, wherein the qualifying action includes at least one of the following:
a first recipient of said coupon forwarding said coupon to a second recipient;
an initial recipient receiving said coupon;
a primary recipient receiving said coupon;
a secondary recipient receiving said coupon;
a tertiary recipient receiving said coupon;
a recipient of said coupon registering said coupon; or
a recipient of said coupon redeeming said coupon.

23. The method of claim 19, wherein the benefit variation condition includes at least one validity duration condition for said coupon.

24. The method of claim 19, further comprising receiving a request to update said coupon's benefit.

25. The method of claim 19, further comprising providing an indication of said coupon's updated benefit.

26. The method of claim 19, wherein the establishing a benefit variation condition associated with said coupon includes establishing a maximum benefit for said coupon.

27. The method of claim 19, further comprising issuing said coupon to at least one recipient.

28. The method of claim 19, further comprising tracking recipients of said coupon.

29. The method of claim 19, further comprising tracking at least one hierarchy of recipients of said coupon.

30. A method for changing a coupon benefit, comprising:
receiving a coupon having an associated benefit and at least one associated qualifying action;
performing the qualifying action; and
receiving an indication of a change in the benefit associated with said coupon.

31. A method for changing a coupon benefit, comprising:
receiving a coupon having an associated initial benefit and at least one associated qualifying action;
causing a completion of the qualifying action; and
receiving an indication of a change in the benefit associated with said coupon.

32. A method for redeeming a coupon, comprising:
receiving a variable benefit coupon for redemption;
requesting a determination of a benefit associated with the variable benefit coupon;
receiving an indication of the benefit associated with the variable benefit coupon; and
allowing the variable benefit coupon to be redeemed for the indicated benefit.

33. A method for redeeming a coupon, comprising:
receiving a request to redeem a variable benefit coupon;
requesting a determination of a benefit associated with the variable benefit coupon;
receiving an indication of the benefit associated with the variable benefit coupon; and
allowing the variable benefit coupon to be redeemed for the indicated benefit.

34. A method for redeeming a coupon, comprising:
receiving a request to redeem a variable benefit coupon;
providing a notice of a receipt of the request;
receiving an indication of the benefit associated with the variable benefit coupon; and
allowing the variable benefit coupon to be redeemed for the indicated benefit.

35. A method of using a computer system for providing a coupon having a variable benefit, comprising:
generating a coupon having a variable benefit, wherein a duplicate of said coupon is transmitted to a first recipient from a second recipient;
receiving an indication that at least one of the second recipient or the first recipient has completed a qualifying action; and
changing a benefit of said coupon retained by the second recipient after the indication is received.

36. The method of claim 35, further comprising:
determining whether the second recipient received a duplicate of the coupon from a third recipient, the third recipient retaining a respective benefit of said coupon; and
changing the benefit of the third recipient's coupon after the second recipient has received the duplicate of said coupon from the third recipient.

37. The method of claim 35, further comprising:
determining at least one prior recipient that has indirectly forwarded a duplicate of said coupon to the first recipient, the at least one recipient has a respective benefit of the coupon; and
changing the benefit of the coupon of each prior recipient that has indirectly forwarded the duplicate of the coupon to the first recipient.

38. The method of claim 37, wherein changing the benefit of each prior recipient comprises changing, for each prior recipient, the benefit of said coupon by an amount that is based on a number of intervening recipients between the at least one prior recipient and the first recipient.

39. The method of claim 37, further comprising adjusting, for each at least one prior recipient, said coupon's benefit to equal a predetermined maximum benefit if the coupon's benefit exceeds the predetermined maximum benefit.

40. The method of claim 35, further comprising assigning an initial benefit to the duplicate of the coupon received by the first recipient.

41. The method of claim 40, further comprising:
receiving a forward indication when the first recipient has forwarded a duplicate of said coupon to a new recipient;
changing the benefit of said coupon retained by the second recipient when the forward indication is received; and
changing the initial benefit of said coupon retained by the first recipient to obtain a first recipient benefit when the forward indication is received.

42. The method of claim 35, further comprising:
arranging the first recipient and the second recipient in a hierarchy, the hierarchy having the first recipient at an immediate lower level than the second recipient;
determining a number of levels lower than the immediate lower level of the second recipient in the hierarchy, wherein each of the number of levels has at least one downstream recipient with a benefit of said coupon, and wherein the duplicate of said coupon is forwarded from the first recipient via each downstream recipient; and
changing the respective benefit of said coupon retained by each downstream recipient as the duplicate of said coupon is forwarded to descending levels in the hierarchy.

43. The method of claim 42, wherein the changing the respective benefit of said coupon of each downstream recipient comprises changing the respective benefit of the coupon retained by each downstream recipient by an amount based on a position of each respective downstream recipient in the hierarchy relative to at least one upstream recipient in the hierarchy.

44. The method of claim 42, further comprising arranging an initial recipient to whom said coupon is initially received at a topmost level of the hierarchy, the hierarchy having no more than a predetermined number of levels below the topmost level.

45. The method of claim 42, further comprising:
determining a primary number of primary downstream recipients having completed a primary required activity, each of the primary downstream recipients receiving said coupon from the first recipient;
multiplying the primary number by a primary recipient increase benefit to obtain a primary recipient total benefit;
determining a secondary number of secondary downstream recipients having completed a secondary required activity, each of the secondary downstream recipients receiving the duplicate of said coupon from at least one of the primary downstream recipients;
multiplying the secondary number by a secondary recipient increase benefit to obtain a secondary recipient total benefit;
determining a tertiary number of tertiary downstream recipients having completed a tertiary required activity, each of the tertiary downstream recipients receiving the duplicate of said coupon from at least one of the secondary downstream recipients;
multiplying the tertiary number by a tertiary recipient increase benefit to obtain a tertiary recipient total benefit; and
updating a first benefit of said coupon of the first recipient, wherein the updated first benefit is proportional to a sum of the primary, secondary and tertiary recipient total benefits.

46. The method of claim 45, wherein the primary required activity, the secondary required activity and the tertiary required activity include at least one of forwarding the coupon to a downstream recipient, registering said coupon, and redeeming the coupon.

47. The method of claim 35, further comprising:
arranging the first recipient and the second recipient in a hierarchy, the hierarchy having a plurality of levels wherein the second recipient is at a level in the hierarchy that is immediately higher than a level of the first recipient;
determining a number of levels in the hierarchy that are higher than the level of the second recipient, wherein when the number of levels exceeds one, each of the number of levels in the hierarchy has a prior recipient having a respective benefit of said coupon; and
changing the respective benefit of said coupon retained by each prior recipient.

48. A method of using a computer system for providing a coupon having a variable benefit, comprising:
issuing a coupon having a variable benefit to an initial recipient;
receiving an indication after a new recipient receives a duplicate of said coupon issued to the initial recipient of the coupon; and
changing a benefit of said coupon retained by said initial recipient each time the indication is received.

49. The method of claim 48, wherein the changing a benefit of said coupon retained by the initial recipient each time the indication is received comprises:
determining after the indication is received whether the new recipient has previously received said coupon; and
changing the benefit of said coupon retained by the initial recipient if the new recipient has not previously received said coupon.

50. The method of claim 48, wherein the changing comprises:
changing the benefit of said coupon retained by the initial recipient by an amount based on a number of intervening recipients between the new recipient and the initial recipient.

51. The method of claim 48, further comprising
assigning an initial benefit to said coupon received by a first new recipient;
receiving a forward indication when the first new recipient has forwarded a duplicate of said coupon to a second new recipient;
changing, after the forward indication is received, the initial benefit of said coupon retained by the first new recipient to obtain a first new recipient benefit; and
changing the benefit of said coupon retained by the initial recipient after the forward indication is received.

52. A method of using a computer system for providing a coupon having a variable benefit, comprising:
generating a coupon having a variable benefit;
receiving an indication that a first recipient has redeemed a duplicate of said coupon received from a second recipient of said coupon; and
changing a benefit of said coupon retained by the second recipient after the indication is received.

53. A method of using a computer system for providing a coupon having a variable benefit, comprising:
generating a coupon having a variable benefit;
changing a benefit of said coupon retained by a first recipient each time an indication is received that a new recipient has registered to receive a duplicate of said coupon issued to the first recipient; and
issuing said coupon to the new recipient.

54. A method of using a computer system for providing a coupon having a variable benefit, comprising:
(a) issuing a coupon having a variable benefit to a first recipient;
(b) receiving a first forward indication that the first recipient has forwarded a duplicate of the coupon to a new recipient;
(c) determining whether the new recipient has previously received said coupon;
(d) changing the benefit of said coupon retained by the first recipient when the new recipient has not previously received said coupon;
(e) receiving a second forward indication that the new recipient has forwarded a duplicate of said coupon to a subsequent recipient;
(f) determining whether the subsequent recipient has previously received a duplicate of said coupon;
(g) changing the benefit of said coupon retained by the first recipient when the subsequent recipient has not previously received said coupon; and
(h) changing a new benefit of said coupon retained by the new recipient when the subsequent recipient has not previously received said coupon.

55. The method of claim 54, further comprising:
repeating (b) through (d) each time the first forward indication is received; and
repeating (e) through (h) each time the second forward indication is received.

56. The method of claim 54, wherein the changing the benefit of said coupon retained by the first recipient when the new recipient has not previously received said coupon comprises;
determining whether a number of the new recipients that have not previously received said coupon exceeds a maximum number; and
adjusting the benefit of said coupon retained by the first recipient to equal a predetermined maximum benefit corresponding to the number if the benefit exceeds the predetermined maximum benefit.

57. The method of claim 54, wherein the changing a new benefit of said coupon retained by the new recipient when the subsequent recipient has not previously received said coupon comprises:
determining whether a number of subsequent recipients that have not previously received said coupon exceeds a maximum number; and
adjusting the benefit of said coupon retained by the new recipient to equal a predetermined maximum benefit corresponding to the number if the benefit exceeds the predetermined maximum benefit.

58. The method of claim 54, further comprising updating the benefit of said coupon retained by the first recipient, wherein the benefit corresponds to a sum of an initial benefit of said coupon and an amount by which the initial benefit of said coupon retained by the first recipient has been increased.

59. An apparatus for providing a coupon having a variable benefit, comprising:
a server coupled to at least one output device for issuing a coupon having a variable benefit to a first recipient, wherein the server is operable to increase a benefit of said coupon retained by the first recipient when an indication is received that a second recipient has received a duplicate of the coupon from the first recipient.

60. A coupon issuing system, comprising:
a controller;
a storage device coupled to the controller; and
software operative to run on the controller to increase a benefit of a coupon retained by a first recipient when an indication is received that a second recipient has received a duplicate of said coupon from the first recipient;
issuing a coupon having a variable benefit, wherein a duplicate of the coupon is transmitted from one recipient to another recipient;
receiving an indication that a first recipient has received the duplicate of the coupon from a second recipient of the coupon; and
changing the benefit of the coupon retained by the second recipient when the indication is received.

61. A method of using a computer system for redeeming a coupon having a variable benefit, comprising:
receiving a coupon identifier of a coupon;
receiving a recipient identifier corresponding to a recipient of the coupon;
determining a benefit of said coupon corresponding to the recipient identifier; and
processing a request to redeem said coupon using the benefit.

62. The method of claim 61, further comprising the step of verifying the validity of said coupon.

63. The method of claim 61, wherein the determining a benefit of said coupon comprises:
accessing a database storing information related to said coupon; and
retrieving the redemption benefit of said coupon corresponding to the recipient identifier from the database.

64. The method of claim 61, wherein the determining the benefit of said coupon comprises:
accessing a web site storing information related to said coupon; and
retrieving the benefit of said coupon corresponding to the recipient identifier from the web site.

65. The method of claim 62, wherein the processing the request comprises applying the benefit to a purchase price of an item corresponding to said coupon.

66. The method of claim 62, wherein the determining the benefit of said coupon comprises determining a benefit of said coupon in accordance with benefit variation conditions.

67. A system for changing a benefit associated with a coupon, comprising:
a memory;
a communication port; and
a processor connected to the memory and the communication port, the processor being operative to:
generate a coupon having a variable benefit;
receive an indication that a first recipient has received a duplicate of said coupon from a second recipient after the second recipient has redeemed said coupon that; and
issue a new coupon to the second recipient, the new coupon having a benefit corresponding to an incremental benefit the second recipient would have received had said coupon not been redeemed by the second recipient.

68. A computer readable medium for use in a coupon system, the computer readable medium storing a computer program comprising:
computer readable means for creating a coupon having a variable benefit;
computer readable means for receiving an indication that a first recipient has received a duplicate of said coupon from a second recipient after the second recipient has redeemed said coupon that; and
computer readable means for providing a new coupon to the second recipient, the new coupon having a benefit corresponding to an incremental benefit the second recipient would have received had said coupon not been redeemed by the second recipient.

69. An article of manufacture, comprising:
a computer usable medium having a computer readable program means embodied therein for operating an information system, the computer readable program means in the article of manufacture operable to:
generate a coupon having a variable benefit;
receive an indication that a first recipient has received a duplicate of said coupon from a second recipient after the second recipient has redeemed said coupon that; and
issue a new coupon to the second recipient, the new coupon having a benefit corresponding to an incremental benefit the second recipient would have received had said coupon not been redeemed by the second recipient.

70. An apparatus for changing a benefit associated with a coupon, comprising:
means for creating a coupon having a variable benefit;
means for receiving an indication that a first recipient has received a duplicate of said coupon from a second recipient after the second recipient has redeemed said coupon that; and
means for providing a new coupon to the second recipient, the new coupon having a benefit corresponding to an incremental benefit the second recipient would have received had said coupon not been redeemed by the second recipient.

71. A system for changing a benefit associated with a coupon, comprising:
a memory;
a communication port; and
a processor connected to the memory and the communication port, the processor being operative to:
generate a coupon having a variable benefit, wherein a duplicate of said coupon is transmitted to a first recipient from a second recipient;
receive an indication that at least one of the second recipient or the first recipient has completed a qualifying action; and
change a benefit of said coupon retained by the second recipient after the indication is received.

72. A computer readable medium for use in a coupon system, the computer readable medium storing a computer program comprising:
computer readable means for creating a coupon having a variable benefit, wherein a duplicate of said coupon is transmitted to a first recipient from a second recipient;
computer readable means for receiving an indication that at least one of the second recipient or the first recipient has completed a qualifying action; and
computer readable means for modifying a benefit of said coupon retained by the second recipient after the indication is received.

73. An article of manufacture, comprising:
a computer usable medium having a computer readable program means embodied therein for operating an information system, the computer readable program means in the article of manufacture operable to:
generate a coupon having a variable benefit, wherein a duplicate of said coupon is transmitted to a first recipient from a second recipient;
receive an indication that at least one of the second recipient or the first recipient has completed a qualifying action; and
change a benefit of said coupon retained by the second recipient after the indication is received.

74. An apparatus for changing a benefit associated with a coupon, comprising:
means for creating a coupon having a variable benefit, wherein a duplicate of said coupon is transmitted to a first recipient from a second recipient;
means for receiving an indication that at least one of the second recipient or the first recipient has completed a qualifying action; and
means for modifying a benefit of said coupon retained by the second recipient after the indication is received.
